(19) United States
(12) Patent Application Publication
(10) Pub. No.: US 2006/0182291 A1
(43) Pub. Date: Aug. 17, 2006

(54) Acoustic processing system, acoustic processing device, acoustic processing method, acoustic processing program, and storage medium

(76) Inventors: Nobuyuki Kunieda, Yokohama-shi (JP); Kazuya Nomura, Sagamihara-shi (JP); Kazuhiro Nakamura, Yokohama-shi (JP)

Correspondence Address: PEARNE & GORDON LLP, 1801 EAST 9TH STREET, SUITE 1200, CLEVELAND, OH, 44114-3108, US

(21) Appl. No.: 10/547,918

(22) PCT Filed: Aug. 27, 2004
(86) PCT No.: PCT/JP04/12798

§ 371 Date: Sep. 8, 2005

(30) Foreign Application Priority Data
Sep. 5, 2003 (JP) 2003-314483

(51) Int. Cl. H04R 3/00

(52) U.S. Cl. 381/110

(57) ABSTRACT

Herein disclosed is a sound signal processing apparatus (10), comprising: a speaker unit (12) for converting a first sound signal to a first sound; sound signal producing means (13) for producing a second sound signal constituted by at least two different components including an echo component indicative of the sound outputted by the speaker unit (12), and a voice component indicative of one's voice having a least one leading end; echo component suppressing means (14) for suppressing the echo component of the second sound signal on the basis of the first and second sound signals to output, as a third sound signal, the suppressed second sound signal; sound signal storing means (15) for storing the third sound signal outputted by the echo component suppressing means (14); voice detecting means (16) for detecting the leading end of the speaker's voice on the basis of the third sound signal outputted by the echo component suppressing means (14); and controlling means (17) for controlling the sound signal storing means (15) to have the sound signal storing means (15) output, as a fourth sound signal, said third sound signal stored in the time period when said voice is detected on the basis of said third sound signal outputted by said echo component suppressing means, the controlling means (17) being operative to specify two different clock times on the basis of a predetermined time difference, the clock times including a first clock time at which the leading end of the voice is detected by the voice detecting means (16), and a second clock time prior to the first clock time, the controlling means (17) being operative to have the sound signal storing means (15) start to output the third sound signal stored after the second clock time.

### TECHNICAL FIELD OF THE INVENTION

The present invention relates to a system for, an apparatus for, a method of, and a program of processing a sound signal, and a recordable media having stored therein the program to be executed by a computer, and more particularly to a system for, an apparatus for, a method of, and a program of suppressing an echo component of a sound signal to process the echo suppressed sound signal, and a recordable media having stored therein the program to be executed by a computer

### DESCRIPTION OF THE RELATED ART

As sound signal processing systems of this type, there have been well known a sound signal processing system such as for example a teleconference system and a hands-free communication system. The conventional sound signal processing system comprises a speaker unit for outputting a sound such as for example a far-end speaker's voice or music, and a microphone unit for receiving not only a near-end speaker's voice but also the sound outputted by the speaker unit to produce a sound signal to be transmitted to the far-end speaker.

The above mentioned conventional sound signal processing apparatus further comprises an echo canceller for suppressing an echo component of the sound signal produced by the microphone unit to produce the echo suppressed sound signal to be transmitted to the far-end speaker.

The term “echo canceller” is intended to indicate an apparatus for suppressing the echo component of the sound signal produced by the microphone unit by estimating the echo component on the basis of the sound outputted by the speaker unit and the sound received by the microphone unit.

The echo canceller includes an adaptive filter for estimating the echo component of the sound signal produced by the microphone unit on the basis of the sound signal to be converted by the speaker unit and the sound signal produced by the microphone unit. The conventional sound signal processing apparatus provided with the echo canceller is disclosed in, for example, “Audio System and Digital Signal Processing” edited by Institute of Electronics and Communication Engineers of Japan (pp. 209-218, CORONA PUBLISHING CO., LTD., 1985), and “Technology of Digital Audio” written and edited by Nobuhiko Kitawaki (pp. 221-257, Ohmsha, Ltd., 1999).

As an example of voice interactive systems, there has been known a navigation system comprising a voice interactive unit for producing a sound signal indicative of a sound such as “What can I do for you?”, a speaker unit for converting the sound signal to the sound “What can I do for you?”, a microphone unit for receiving one's voice such as for example “I want to go to amusement park A” with the sound outputted by the speaker unit. The conventional voice interactive system is required to reduce an echo component indicative of the sound outputted by the speaker unit to reliably recognize the voice.

The conventional voice interactive system, however, encounters such a problem that the conventional voice interactive system is required, as a restriction in use, to stop performing the voice recognition over a time period when the sound “What can I do for you?” is being outputted by the speaker unit, and to start to perform the voice recognition to the voice “I want to go to amusement park A” after the sound “What can I do for you?” is outputted by the speaker unit.

Therefore, the restriction of the conventional voice interactive system tends to have the operator find it tedious to wait for a time period before the sound is over in order to respond to the sound outputted by the conventional voice interactive system. Recently, there has been proposed a voice recognition system for performing the voice recognition to one's voice on the basis of barge-in method of barging the voice in a time period when the sound is being outputted by the navigation apparatus, the method being disclosed in “Engineering of Voice Communication” written and edited by Nobuhiko Kitawaki, (pp 128-130, CORONA PUBLISHING CO., LTD., 1996).

The above mentioned voice interactive system, however, encounters such a problem that the voice component tends to be inaccurately distinguished from the echo component under the condition that the sound is being outputted by the speaker unit. This leads to the fact that the voice recognition is executed at a relatively low accuracy even if the echo component is suppressed by an echo canceller.

Each of the sound signal recording and reproducing apparatus disclosed in Japanese Patent Laying-Open Publication No. H08-107375 (pp. 4-5, FIG. 1) and the data processing apparatus disclosed in Japanese Patent Laying-Open Publication No. H08-51385 (pp. 3-4, FIG. 1) is shown in FIG. 33 as comprising sound signal inputting means 1, a speaker unit 2, a microphone unit 3, an echo canceller 4, and sound signal outputting means 5. The echo canceller 4 is operative to cancel the echo component of the sound signal produced by the microphone unit 3. The voice inputting method disclosed in Japanese Patent Laying-Open Publication No. 2001-94370 (pp. 3-4, FIG. 1) is of extracting a voice component from a sound signal suppressed by an echo canceller 4, and of outputting the extracted voice component, as a sound to be judged by the user, to the speaker unit 2. The above mentioned conventional apparatus, however, encounters such a problem that the echo component is insufficiently suppressed as a result of the fact that the level of the background noise is relatively large, or the echo path is varied with time.

The voice recognition apparatus disclosed in Japanese Patent Laying-Open Publication No. 2001-94370 (pp. 3-4, FIG. 1) is shown in FIG. 34 as comprising sound signal inputting means 1, a speaker unit 2, a microphone unit 3, an echo canceller 4, sound signal outputting means 5, and voice detecting means 6. The echo canceller 4 is operative to judge whether or not the speaker talks to the microphone unit 3, while the voice detecting means 6 is operative to distinguish a time period when the speaker talks to the microphone unit 3 from a time period when the speaker does not talk to the microphone unit 3.

Each of “voice interactive system” disclosed in Japanese Patent Laying-Open Publication No. H05-323993 (pp. 3-4, FIG. 1), “apparatus for and method of processing a voice signal” disclosed in Japanese Patent Publication No. 3229335 (p. 4, FIG. 2), “apparatus for and method of detecting superimposed voice, and voice inputting and outputting apparatus to be provided with the detecting apparatus” disclosed in Japanese Patent Laying-Open Publication No. H07-264103 (p. 4, FIG. 1) is operative to start to perform the voice recognition to the inputted sound when the judgment is made that the voice is detected in the inputted sound signal, to stop having an adaptive filter learn the inputted sound signal, or to stop obtaining the learning data useful for echo suppression.

The conventional sound signal suppressing apparatus, however, encounters such a problem that the voice component tends to be inaccurately distinguished from the remaining component such as for example a noise component indicative of the background sound produced in the vicinity of the microphone unit, or an echo component indicative of the sound produced by the speaker unit. This leads to the fact that the voice recognition tends to be executed at a relatively low accuracy in a time period when the sound is being outputted by the speaker unit.

It is, therefore, an object of the present invention to provide a sound signal processing apparatus which can sufficiently suppress the echo component of the sound signal, and reduce the time period up to start to output the echo suppressed sound signal.

### DISCLOSURE OF THE INVENTION

In accordance with a first aspect of the present invention, there is provided a sound signal processing apparatus, comprising: a speaker unit for converting a first sound signal to a first sound; sound signal producing means for producing a second sound signal constituted by at least two different components including an echo component indicative of the first sound outputted by the speaker unit, and a voice component indicative of one's voice having a least one leading end; echo component suppressing means for suppressing the echo component of the second sound signal on the basis of the first and second sound signals to output, as a third sound signal, the suppressed second sound signal; sound signal storing means for storing the third sound signal outputted by the echo component suppressing means; voice detecting means for detecting the leading end of the voice on the basis of the third sound signal outputted by the echo component suppressing means; and controlling means for controlling the sound signal storing means to have the sound signal storing means output, as a fourth sound signal, the third sound signal stored in the time period when the voice is detected on the basis of the third sound signal outputted by the echo component suppressing means, the controlling means being operative to specify two different clock times on the basis of a predetermined time difference, the clock times including a first clock time at which the leading end of the voice is detected by the voice detecting means, and a second clock time prior to the first clock time, the controlling means being operative to have the sound signal storing means start to output the third sound signal stored after the second clock time.

The sound signal processing apparatus thus constructed as previously mentioned can sufficiently suppress the remaining echo component by estimating at a relatively high accuracy the echo component of the second sound signal by reason that the controlling means is operative to specify two different clock times on the basis of a predetermined time difference, the clock times including a first clock time at which the leading end of the voice is detected by the voice detecting means, and a second clock time prior to the first clock time, the controlling means being operative to have the sound signal storing means start to output the third sound signal stored after the second clock time. The sound signal processing apparatus can reduce the time period up to start to output the echo suppressed sound signal.

In the sound signal processing apparatus according to the present invention, the echo component suppressing means may include: an adaptive filter for estimating the echo component of the second sound signal to output a replica echo signal indicative of the estimated echo component of the second sound signal; and a subtracting unit for subtracting the replica echo signal produced by the adaptive filter from the second sound signal produced by the sound signal producing means to output a signal indicative of the difference between the second sound signal and the replica echo signal. The adaptive filter may be operative to produce the replica echo signal on the basis of the first sound signal and the signal outputted by the subtracting unit. The echo component suppressing means may be operative to output, as a third signal, the signal produced by the subtracting unit.

The echo component suppressing means of the sound signal processing apparatus thus constructed as previously mentioned can sufficiently suppress the echo component of the second sound signal produced by the sound signal producing means.

In the sound signal processing apparatus according to the present invention, the echo component suppressing means may include: an adaptive filter for estimating a filter coefficient; a convolution calculating unit for estimating a replica echo signal indicative of the echo component of the second sound signal by calculating the convolution of the first sound signal with respect to the filter coefficient estimated by the adaptive filter; a filter coefficient transferring unit for judging whether the filter coefficient estimated by the adaptive filter is being varied or relatively stable, the filter coefficient transferring unit being operative to transfer the filter coefficient estimated by the adaptive filter to the convolution calculating unit when the judgment is made that the filter coefficient estimated by the adaptive filter is relatively stable; and a subtracting unit for subtracting the replica echo signal produced by the convolution calculating unit from the second sound signal produced by the sound signal producing means to output a signal indicative of the difference between the second sound signal and the replica echo signal. The adaptive filter may be operative to estimate the filter coefficient on the basis of the first sound signal and the signal outputted by the subtracting unit. The echo component suppressing means may be operative to output, as a third signal, the signal outputted by the subtracting unit.

The echo component suppressing means of the sound signal processing apparatus thus constructed as previously mentioned can sufficiently suppress the echo component of the second sound signal produced by the sound signal producing means by reason that the adaptive filter is operative to estimate a filter coefficient, and the filter coefficient transferring unit is operative to transfer the filter coefficient estimated by the adaptive filter to the convolution calculating unit when the judgment is made that the filter coefficient estimated by the adaptive filter is relatively stable.

In the sound signal processing apparatus according to the present invention, the echo component suppressing means may include: an adaptive filter for estimating a filter coefficient; a first sound signal storing unit having the first sound signal stored therein, the first sound signal storing unit being operative to output the stored first sound signal in order of first-in first-out with a predetermined delay; a second sound signal storing unit having the second sound signal stored therein, the first sound signal storing unit being operative to output the stored second sound signal in order of first-in first-out with a predetermined delay; a convolution calculating unit for estimating a replica echo signal indicative of the echo component of the second sound signal by calculating the convolution of the first sound signal outputted by the first sound signal storing unit with respect to the filter coefficient estimated by the adaptive filter; a filter coefficient transferring unit for judging whether the filter coefficient estimated by the adaptive filter is being varied or relatively stable, the filter coefficient transferring unit being operative to transfer the filter coefficient estimated by the adaptive filter to the convolution calculating unit when the judgment is made that the filter coefficient estimated by the adaptive filter is relatively stable; and a subtracting unit for subtracting the replica echo signal produced by the convolution calculating unit from the second sound signal outputted by the second sound signal storing unit to output a signal indicative of the difference between the second sound signal and the replica echo signal. The adaptive filter may be operative to estimate the filter coefficient on the basis of the first sound signal and the signal outputted by the subtracting unit. The echo component suppressing means may be operative to output, as a third signal, the signal outputted by the subtracting unit.

The echo component suppressing means of the sound signal processing apparatus thus constructed as previously mentioned can sufficiently suppress the echo component of the second sound signal produced by the sound signal producing means by reason that the convolution calculating unit is operative to produce a replica echo signal indicative of the estimated echo component of the second sound signal after judging that the filter coefficient estimated by the adaptive filter is relatively stable.

In the sound signal processing apparatus according to the present invention, the echo component suppressing means may include: a first learning data storing unit to be operable to have stored therein the first sound signal as first learning data; a second learning data storing unit to be operable to have stored therein the second sound signal produced by the sound signal producing means as second learning data; a controlling unit for allowing the first and second learning data storing units to respectively have stored therein the first and second learning data related to each other; an adaptive filter for estimating a filter coefficient on the basis of the first learning data stored in the first learning data storing unit and the second learning data stored in the second learning data storing unit; a convolution calculating unit for estimating a replica echo signal indicative of the echo component of the second sound signal by calculating the convolution of the first sound signal with respect to the filter coefficient estimated by the adaptive filter; a filter coefficient transferring unit for judging whether or not the filter coefficient estimated by the adaptive filter is relatively stable, the filter coefficient transferring unit being operative to transfer the filter coefficient estimated by the adaptive filter to the convolution calculating unit; and a subtracting unit for subtracting the replica echo signal produced by the convolution calculating unit from the second sound signal outputted by the second sound signal storing unit to output a signal indicative of the difference between the second sound signal and the replica echo signal. The adaptive filter may be operative to estimate the filter coefficient on the basis of the first sound signal and the signal outputted by the subtracting unit. The echo component suppressing means may be operative to output, as a third signal, the signal outputted by the subtracting unit.

The sound signal processing apparatus thus constructed as previously mentioned can sufficiently suppress the echo component of the second sound signal produced by the microphone unit by reason that the controlling unit is operative to have the adaptive filter estimate at a relatively high accuracy the stable filter coefficient by repeatedly utilizing the first and second learning data stored in the first and second learning data storing units.

In accordance with a second aspect of the present invention, there is provided a sound signal processing apparatus, comprising: communication performing means for receiving a first sound signal from an external apparatus through a communication network; a speaker unit for converting the first sound signal received by the communication performing means to a first sound; sound signal producing means for producing a second sound signal constituted by at least two different components including an echo component indicative of the first sound outputted by the speaker unit, and a voice component indicative of one's voice having a least one leading end; echo component suppressing means for suppressing the echo component of the second sound signal on the basis of the first and second sound signals to output, as a third sound signal, the suppressed second sound signal; sound signal storing means for storing the third sound signal outputted by the echo component suppressing means; voice detecting means for detecting the leading end of the voice on the basis of the third sound signal outputted by the echo component suppressing means; and controlling means for controlling the sound signal storing means to have the sound signal storing means output, as a fourth sound signal, the third sound signal stored in the time period when the voice is detected on the basis of the third sound signal outputted by the echo component suppressing means, the controlling means being operative to specify two different clock times on the basis of a predetermined time difference, the clock times including a first clock time at which the leading end of the voice is detected by the voice detecting means, and a second clock time prior to the first clock time, the controlling means being operative to have the sound signal storing means start to output the third sound signal stored after the second clock time.

The above mentioned sound signal processing apparatus may be operative to perform the communication with an external apparatus through a communication network. The above mentioned sound signal processing apparatus and the external apparatus collectively constitute a sound signal processing system.

In accordance with a third aspect of the present invention, there is provided a sound signal processing apparatus, comprising: communication performing means for receiving a second sound signal from an external apparatus through a communication network, the external apparatus including a speaker unit for converting a first sound signal to a first sound, and a sound signal producing means for producing a second sound signal to be outputted to the communication performing means, the second sound signal being constituted by at least two different components including an echo component indicative of the first sound outputted by the speaker unit, and a voice component indicative of one's voice having a least one leading end; echo component suppressing means for suppressing the echo component of the second sound signal on the basis of the first and second sound signals to output, as a third sound signal, the suppressed second sound signal; sound signal storing means for storing the third sound signal outputted by the echo component suppressing means; voice detecting means for detecting the leading end of the voice on the basis of the third sound signal outputted by the echo component suppressing means; and controlling means for controlling the sound signal storing means to have the sound signal storing means output, as a fourth sound signal, the third sound signal stored in the time period when the voice is detected on the basis of the third sound signal outputted by the echo component suppressing means, the controlling means being operative to specify two different clock times on the basis of a predetermined time difference, the clock times including a first clock time at which the leading end of the voice is detected by the voice detecting means, and a second clock time prior to the first clock time, the controlling means being operative to have the sound signal storing means start to output the third sound signal stored after the second clock time.

The above mentioned sound signal processing apparatus may be operative to perform the communication with an external apparatus through a communication network. The above mentioned sound signal processing apparatus and the external apparatus collectively constitute a sound signal processing system.

In the sound signal processing apparatus according to the present invention, the voice detecting means may be operative to detect the leading end of the voice component of the third sound signal by measuring the signal level of each of the first and third sound signals, and by comparing the signal level of each of the measured first and third sound signals with a predetermined threshold level.

The voice detecting means of the sound signal processing apparatus thus constructed as previously mentioned can detect at a relatively high accuracy the leading end of the voice component of the third sound signal outputted by the echo component suppressing means by comparing the signal level of each of the first and third sound signals with a predetermined threshold level.

In the sound signal processing apparatus according to the present invention, the voice detecting means may be operative to detect the leading end of the voice component of the third sound signal by measuring the noise level of the third sound signal to update the threshold level on the basis of the measured noise level of the third sound signal, and by comparing each of the measured first and third sound signals with the updated predetermined threshold level.

The voice detecting means of the sound signal processing apparatus thus constructed as previously mentioned can detect at a relatively high accuracy the leading end of the voice component of the third sound signal outputted by the echo component suppressing means even if the noise level of the third sound signal is relatively high.

In the sound signal processing apparatus according to the present invention, the voice detecting means may be operative to detect the leading end of the voice component of the third sound signal by judging whether or not the magnitude of the sound to be outputted by the speaker unit is larger than a predetermined threshold level to update the threshold level on the basis of the judgment, and by comparing each of the measured first and third sound signals with the updated predetermined threshold level.

The voice detecting means of the sound signal processing apparatus thus constructed as previously mentioned can detect at a relatively high accuracy the leading end of the voice component of the third sound signal outputted by the echo component suppressing means by reason that the voice detecting means is operative to update the threshold level on the basis of the judgment made on whether or not the magnitude of the sound to be outputted by the speaker unit is larger than a predetermined threshold level.

In the sound signal processing apparatus according to the present invention, the voice detecting means may be operative to detect the leading end of the voice component of the third sound signal by measuring the duration of the sound to be outputted by the speaker unit to update the threshold level on the basis of the measured duration of the sound, and by comparing each of the measured first and third sound signals with the updated predetermined threshold level.

The voice detecting means of the sound signal processing apparatus thus constructed as previously mentioned can detect at a relatively high accuracy the leading end of the voice component of the third sound signal outputted by the echo component suppressing means by reason that the voice detecting means is operative to update the threshold level on the basis of the measured duration of the sound to be outputted by the speaker unit.

In the sound signal processing apparatus according to the present invention, the voice detecting means may be operative to operative to detect the leading end of the voice component of the third sound signal by calculating first and third power values of the first and third sound signals, and by comparing each of the calculated first and third power values of the first and third sound signals with a predetermined threshold level.

The voice detecting means of the sound signal processing apparatus thus constructed as previously mentioned can detect at a relatively high accuracy the leading end of the voice component of the third sound signal outputted by the echo component suppressing means on the basis of the first and third power values of the first and third sound signals.

In the sound signal processing apparatus according to the present invention, the voice detecting means may be operative to perform the frequency analysis of each of the first and third sound signals to detect the leading end of the voice component of the third sound signal on the basis of the result of the frequency analysis of each of the first and third sound signals.

The voice detecting means of the sound signal processing apparatus thus constructed as previously mentioned can detect at a relatively high accuracy the leading end of the voice component of the third sound signal outputted by the echo component suppressing means on the basis of the result of the frequency analysis of each of the first and third sound signals.

In the sound signal processing apparatus according to the present invention, the voice detecting means may be operative to detect the leading end of the voice component of the third sound signal by measuring the signal level of each of the second and third sound signals, and by comparing each of the calculated signal levels of the second and third sound signals with a predetermined threshold level.

The voice detecting means of the sound signal processing apparatus thus constructed as previously mentioned can detect at a relatively high accuracy the leading end of the voice component of the third sound signal outputted by the echo component suppressing means by comparing each of the calculated signal levels of the second and third sound signals with a predetermined threshold level.

In the sound signal processing apparatus according to the present invention, the voice detecting means may be operative to detect the leading end of the voice component of the third sound signal by calculating second and third power values of the second and third sound signals, and by comparing each of the calculated second and third power values of the second and third sound signals with a predetermined threshold level.

The voice detecting means of the sound signal processing apparatus thus constructed as previously mentioned can detect at a relatively high accuracy the leading end of the voice component of the third sound signal outputted by the echo component suppressing means by comparing each of the calculated second and third power values of the second and third sound signals with a predetermined threshold level.

In the sound signal processing apparatus according to the present invention, the voice detecting means may be operative to perform the frequency analysis of each of the second and third sound signals to detect the leading end of the voice component of the third sound signal on the basis of the result of the frequency analysis of each of the second and third sound signals.

The voice detecting means of the sound signal processing apparatus thus constructed as previously mentioned can detect at a relatively high accuracy the leading end of the voice component of the third sound signal outputted by the echo component suppressing means on the basis of the result of the frequency analysis of each of the second and third sound signals.

In the sound signal processing apparatus according to the present invention, the voice detecting means may be operative to detect the leading end of the voice component of the third sound signal by measuring the signal level of each of the first to third sound signals, and by comparing each of the calculated signal levels of the first to third sound signals with a predetermined threshold level.

The voice detecting means of the sound signal processing apparatus thus constructed as previously mentioned can detect t at a relatively high accuracy he leading end of the voice component of the third sound signal outputted by the echo component suppressing means by comparing each of the calculated signal levels of the first to third sound signals with a predetermined threshold level.

In the sound signal processing apparatus according to the present invention, the voice detecting means may be operative to detect the leading end of the voice component of the third sound signal by calculating first to third power values of the first to third sound signals, and by comparing each of the calculated first to third power values of the first to third sound signals with a predetermined threshold level.

The voice detecting means of the sound signal processing apparatus thus constructed as previously mentioned can detect at a relatively high accuracy the leading end of the voice component of the third sound signal outputted by the echo component suppressing means by comparing each of the calculated power values of the first to third sound signals with a predetermined threshold level.

In the sound signal processing apparatus according to the present invention, the voice detecting means may be operative to perform the frequency analysis of each of the first to third sound signals to detect the leading end of the voice component of the third sound signal on the basis of the result of the frequency analysis of each of the first to third sound signals.

The voice detecting means of the sound signal processing apparatus thus constructed as previously mentioned can detect at a relatively high accuracy the leading end of the voice component of the third sound signal outputted by the echo component suppressing means on the basis of the result of the frequency analysis of each of the first to third sound signals.

The sound signal processing apparatus according to the present invention may further comprise signal level adjusting means for adjusting the signal level of the first sound signal to be converted to the sound by the speaker unit. The voice detecting means may be operative to detect the leading end of the voice component of the third sound signal by measuring each of the signal level of the first sound signal adjusted by the signal level adjusting means and the signal level of the third sound signal outputted by the echo component suppressing means, and by comparing each of the calculated signal levels of the first and third sound signals with a predetermined threshold level.

The voice detecting means of the sound signal processing apparatus thus constructed as previously mentioned can detect at a relatively high accuracy the leading end of the voice component of the third sound signal outputted by the echo component suppressing means by comparing each of the signal level of the first sound signal adjusted by the signal level adjusting means and the signal level of the third sound signal outputted by the echo component suppressing means with a predetermined threshold level.

The sound signal processing apparatus according to the present invention may further comprise signal level adjusting means for adjusting the signal level of the first sound signal to be converted to the sound by the speaker unit. The voice detecting means may be operative to detect the leading end of the voice component of the third sound signal by calculating each of the first power value of the first sound signal adjusted by the signal level adjusting means and the third power value of the third sound signal outputted by the echo component suppressing means, and by comparing each of the calculated first and third power values of the first and third sound signals with a predetermined threshold level.

The voice detecting means of the sound signal processing apparatus thus constructed as previously mentioned can detect at a relatively high accuracy the leading end of the voice component of the third sound signal outputted by the echo component suppressing means by comparing each of the first power value of the first sound signal adjusted by the signal level adjusting means and the third power value of the third sound signal outputted by the echo component suppressing means with a predetermined threshold level.

The sound signal processing apparatus according to the present invention may further comprise magnitude adjusting means for adjusting the magnitude of the sound to be outputted by the speaker unit by adjusting the signal level of the first sound signal to be inputted to the speaker unit. The voice detecting means may be operative to detect the leading end of the voice component of the third sound signal by performing the frequency analysis of each of the first sound signal adjusted by the magnitude adjusting means and the third sound signal outputted by the echo component suppressing means.

The voice detecting means of the sound signal processing apparatus thus constructed as previously mentioned can detect at a relatively high accuracy the leading end of the voice component of the third sound signal outputted by the echo component suppressing means on the basis of the frequency analysis of each of the first sound signal adjusted by the magnitude adjusting means and the third sound signal outputted by the echo component suppressing means.

The sound signal processing apparatus according to the present invention may further comprise trigger signal producing means for producing a trigger signal having a trigger pulse to be defined in association with the time at which the voice is detected by the voice detecting means. The voice detecting means may be operative to detect the leading end of the voice component of the third sound signal outputted by the echo component suppressing means on the basis of the trigger signal produced by the trigger signal producing means.

The voice detecting means of the sound signal processing apparatus thus constructed as previously mentioned can detect at a relatively high accuracy the leading end of the voice component of the third sound signal outputted by the echo component suppressing means on the basis of the trigger signal produced by the trigger signal producing means.

In the sound signal processing apparatus according to the present invention, the trigger signal producing means may be operative to produce a trigger signal having a trigger pulse to be defined in association with the time at which the voice is detected by the voice detecting means. The voice detecting means may be operative to detect the leading end of the voice component of the third sound signal outputted by the echo component suppressing means on the basis of the trigger signal produced by the trigger signal producing means.

The voice detecting means of the sound signal processing apparatus thus constructed as previously mentioned can detect at a relatively high accuracy the leading end of the voice component of the third sound signal outputted by the echo component suppressing means on the basis of the trigger signal produced by the trigger signal producing means.

In the sound signal processing apparatus according to the present invention, the sound signal producing means may include a plurality of microphone units for producing respective signals each constituted by at least two different components including an echo component indicative of the sound outputted by the speaker unit, and a voice component indicative of the voice having a least one leading end, and synthesizing means for allowing the second sound signal to be constituted by the signals produced by the respective microphone units. The sound signal producing means may be operative to output the second sound signal produced by the synthesizing means to the echo component suppressing unit. The voice detecting means may be operative to detect the leading end of the voice component of the third sound signal by measuring the signal level of the second sound signal produced by the synthesizing means, and by comparing the calculated signal level of the second sound signal with a predetermined threshold level.

The voice detecting means of the sound signal processing apparatus thus constructed as previously mentioned can detect at a relatively high accuracy the leading end of the voice component of the third sound signal outputted by the echo component suppressing means by comparing the calculated signal level of the second sound signal with a predetermined threshold level by reason that the synthesizing means is operative to emphasize the voice component of the second sound signal, and to reduce the noise component of the second sound signal.

In the sound signal processing apparatus according to the present invention, the sound signal producing means may include a plurality of microphone units for producing respective signals each constituted by at least two different components including an echo component indicative of the sound outputted by the speaker unit, and a voice component indicative of the voice having a least one leading end, and synthesizing means for allowing the second sound signal to be constituted by the signals produced by the respective microphone units. The sound signal producing means may be operative to output the second sound signal produced by the synthesizing means to the echo component suppressing unit. The voice detecting means may be operative to detect the leading end of the voice component of the third sound signal by calculating the second power value of the second sound signal produced by the synthesizing means, and by comparing the calculated second power value of the second sound signal with a predetermined threshold level.

The voice detecting means of the sound signal processing apparatus thus constructed as previously mentioned can detect at a relatively high accuracy the leading end of the voice component of the third sound signal outputted by the echo component suppressing means by comparing the calculated second power value of the second sound signal with a predetermined threshold level by reason that the synthesizing means is operative to emphasize the voice component of the second sound signal, and to reduce the noise component of the second sound signal.

In the sound signal processing apparatus according to the present invention, the sound signal producing means may include a plurality of microphone units for producing respective signals each constituted by at least two different components including an echo component indicative of the sound outputted by the speaker unit, and a voice component indicative of the voice having a least one leading end, and synthesizing means for allowing the second sound signal to be constituted by the signals produced by the respective microphone units. The sound signal producing means may be operative to output the second sound signal produced by the synthesizing means to the echo component suppressing unit. The voice detecting means may be operative to perform the frequency analysis of the second sound signal produced by the synthesizing means to detect the leading end of the voice component of the third sound signal on the basis of the result of the frequency analysis of the second sound signal.

The voice detecting means of the sound signal processing apparatus thus constructed as previously mentioned can detect at a relatively high accuracy the leading end of the voice component of the third sound signal outputted by the echo component suppressing means on the basis of the result of the frequency analysis of the second sound signal by reason that the synthesizing means is operative to emphasize the voice component of the second sound signal, and to reduce the noise component of the second sound signal.

The sound signal processing apparatus according to the present invention may further comprise noise component suppressing means for suppressing the noise component of the third sound signal outputted by the echo component suppressing means. The voice detecting means may be operative to detect the leading end of the voice component of the third sound signal by measuring the signal level of the third sound signal suppressed by the noise component suppressing means, and by comparing the calculated signal level of the third sound signal suppressed by the noise component suppressing means with a predetermined threshold level.

The voice detecting means of the sound signal processing apparatus thus constructed as previously mentioned can detect at a relatively high accuracy the leading end of the voice component of the third sound signal outputted by the echo component suppressing means by comparing the calculated signal level of the third sound signal suppressed by the noise component suppressing means with a predetermined threshold level.

The sound signal processing apparatus according to the present invention may further comprise noise component suppressing means for suppressing the noise component of the third sound signal outputted by the echo component suppressing means. The voice detecting means may be operative to detect the leading end of the voice component of the third sound signal by calculating the third power value of the third sound signal suppressed by the noise component suppressing means, and by comparing the calculated third power value of the third sound signal with a predetermined threshold level.

The voice detecting means of the sound signal processing apparatus thus constructed as previously mentioned can detect at a relatively high accuracy the leading end of the voice component of the third sound signal outputted by the echo component suppressing means by comparing the calculated third power value of the third sound signal with a predetermined threshold level.

The sound signal processing apparatus according to the present invention may further comprise noise component suppressing means for suppressing the noise component of the third sound signal outputted by the echo component suppressing means. The voice detecting means may be operative to perform the frequency analysis of the third sound signal suppressed by the noise component suppressing means to detect the leading end of the voice component of the third sound signal on the basis of the result of the frequency analysis of the third sound signal suppressed by the noise component suppressing means.

The voice detecting means of the sound signal processing apparatus thus constructed as previously mentioned can detect at a relatively high accuracy the leading end of the voice component of the third sound signal outputted by the echo component suppressing means on the basis of the result of the frequency analysis of the third sound signal suppressed by the noise component suppressing means.

In the sound signal processing apparatus according to the present invention, the voice detecting means may be operative to detect the leading end of the voice component of the third sound signal by measuring the signal level of the second sound signal produced by the sound signal producing means, and by comparing the calculated signal level of the second sound signal with a predetermined threshold level when the judgment is made that the filter coefficient estimated by the adaptive filter is relatively stable.

The voice detecting means of the sound signal processing apparatus thus constructed as previously mentioned can detect at a relatively high accuracy the leading end of the voice component of the third sound signal outputted by the echo component suppressing means by comparing the calculated signal level of the second sound signal with a predetermined threshold level when the judgment is made that the filter coefficient estimated by the adaptive filter is relatively stable.

In the sound signal processing apparatus according to the present invention, the voice detecting means is operative to detect the leading end of the voice component of the third sound signal by calculating the third power value of the second sound signal produced by the sound signal producing means, and by comparing the calculated second power value of the second sound signal with a predetermined threshold level when the judgment is made that the filter coefficient estimated by the adaptive filter is relatively stable.

The voice detecting means of the sound signal processing apparatus thus constructed as previously mentioned can detect at a relatively high accuracy the leading end of the voice component of the third sound signal outputted by the echo component suppressing means by comparing the calculated second power value of the second sound signal with a predetermined threshold level when the judgment is made that the filter coefficient estimated by the adaptive filter is relatively stable.

In the sound signal processing apparatus according to the present invention, the voice detecting means is operative to perform the frequency analysis of the second sound signal produced by the sound signal producing means to detect the leading end of the voice component of the third sound signal on the basis of the result of the frequency analysis when the judgment is made that the filter coefficient estimated by the adaptive filter is relatively stable.

The voice detecting means of the sound signal processing apparatus thus constructed as previously mentioned can detect at a relatively high accuracy the leading end of the voice component of the third sound signal outputted by the echo component suppressing means on the basis of the result of the frequency analysis when the judgment is made that the filter coefficient estimated by the adaptive filter is relatively stable.

In accordance with a fourth aspect of the present invention, there is provided a sound signal processing system, comprising: at least two sound signal processing apparatuses including first and second sound signal processing apparatuses, the first sound signal processing apparatus including: a speaker unit for converting a first sound signal to a first sound; sound signal producing means for producing a second sound signal constituted by at least two different components including an echo component indicative of the first sound outputted by the speaker unit, and a voice component indicative of one's voice having a least one leading end; echo component suppressing means for suppressing the echo component of the second sound signal on the basis of the first and second sound signals to output, as a third sound signal, the suppressed second sound signal; sound signal storing means for storing the third sound signal outputted by the echo component suppressing means; voice detecting means for detecting the leading end of the voice on the basis of the third sound signal outputted by the echo component suppressing means; controlling means for controlling the sound signal storing means to have the sound signal storing means output, as a fourth sound signal, the third sound signal stored in the time period when the voice is detected on the basis of the third sound signal outputted by the echo component suppressing means, the controlling means being operative to specify two different clock times on the basis of a predetermined time difference, the clock times including a first clock time at which the leading end of the voice is detected by the voice detecting means, and a second clock time prior to the first clock time, the controlling means being operative to have the sound signal storing means start to output the third sound signal stored after the second clock time; and communication performing means for transmitting the first sound signal to the second sound signal processing apparatus, and the second sound signal processing apparatus including: a speaker unit for converting a first sound signal to a first sound; sound signal producing means for producing a second sound signal constituted by at least two different components including an echo component indicative of the first sound outputted by the speaker unit, and a voice component indicative of one's voice having a least one leading end; echo component suppressing means for suppressing the echo component of the second sound signal on the basis of the first and second sound signals to output, as a third sound signal, the suppressed second sound signal; sound signal storing means for storing the third sound signal outputted by the echo component suppressing means; voice detecting means for detecting the leading end of the voice on the basis of the third sound signal outputted by the echo component suppressing means; controlling means for controlling the sound signal storing means to have the sound signal storing means output, as a fourth sound signal, the third sound signal stored in the time period when the voice is detected on the basis of the third sound signal outputted by the echo component suppressing means, the controlling means being operative to specify two different clock times on the basis of a predetermined time difference, the clock times including a first clock time at which the leading end of the voice is detected by the voice detecting means, and a second clock time prior to the first clock time, the controlling means being operative to have the sound signal storing means start to output the third sound signal stored after the second clock time.

The sound signal processing system can sufficiently suppress each of the echo components of the second sound signals produced by the sound signal producing means of the first and second sound signal processing apparatuses, even if the first sound outputted by the speaker unit of one of the first and second sound signal processing apparatuses is received by the microphone unit of the other of the first and second sound signal processing apparatuses, by reason that the first and second sound signal processing apparatuses are operative to perform the wireless communication with each other.

In the sound signal processing apparatus according to the present invention, the echo component suppressing means of the first sound signal processing apparatus may be operative to suppress the echo component of the second sound signal produced by the sound signal producing means of the first sound signal processing apparatus on the basis of the first sound signal inputted to the first sound signal processing apparatus, the second sound signal produced by the sound signal producing means of the first sound signal processing apparatus, and the first sound signal received from the second sound signal processing apparatus. On the other hand, the echo component suppressing means of the second sound signal processing apparatus may be operative to suppress the echo component of the second sound signal produced by the sound signal producing means of the second sound signal processing apparatus on the basis of the first sound signal inputted to the second sound signal processing apparatus, the second sound signal produced by the sound signal producing means of the second sound signal processing apparatus, and the first sound signal received from the first sound signal processing apparatus.

The sound signal processing system can sufficiently suppress each of the echo components of the second sound signals produced by the sound signal producing means of the first and second sound signal processing apparatuses, even if the first sound outputted by the speaker unit of one of the first and second sound signal processing apparatuses is received by the microphone unit of the other of the first and second sound signal processing apparatuses, by reason that the first and second sound signal processing apparatuses are operative to perform the wireless communication with each other.

In accordance with a fifth aspect of the present invention, there is provided a sound signal processing system, comprising: an audio apparatus for producing a first sound signal; a sound signal processing apparatus, including: a a speaker unit for converting the first sound signal received from the audio apparatus to a first sound; sound signal producing means for producing a second sound signal constituted by at least two different components including an echo component indicative of the first sound outputted by the speaker unit, and a voice component indicative of one's voice having a least one leading end; echo component suppressing means for suppressing the echo component of the second sound signal on the basis of the first and second sound signals to output, as a third sound signal, the suppressed second sound signal; sound signal storing means for storing the third sound signal outputted by the echo component suppressing means; voice detecting means for detecting the leading end of the voice on the basis of the third sound signal outputted by the echo component suppressing means; and controlling means for controlling the sound signal storing means to have the sound signal storing means output, as a fourth sound signal, the third sound signal stored in the time period when the voice is detected on the basis of the third sound signal outputted by the echo component suppressing means, the controlling means being operative to specify two different clock times on the basis of a predetermined time difference, the clock times including a first clock time at which the leading end of the voice is detected by the voice detecting means, and a second clock time prior to the first clock time, the controlling means being operative to have the sound signal storing means start to output the third sound signal stored after the second clock time, and sound signal recording apparatus having recorded therein the fourth sound signal received from the sound signal storing unit of the sound signal processing apparatus.

The voice detecting means of the sound signal processing apparatus thus constructed as previously mentioned can detect at a relatively high accuracy the leading end of the voice component of the third sound signal outputted by the echo component suppressing means under the condition that the first sound signal produced by the audio apparatus is converted to the first sound by the speaker unit, the second sound signal produced by the sound signal producing means is constituted by two different components including an echo component indicative of the first sound outputted by the speaker unit, and a voice component indicative of the voice of the speaker. The sound signal recording apparatus can have recorded therein the fourth sound signal received from the sound signal storing unit of the sound signal processing apparatus.

In accordance with a fourth aspect of the present invention, there is provided a sound signal processing system, comprising: a navigation apparatus including: navigation information producing means for producing navigation information, and sound signal producing means for producing a first sound signal indicative of the navigation information as a navigation guidance; and a sound signal processing apparatus including: a speaker unit for converting the first sound signal received from the navigation apparatus to a first sound; sound signal producing means for producing a second sound signal constituted by at least two different components including an echo component indicative of the first sound outputted by the speaker unit, and a voice component indicative of one's voice having a least one leading end; echo component suppressing means for suppressing the echo component of the second sound signal on the basis of the first and second sound signals to output, as a third sound signal, the suppressed second sound signal; sound signal storing means for storing the third sound signal outputted by the echo component suppressing means; voice detecting means for detecting the leading end of the voice on the basis of the third sound signal outputted by the echo component suppressing means; and controlling means for controlling the sound signal storing means to have the sound signal storing means output, as a fourth sound signal, the third sound signal stored in the time period when the voice is detected on the basis of the third sound signal outputted by the echo component suppressing means, the controlling means being operative to specify two different clock times on the basis of a predetermined time difference, the clock times including a first clock time at which the leading end of the voice is detected by the voice detecting means, and a second clock time prior to the first clock time, the controlling means being operative to have the sound signal storing means start to output the third sound signal stored after the second clock time.

The voice detecting means of the sound signal processing apparatus thus constructed as previously mentioned can detect at a relatively high accuracy the leading end of the voice component of the third sound signal outputted by the echo component suppressing means under the condition that the first sound signal produced by the navigation apparatus is converted to the first sound by the speaker unit, the second sound signal produced by the sound signal producing means is constituted by two different components including an echo component indicative of the first sound outputted by the speaker unit, and a voice component indicative of the voice of the speaker. The navigation apparatus can execute the voice recognition to the fourth sound signal received from the sound signal storing unit of the sound signal processing apparatus.

In accordance with a sixth aspect of the present invention, there is provided a sound signal processing system, comprising: an external apparatus for producing a first sound signal indicative of one's voice; and a sound signal processing apparatus including: a speaker unit for converting the first sound signal received from the external apparatus to a first sound; sound signal producing means for producing a second sound signal constituted by at least two different components including an echo component indicative of the first sound outputted by the speaker unit, and a voice component indicative of one's voice having a least one leading end; echo component suppressing means for suppressing the echo component of the second sound signal on the basis of the first and second sound signals to output, as a third sound signal, the suppressed second sound signal; sound signal storing means for storing the third sound signal outputted by the echo component suppressing means; voice detecting means for detecting the leading end of the voice on the basis of the third sound signal outputted by the echo component suppressing means; and controlling means for controlling the sound signal storing means to have the sound signal storing means output, as a fourth sound signal, the third sound signal stored in the time period when the voice is detected on the basis of the third sound signal outputted by the echo component suppressing means, the controlling means being operative to specify two different clock times on the basis of a predetermined time difference, the clock times including a first clock time at which the leading end of the voice is detected by the voice detecting means, and a second clock time prior to the first clock time, the controlling means being operative to have the sound signal storing means start to output the third sound signal stored after the second clock time, wherein, the external apparatus further comprises voice recognition means for performing the voice recognition of the fourth sound signal received from the sound signal storing means, and the sound signal producing means of the external apparatus is operative to produce the first sound signal in response to the result of the voice recognition performed by the voice recognition means.

The voice detecting means of the sound signal processing apparatus thus constructed as previously mentioned can detect at a relatively high accuracy the leading end of the voice component of the third sound signal outputted by the echo component suppressing means under the condition that the first sound signal produced by the external apparatus is converted to the first sound by the speaker unit, the second sound signal produced by the sound signal producing means is constituted by two different components including an echo component indicative of the first sound outputted by the speaker unit, and a voice component indicative of the voice of the speaker. The external apparatus can execute the voice recognition to the fourth sound signal received from the sound signal storing unit of the sound signal processing apparatus, and produce the first sound signal in reply to the result of the voice recognition.

In accordance with a seventh aspect of the present invention, there is provided a sound signal processing system, comprising: a preparing step of preparing a sound signal processing apparatus, comprising: a speaker unit for converting a first sound signal to a first sound; sound signal producing means for producing a second sound signal constituted by at least two different components including an echo component indicative of the first sound outputted by the speaker unit, and a voice component indicative of one's voice having a least one leading end; echo component suppressing means for suppressing the echo component of the second sound signal on the basis of the first and second sound signals to output, as a third sound signal, the suppressed second sound signal; sound signal storing means for storing the third sound signal outputted by the echo component suppressing means; voice detecting means for detecting the leading end of the voice on the basis of the third sound signal outputted by the echo component suppressing means; and controlling means for controlling the sound signal storing means to have the sound signal storing means output, as a fourth sound signal, the third sound signal stored in the time period when the voice is detected on the basis of the third sound signal outputted by the echo component suppressing means, the controlling means being operative to specify two different clock times on the basis of a predetermined time difference, the clock times including a first clock time at which the leading end of the voice is detected by the voice detecting means, and a second clock time prior to the first clock time, the controlling means being operative to have the sound signal storing means start to output the third sound signal stored after the second clock time, an echo component suppressing step of suppressing the echo component of the second sound signal on the basis of the first and second sound signals to output, as the third sound signal, the suppressed second sound signal; a sound signal storing step of storing the third sound signal with time information in the sound signal storing means; a voice detecting step of detecting a leading end of one's voice on the basis of the third sound signal; and a controlling step of controlling the sound signal storing means to have the sound signal storing means output, as a fourth sound signal, the third sound signal stored in the time period when the voice is detected on the basis of the third sound signal outputted by the echo component suppressing means, the controlling step being of specifying two different clock times on the basis of a predetermined time difference, the clock times including a first clock time at which the leading end of the voice is detected in the voice detecting step, and a second clock time prior to the first clock time, the controlling step being of having the sound signal storing means start to output the third sound signal stored after the second clock time.

The sound signal processing method thus constructed as previously mentioned can reduce the time period up to start to output the echo suppressed sound signal by reason that the controlling step is of specifying two different clock times on the basis of a predetermined time difference, the clock times including a first clock time at which the leading end of the voice is detected in the voice detecting step, and a second clock time prior to the first clock time, the controlling step being of having the sound signal storing means start to output the third sound signal stored after the second clock time.

In accordance with a seventh aspect of the present invention, there is provided a sound signal processing system, comprising: an echo component suppressing step of suppressing an echo component of a second sound signal on the basis of first and second sound signals to output, as a third sound signal, the suppressed second sound signal; a sound signal storing step of storing the third sound signal with time information in sound signal storing means; a voice detecting step of detecting a leading end of one's voice on the basis of the third sound signal; and a controlling step of controlling the sound signal storing means to have the sound signal storing means output, as a fourth sound signal, the third sound signal stored in the time period when the voice is detected on the basis of the third sound signal outputted by the echo component suppressing means, the controlling step being of specifying two different clock times on the basis of a predetermined time difference, the clock times including a first clock time at which the leading end of the voice is detected in the voice detecting step, and a second clock time prior to the first clock time, the controlling step being of having the sound signal storing means start to output the third sound signal stored after the second clock time.

The sound signal processing program thus constructed as previously mentioned can reduce the time period up to start to output the echo suppressed sound signal by reason that the controlling step is of specifying two different clock times on the basis of a predetermined time difference, the clock times including a first clock time at which the leading end of the voice is detected in the voice detecting step, and a second clock time prior to the first clock time, the controlling step being of having the sound signal storing means start to output the third sound signal stored after the second clock time.

In accordance with an eighth aspect of the present invention, there is provided a recordable media having recorded therein a sound signal processing program to be executed by a computer, the sound signal processing program, comprising: an echo component suppressing step of suppressing an echo component of a second sound signal on the basis of first and second sound signals to output, as a third sound signal, the suppressed second sound signal; a sound signal storing step of storing the third sound signal with time information in sound signal storing means; a voice detecting step of detecting a leading end of one's voice on the basis of the third sound signal; and a controlling step of controlling the sound signal storing means to have the sound signal storing means output, as a fourth sound signal, the third sound signal stored in the time period when the voice is detected on the basis of the third sound signal outputted by the echo component suppressing means, the controlling step being of specifying two different clock times on the basis of a predetermined time difference, the clock times including a first clock time at which the leading end of the voice is detected in the voice detecting step, and a second clock time prior to the first clock time, the controlling step being of having the sound signal storing means start to output the third sound signal stored after the second clock time.

The recordable media thus constructed as previously mentioned can reduce the time period up to start to output the echo suppressed sound signal by reason that the controlling step is of specifying two different clock times on the basis of a predetermined time difference, the clock times including a first clock time at which the leading end of the voice is detected in the voice detecting step, and a second clock time prior to the first clock time, the controlling step being of having the sound signal storing means start to output the third sound signal stored after the second clock time.

### BRIEF DESCRIPTION OF THE DRAWINGS

The features and advantages of the sound signal processing apparatus according to the present invention will be more clearly understood from the following description taken in conjunction with the accompanying drawings:

FIG. 1 is a block diagram showing the constitution of the first embodiment of the sound signal processing apparatus according to the present invention;

FIG. 2 is a block diagram showing one example of echo cancellers each forming part of the first embodiment of the sound signal processing apparatus according to the present invention;

FIG. 3 is a showing another example of the echo cancellers each forming part of the first embodiment of the sound signal processing apparatus according to the present invention;

FIG. 4 is a graph showing the third sound signal outputted by the echo canceller of the sound signal processing apparatus according to the first embodiment of the present invention;

FIG. 5 is a graph showing the operation of the voice detecting means of the sound signal processing apparatus according to the first embodiment of the present invention;

FIG. 6 is a block diagram showing the constitution of the first modified embodiment similar to the first embodiment of the sound signal processing apparatus;

FIG. 7 is a schematic diagram showing the first modified embodiment similar to the first embodiment of the sound signal processing apparatus;

FIG. 8 is a block diagram showing the constitution of the second modified embodiment similar to the first embodiment of the sound signal processing apparatus;

FIG. 9 is a schematic diagram showing as an example of the voice interactive system;

FIG. 10 is a schematic diagram showing as an example of the voice interactive system;

FIG. 11 is a block diagram showing the constitution of the second embodiment of the sound signal processing apparatus according to the present invention;

FIG. 12 is a schematic graph showing the method of setting the threshold level by the voice detecting means of the sound signal processing apparatus according to the second embodiment of the present invention;

FIG. 13 is a schematic graph showing the recognition rate on the sound signal outputted by the sound signal processing apparatus according to the second embodiment of the present invention in comparison with the recognition rate on the sound signal outputted by the conventional sound signal processing apparatus;

FIG. 14 is a block diagram showing the third embodiment of the sound signal processing apparatus according to the present invention;

FIG. 15 is a block diagram showing the fourth embodiment of the sound signal processing apparatus according to the present invention;

FIG. 16 is a block diagram showing the fifth embodiment of the sound signal processing apparatus according to the present invention;

FIG. 17 is a block diagram showing the sixth embodiment of the sound signal processing apparatus according to the present invention;

FIG. 18 is a block diagram showing the seventh embodiment of the sound signal processing apparatus according to the present invention;

FIG. 19 is a block diagram showing the eighth embodiment of the sound signal processing apparatus according to the present invention;

FIG. 20 is a block diagram showing the ninth embodiment of the sound signal processing apparatus according to the present invention;

FIG. 21 is a block diagram showing the tenth embodiment of the sound signal processing apparatus according to the present invention;

FIG. 22 is a block diagram showing the eleventh embodiment of the sound signal processing apparatus according to the present invention;

FIG. 23 is a block diagram showing the twelfth embodiment of the sound signal processing apparatus according to the present invention;

FIG. 24 is a block diagram showing the thirteenth embodiment of the sound signal processing apparatus according to the present invention;

FIG. 25 is a block diagram showing the fourteenth embodiment of the sound signal processing system according to the present invention;

FIG. 26 is a block diagram showing, as one example, the echo canceller of the sound signal processing system according to the fourteenth embodiment of the present invention;

FIG. 27 is a block diagram showing, as another example, the echo canceller of the sound signal processing system according to the fourteenth embodiment of the present invention;

FIG. 28 is a block diagram showing the fourteenth embodiment of the sound signal processing system according to the present invention;

FIG. 29 is a schematic diagram showing a remote controller provided with the sound signal processing apparatus according to the present invention;

FIG. 30 is a schematic diagram showing a voice interactive system provided with the sound signal processing apparatus according to the present invention;

FIG. 31 is a schematic block diagram showing the constitution of the fifteenth embodiment of the sound signal processing system according to the present invention;

FIG. 32 is a flowchart showing the operation of the sound signal processing system according to the fifteenth embodiment of the present invention;

FIG. 33 is a block diagram showing, as one typical example, the constitution of the conventional sound signal processing apparatus; and

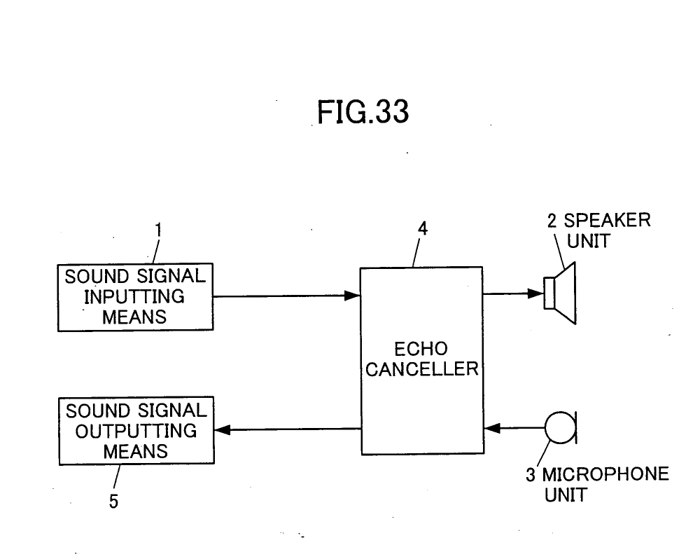

FIG. 34 is a block diagram showing as another typical example, the constitution of the conventional sound signal processing apparatus.

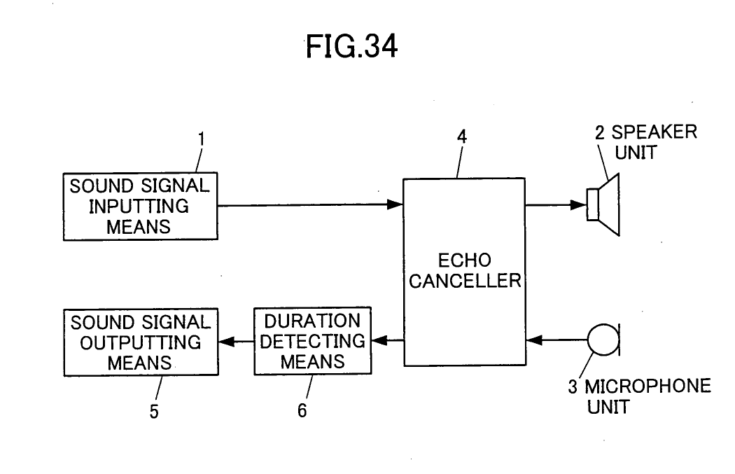

### DESCRIPTION OF THE PREFERRED EMBODIMENTS

The first to fifteenth embodiments of the sound signal processing apparatus according to the present invention will be described hereinafter in accordance with accompanying drawings.

### First Embodiment

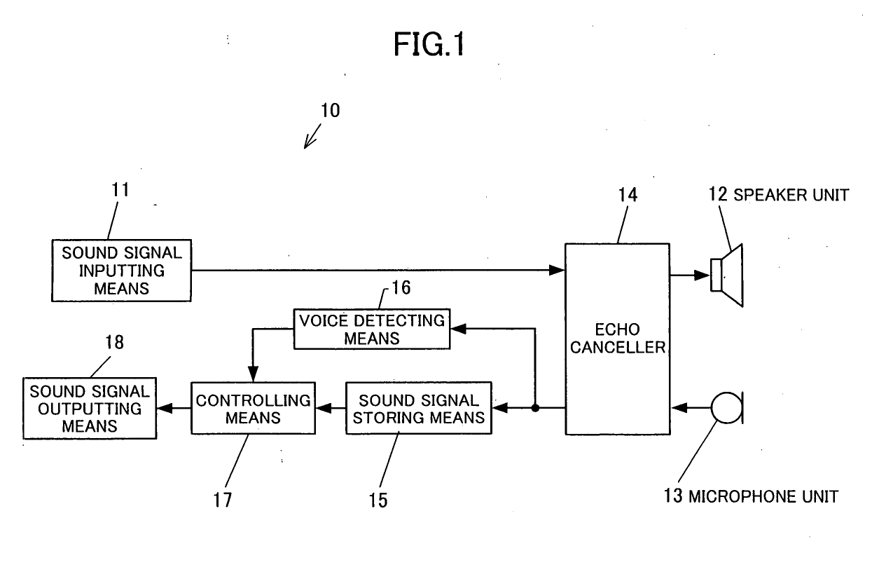

The sound signal processing apparatus 10 is shown in FIG. 1 as comprising sound signal inputting means 11 for inputting a first sound signal, a speaker unit 12 for converting the first sound signal inputted by the sound signal inputting means 11 to the first sound, and a microphone unit 13 for producing a second sound signal constituted by three different components including an echo component indicative of the sound outputted by the speaker unit 12, a voice component indicative of one's voice having a least one leading end, and an background noise component indicative of background sounds produced in the vicinity of the microphone unit 13. Here, the microphone unit 13 constitutes sound signal producing means.

The sound signal processing apparatus 10 further comprises echo canceller 14 for suppressing the echo component of the second sound signal on the basis of the first sound signal inputted by the sound signal inputting means 11 and the second sound signal produced by the microphone unit 13 to output the suppressed second sound signal as a third sound signal, sound signal storing means 15 for storing the third sound signal outputted by the echo canceller 14, voice detecting means 16 for detecting the leading end of the voice on the basis of the third sound signal outputted by the echo canceller 14, controlling means 17 for controlling the sound signal storing means 15 to have the sound signal storing means 15 output, as a fourth sound signal, the third sound signal stored in the time period when the voice is detected on the basis of the third sound signal outputted by the echo canceller 14, and sound signal outputting means 18 for outputting the fourth sound signal. The controlling means 17 is operative to specify two different clock times on the basis of a predetermined time difference, the clock times including a first clock time at which the leading end of the voice is detected by the voice detecting means 16, and a second clock time prior to the first clock time. The controlling means 17 is operative to have the sound signal storing means 15 start to retroactively output the third sound signal stored after the second clock time. Here, the echo canceller 14 constitutes echo component suppressing means.

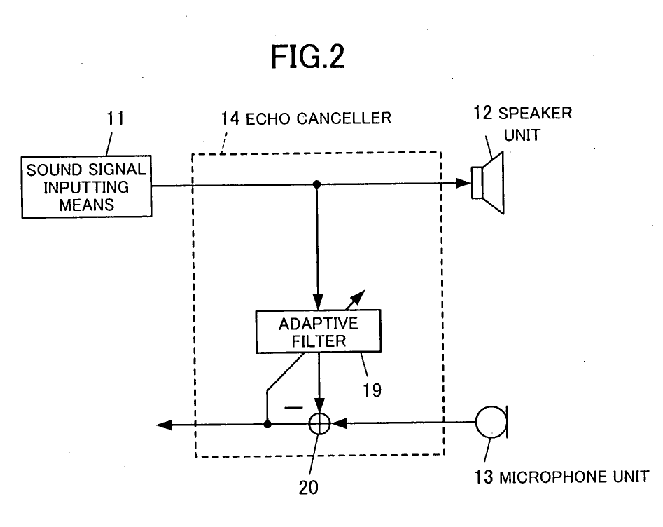

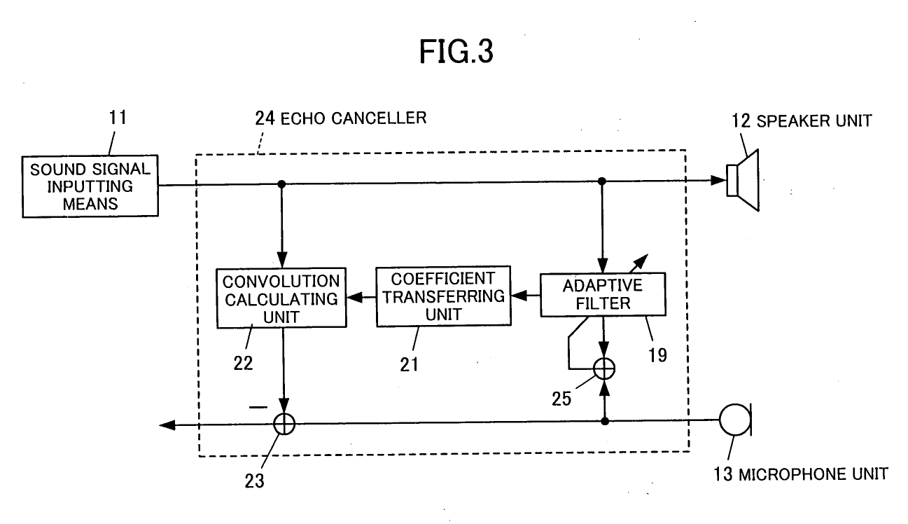

The echo canceller 14 is shown in FIG. 2 as including an adaptive filter 19 for estimating the echo component of the second sound signal to output a replica echo signal indicative of the estimated echo component of the second sound signal, and a subtracting unit 20 for subtracting the replica echo signal produced by the adaptive filter 19 from the second sound signal produced by the microphone unit 13 to output a signal indicative of the difference between the second sound signal and the replica echo signal. The echo canceller 14 is operative to output, as a third sound signal, the signal produced by the subtracting unit 20. The adaptive filter 19 is operative to produce the replica echo signal on the basis of the first sound signal and the signal outputted by the subtracting unit 20. Here, the echo canceller 14 shown in FIG. 2 may be replaced by an echo canceller 24 shown in FIG. 3.

As shown in FIG. 3, the echo canceller 24 includes an adaptive filter 19 for estimating a filter coefficient, a convolution calculating unit 22 for producing a replica echo signal indicative of the echo component of the second sound signal by calculating the convolution of the first sound signal with respect to the filter coefficient estimated by the adaptive filter 19, a filter coefficient transferring unit 21 for transferring the filter coefficient estimated by the adaptive filter 19 to the convolution calculating unit 22, and a first subtracting unit 23 for subtracting the replica echo signal produced by the convolution calculating unit 22 from the second sound signal produced by the microphone unit 13 to output a signal indicative of the difference between the second sound signal and the replica echo signal. The adaptive filter 19 is operative to estimate the filter coefficient on the basis of the first sound signal and the signal outputted by the first subtracting unit 23.

The echo canceller 24 is operative to output, as a third signal, the signal outputted by the first subtracting unit 23. The adaptive filter 19 is operative to estimate not only the filter coefficient but also the echo component of the second sound signal on the basis of the first sound signal and the signal outputted by the first subtracting unit 23 to produce a replica echo signal indicative of the echo component of the second sound signal.

The echo canceller 24 further includes a second subtracting unit 25 for subtracting the replica echo signal produced by the adaptive filter 19 from the second sound signal produced by the microphone unit 13 to output a signal indicative of the difference between the second sound signal and the replica echo signal. The adaptive filter 19 is operative to update the filter coefficient in response to the signal outputted by the second subtracting unit 25.

The filter coefficient transferring unit 21 is operative to judge whether the filter coefficient estimated by the adaptive filter 19 is being varied or relatively stable. When the judgment is made that the estimated filter coefficient converges with the le value, the filter coefficient transferring unit 21 is operative to transfer the filter coefficient estimated by the adaptive filter 19 to the convolution calculating unit 22. The convolution calculating unit 22 is operative to produce the replica echo signal by calculating the convolution of the first sound signal with respect to the filter coefficient updated by the filter coefficient transferring unit 21.

The echo canceller 24 shown in FIG. 3 is the same in construction as an echo canceller disclosed in non-patent document 1. The algorithm of the adaptive filter 19 of the echo canceller 24 shown in FIG. 3 is the same as an algorithm disclosed in each of non-patent documents 1 and 2. Therefore, the algorithm of the adaptive filter 19 of the echo canceller 24 will not described hereinafter in detail.

Non Patent Document 1: “method of transferring filter coefficient to one of dual filters from the other of dual filters in echo canceller” of collected papers of Acoustical Society of Japan, written by Oho, Matsui, Terada, and Nakayama, 3-p-10, pages 491-492, Oct, 1999.

Non Patent Document 2: “Introduction to Adaptive filter” written by Simon Haykin, and translated by Tsuyoshi Takebe, Gendai-Kogakusha, 1987.

The first and second sound signals are respectively represented by legends “x(i)” and “y(i)”, and discretely and digitally processed by the sound signal processing apparatus according to the present invention with the exception of the speaker unit 12 and the microphone unit 13. Here, the legend “i” of each of the first and second sound signals x(i) and y(i) is the i-th of respective data string. The voice component of the second sound signal, the echo component of the second sound signal, and the noise component of the second sound signal are respectively represented by legends “s(i)”, “y(i)”, and “n(i)”. Additionally, the second signal d(i) is represented by an equation d(i)=s(i)+y(i)+n(i).

The following description will be directed to the case that the sound signal processing apparatus 10 according to the first embodiment of the present invention is operative in combination with to a navigation apparatus for producing, as navigation information, a first sound signal to be outputted to the speaker unit 12 through the sound signal inputting means 11.

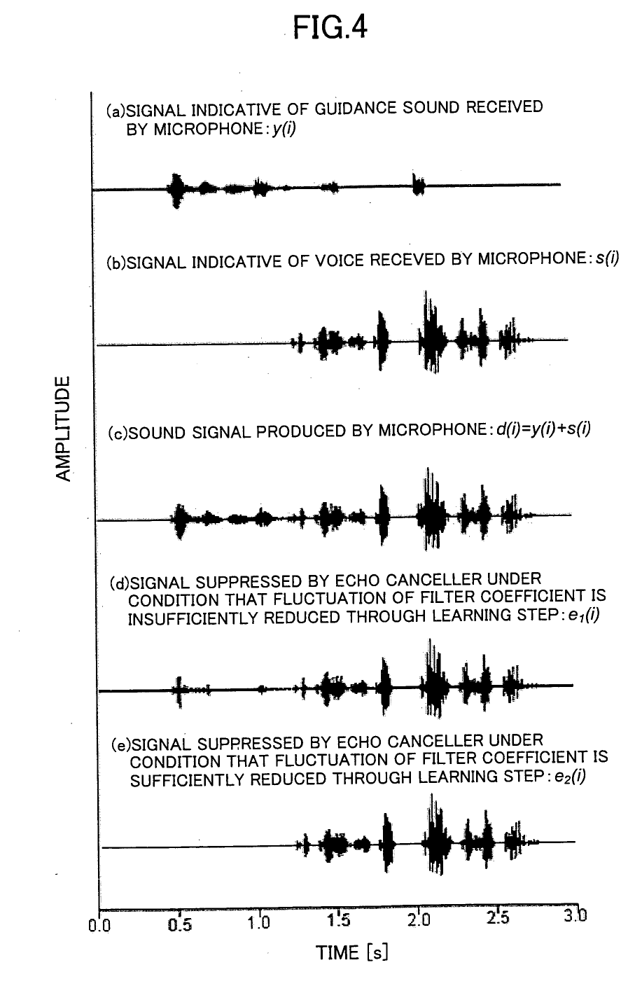

The echo component y(i) of the second sound signal d(i) produced by the microphone unit 13, the voice component s(i) of the second sound signal d(i), the second sound signal d(i)=y(i)+s(i), and the third sound signal e(i) produced by the echo canceller 14 are shown in FIG. 4 as examples under the condition that the back ground noise component n(i) is negligible small.

The third sound signal e1(i) outputted by the echo canceller 14 under the condition that the filter coefficient produced by the adaptive filer 19 is unstable (the filter coefficient is varied with time) and the third sound signal e2(i) outputted by the echo canceller 14 under the condition that the filter coefficient produced by the adaptive filter 19 is relatively stable (the filter coefficient substantially converges with a value) are respectively shown in FIGS. 4(d) and 4(e).

As will be seen from FIGS. 4(d) and 4(e), the echo component of the second sound signal can be insufficiently suppressed by the echo canceller 14 under the condition that the filter coefficient produced by the adaptive filer 19 is unstable (the filter coefficient is varied with time). On the other hand, the echo component of the second sound signal is sufficiently suppressed by the echo canceller 14 under the condition that the filter coefficient produced by the adaptive filter 19 is relatively stable (the filter coefficient substantially converges with a value).

The voice detecting means 16 is operative to detect the leading end of the voice component of the third sound signal e(i) through the steps of measuring the signal level of the third sound signal e(i), comparing the measured signal level of the third sound signal e(i) with a predetermined threshold level, judging whether or not the measured signal level of the third sound signal e(i) exceeds the predetermined threshold level, producing a control signal to be outputted to the controlling unit 17, the control signal having information about the time when the measured signal level of the third sound signal e(i) exceeds the predetermined threshold level.

Here, the voice detecting means 16 may be operative to update the predetermined threshold level on the basis of the judgment on whether or not the sound is being outputted by the speaker unit 12, and to judge whether or not the signal level of the third sound signal e(i) exceeds the updated threshold level before detecting the leading end of the voice component of the third sound signal e(i).

The voice detecting means 16 may be operative to update the predetermined threshold level on the basis of the duration of the sound outputted by the speaker unit 12, and to judge whether or not the signal level of the third sound signal e(i) exceeds the updated threshold level before detecting the leading end of the voice component of the third sound signal e(i).

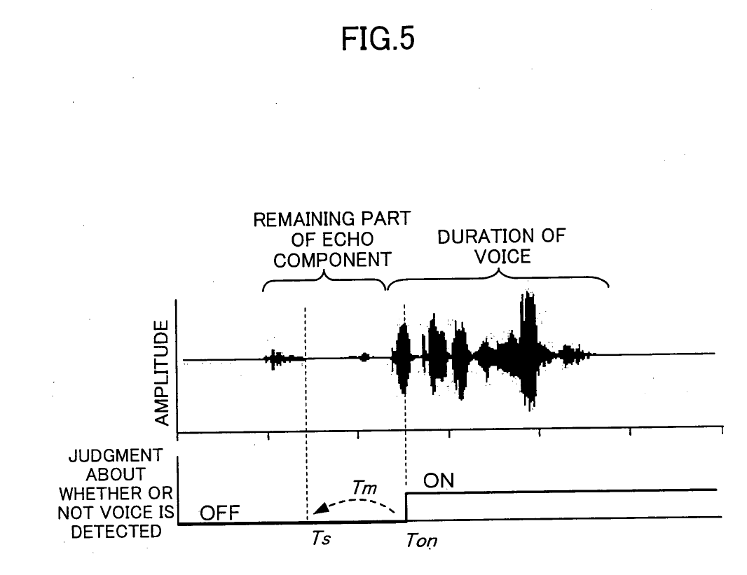

FIG. 5 is a graph partially showing the third sound signal e(i) outputted by the echo canceller in comparison with the control signal produced by the voice detecting means 16.

The voice detecting means 16 is operative to produce a control signal to be outputted to the controlling means 17, the control signal having two different states including a state “OFF” before the leading end of the voice is detected by the voice detecting means 16, the control signal having a state “ON” after the leading end of the voice is detected by the voice detecting means 16. The voice detecting means 16 is operative to allow the control signal to transit from the state “OFF” to the state “ON” at the time when the leading end of the voice component of third sound signal e(i) is detected by the voice detecting means 16.

As will be seen from FIG. 5, the time “Ton” when the control signal transits from the state “OFF” to the state “ON” is slightly delayed in comparison with the time when the leading end of the voice component of third sound signal e(i) is detected by the voice detecting means 16. Accordingly, the controlling means 17 is operative to specify two different clock times on the basis of a predetermined time difference, i.e., an above mentioned time-lag, the clock times including a first clock time at which the leading end of the voice is detected by the voice detecting means 16, and a second clock time “Ts” prior to the first clock time. The controlling means 17 is operative to have the sound signal storing means 15 start to retroactively output the third sound signal stored after the second clock time “Ts” to the sound signal outputting means 18.

The sound signal outputting means 18 is operative to output the fourth sound signal as the voice of the speaker. From the above detail description, it will be understood that the sound signal processing apparatus 10 according to the first embodiment of the present invention can sufficiently suppress the echo component of the second sound signal.

The operation of the sound signal processing apparatus 10 according to the first embodiment of the present invention will be described hereinafter. The first sound signal such as for example “What can I do for you?” is firstly inputted to the sound signal inputting means 11, while the first sound signal is received by the sound signal inputting means 11. The first sound signal is received by the sound signal inputting means 11 is outputted to the speaker unit 12, while the first sound is converted to the first sound by the speaker unit 12.

On the other hand, the voice such as for example “I want to go to amusement park A” is received by the microphone unit 13. The second sound signal is produced by the microphone unit 13. The second sound signal is two different components including a voice component indicative of the voice, and an echo component indicative of the first sound outputted by the speaker unit 12. From the above detail description, it will be understood that the second sound signal is deteriorated by the echo component as a result of the fact that the first sound is received by the microphone unit 13. Therefore, the echo component of the second sound signal is suppressed by the echo canceller 14.

The suppression of the echo component of the second sound signal to be performed by the echo canceller 14 will be described hereinafter with reference to FIG. 2.

Here, the time-series data on audio guidance i.e., the first sound signal by the sound signal inputting means 11 is represented by a legend x(i). The echo component indicative of the first sound converted from the first sound signal x(i) by the speaker unit 12, the voice component indicative of the voice of the speaker, and the background noise component indicative of the sound produced in the vicinity of the microphone unit 13 are respectively represented by legends y(i), s(i), and n(i). Therefore, the second sound signal d(i) produced by the microphone unit 13 is defmed as d(i)=s(i)+y(i)+n(i).

The replica echo signal yd(i) indicative of the estimated echo component of the second sound signal is produced by the echo canceller 14. As a result of the fact that the suppression of the echo component of the second sound signal is performed by the echo canceller 14, the signal e(i)=d(i)−yd(i) is outputted, as the third sound signal, to each of the sound signal storing means 15 and voice detecting means 16 by the echo canceller 14. The third sound signal e(i) is sequentially and temporary stored by the sound signal storing means 15.

On the other hand, the voice of the speaker is detected by the voice detecting means 16 on the basis of the third sound signal e(i) received from the echo canceller 14. In this step, the power value P(i) of the third sound signal e(i) may be calculated by the voice detecting means 16, while the judgment is made whether or not the calculated power value P(i) of the third sound signal e(i) is larger than the threshold level “TH”. When the judgment is made that the calculated power value P(i) of the third sound signal e(i) is larger than the threshold level “TH”, the voice detecting means 16 judges that the power value P(i) of the third sound signal e(i) is increased in response to the voice received by the microphone unit 13.

The detection of the leading end of the voice to be performed by the voice detecting means 16 will be more specifically described hereinafter.

As shown in FIG. 5, the third sound signal e(i) outputted by the echo canceller 14 is constituted by two different components including a remaining echo component indicative of the difference between the echo component y(i) and the replica echo signal yd(i), and a voice component s(i) indicative of the voice of the speaker. The control signal produced by the voice detecting means 16, shown in FIG. 5 with the third sound signal e(i) outputted by the echo canceller 14, has two different levels including a low level “L” before the leading end of the voice is detected by the voice detecting means 16, the control signal having a high level “H” after the leading end of the voice is detected by the voice detecting means 16. The voice detecting means 16 is operative to allow the control signal to transit from the low level “L” to the high level “H” at the time “Ton” when the leading end of the voice component of third sound signal is detected by the voice detecting means 16.

As will be seen from FIG. 5, the control signal transits from the low level “L” to the high level “H” with some delay after the speaker starts to talk to the microphone unit 13. The controlling means 17 is operative to specify two different clock times on the basis of a predetermined time difference, the clock times including a first clock time at which the leading end of the voice is detected by the voice detecting means 16, and a second clock time prior to the first clock time. The controlling means 17 is operative to have the sound signal storing means 15 start to retroactively output the third sound signal stored after the second clock time.

The sound signal outputting means 18 can output the suppressed fourth sound signal to the external apparatus only for the time period when the voice is detected in the third sound signal outputted by the echo canceller 14 by reason that the controlling means 17 is operative to specify two different clock times on the basis of a predetermined time difference, the clock times including a first clock time at which the leading end of the voice is detected by the voice detecting means 16, and a second clock time prior to the first clock time, the controlling means 17 being operative to have the sound signal storing means 15 start to output the third sound signal stored after the second clock time.

From the above detail description, it will be understood that the sound signal processing apparatus 10 can sufficiently suppress the echo component of the second sound signal to be transmitted to the external apparatus in comparison with the conventional sound signal processing apparatus, and reduce the time period up to start to output the suppressed second sound signal to the external apparatus.

From the above detail description, it will be understood that the sound signal processing apparatus 10 according to the first embodiment of the present invention can detect at a relatively high accuracy the leading end of the voice component of the third sound signal on the basis of the third sound signal outputted by the echo canceller 14 even if the echo component of the second sound signal is insufficiently suppressed by echo canceller 14.

The sound signal processing apparatus 10 according to the first embodiment of the present invention may be operative in combination with a voice recognition apparatus for performing the voice recognition to the fourth sound signal outputted by the sound signal outputting means 18. In this particular case, the sound signal processing apparatus 10 according to first embodiment of the present invention can have the voice recognition apparatus effectively perform the voice recognition by reason that the controlling means 17 is operative to have the sound signal storing means 15 output the fourth sound signal to the sound signal outputting means 18 only for a time period that the speaker is talking to the microphone array 13.

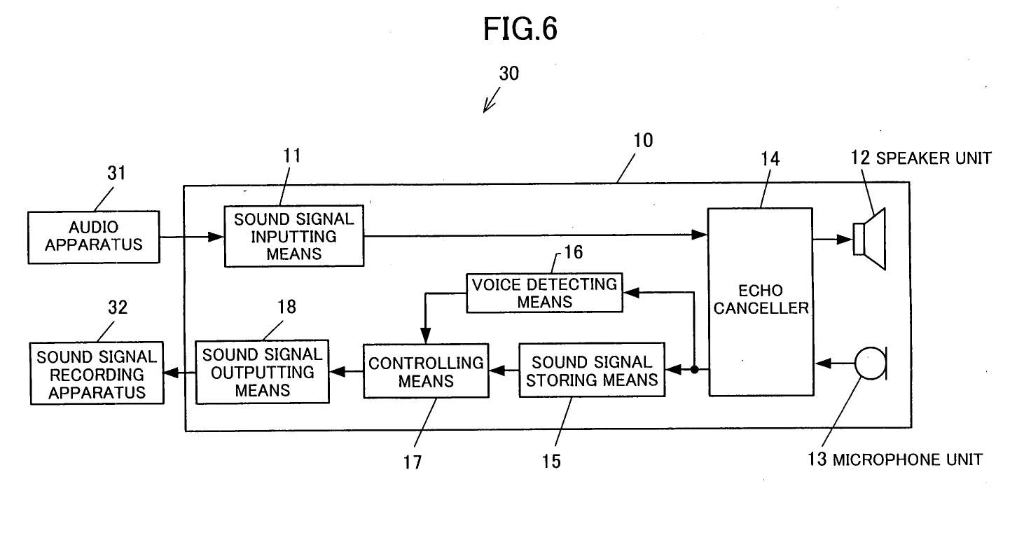

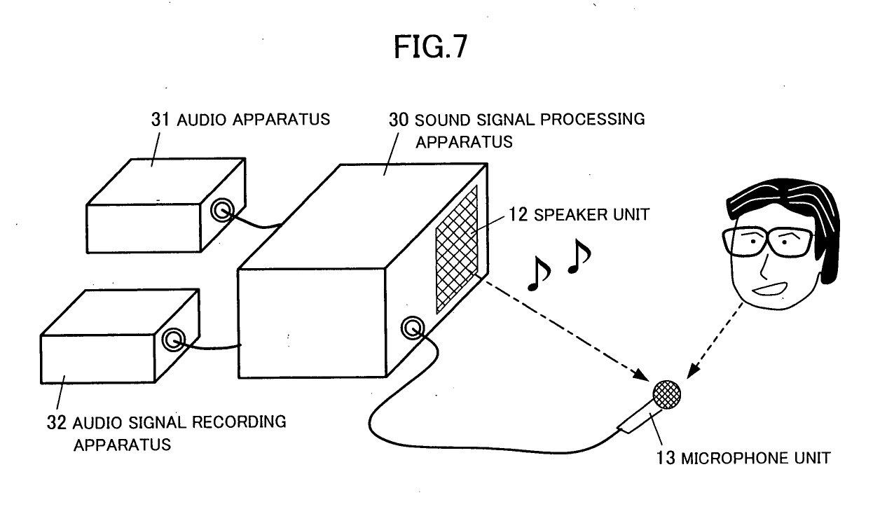

The first modified embodiment of the sound signal processing apparatus 30 similar to the first embodiment of the sound signal processing apparatus 10 according to the present invention will be described hereinafter with reference to FIGS. 6 to 7.

As shown in FIGS. 6 to 7, the sound signal processing apparatus 30 according to the first modified embodiment is operative in combination with an audio apparatus 31 for producing a first sound signal to be outputted as music. The echo canceller 14 of the sound signal processing apparatus 30 according to the first modified embodiment is operative to suppress the echo component of the second sound signal produced by the microphone unit 13.

In this modified embodiment, the sound signal processing apparatus 30 can suppress the echo component of the sound signal to be outputted to the sound signal recording apparatus 32 when the voice is recorded by the sound signal recording apparatus 32 with the sound outputted by the speaker unit 12.

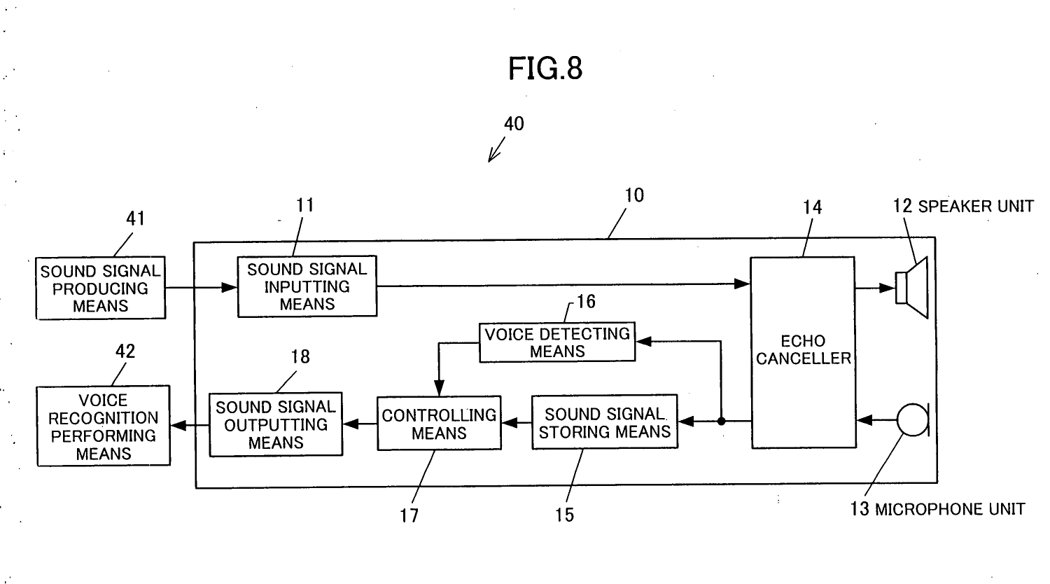

The second modified embodiment of the sound signal processing apparatus 40 similar to the first embodiment of the sound signal processing apparatus 10 according to the present invention will be described hereinafter with reference to FIGS. 8 to 10.

As shown in FIGS. 8 to 10, the sound signal processing apparatus 40 according to the second modified embodiment is built in an electronic apparatus which comprises sound signal producing means 41 for producing, as an audio guidance, a first sound signal to be outputted to the sound signal processing apparatus 40, and voice recognition means 42 for performing the voice recognition to the voice received by the microphone unit 13. The sound signal processing apparatus 40 according to the second modified embodiment is operative to suppress the echo component of the second sound signal produced by the microphone unit 13.

The sound signal processing apparatus 40 thus constructed as previously mentioned can have the voice recognition means 42 effectively perform the voice recognition to the voice received by the microphone unit 13.

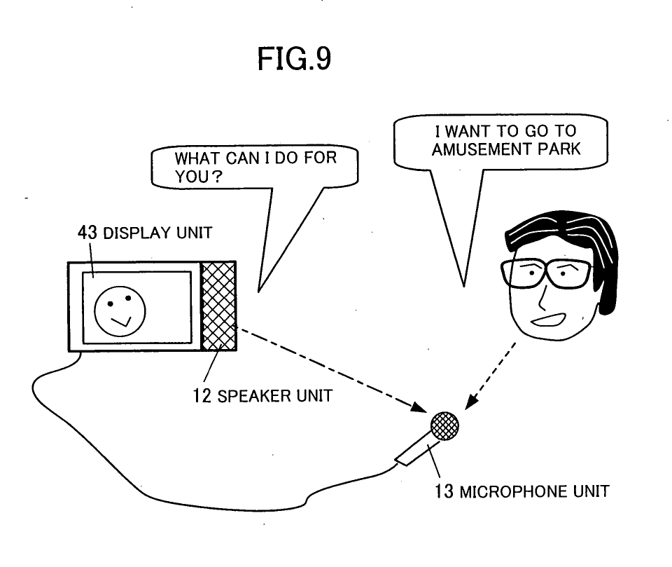

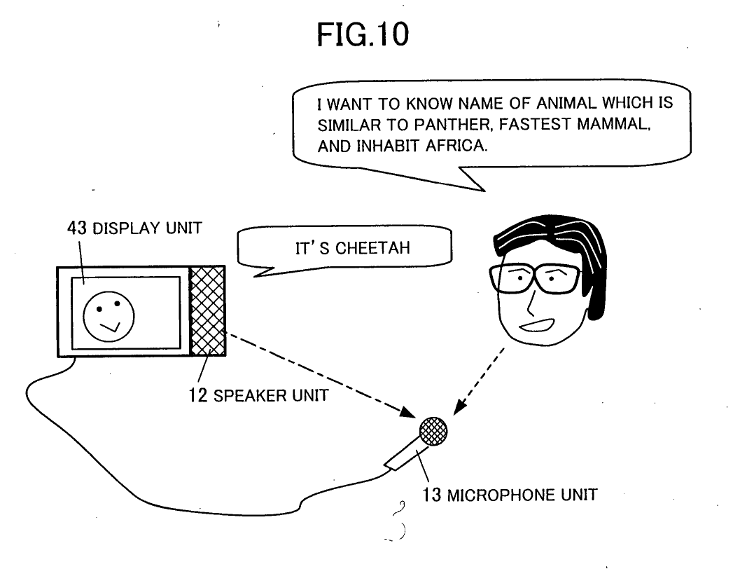

As will be seen from FIGS. 9 and 10, the electronic apparatus may be operative to display a moving picture such as of example an animation character in response to the guidance sound and the recognized voice. In this case, the operator can operate the electronic apparatus to as through it were an interpersonal communication.

### Second Embodiment

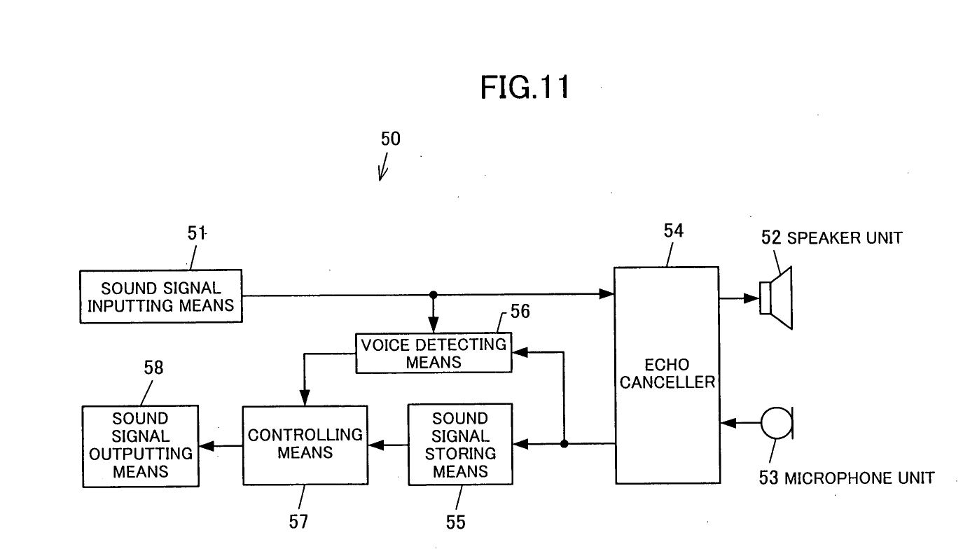

Although there has been described in the above about the first embodiment of the sound signal processing apparatus according to the present invention, the objects of the present invention may be attained by the second embodiment of the sound signal processing apparatus according to the present invention. The second embodiment of the sound signal processing apparatus will then be described hereinafter with reference to FIGS. 11 to 13.

The sound signal processing apparatus 50 according to the second embodiment of the present invention is shown in FIG. 11 as comprising sound signal inputting means 51, a speaker unit 52, a microphone unit 53, an echo canceller 54, sound signal storing means 55, sound signal outputting means 58, voice detecting means 56 for detecting the leading end of the voice of the speaker on the basis of the first sound signal inputted by the sound signal inputting means 51 and the third sound signal outputted by the echo canceller 54, and controlling means 57 for controlling the sound signal storing means 55 to have the sound signal storing means 55 output, as a fourth sound signal, the third sound signal stored in the time period when the voice is detected in the third sound signal outputted by the echo canceller 54. The controlling means 57 is operative to specify two different clock times on the basis of a predetermined time difference, the clock times including a first clock time at which the leading end of the voice is detected by the voice detecting means 56, and a second clock time prior to the first clock time. The controlling means 57 is operative to have the sound signal storing means 55 start to retroactively output the third sound signal stored after the second clock time to the sound signal outputting means 58.

The voice detecting means 56 is operative to detect the leading end of the voice component of the third sound signal by measuring the signal level of each of the first and third sound signals, and by comparing the signal level of each of the measured first and third sound signals with a predetermined threshold level.

In this embodiment of the sound signal processing apparatus 50 according to the present invention, the voice detecting means 56 is operative to detect the leading end of the voice component of the third sound signal by measuring the signal level of each of the first and third sound signals, and by comparing the signal level of each of the measured first and third sound signals with a predetermined threshold level. However, the voice detecting means may be operative to detect the leading end of the voice component of the third sound signal by measuring the first and third power values of the first and third sound signals, and by comparing each of the first and third power values of the first and third sound signals with a predetermined threshold level. The voice detecting means may be operative to perform the frequency analysis of each of the first and third sound signals to detect the leading end of the voice component of the third sound signal on the basis of the result of the frequency analysis. The voice detecting means may be operative to detect the leading end of the voice component of the third sound signal through the steps of measuring the signal level of the background noise component of the third sound signal, updating the predetermined threshold level on the basis of the measured signal level of the background noise component of the third sound signal, and comparing the measured signal level of each of the first and third sound signals with the updated predetermined threshold level.

From the above detail description, it will be understood that the voice detecting means 56 can detect at a relatively high accuracy the leading end of the voice component of the third sound signal by judging whether or not the voice of the speaker is being received by the microphone unit 53 on the basis of the first sound signal inputted by the sound signal inputting means 51 and the third sound signal outputted by the echo canceller 54.

The voice detecting means 56 can detect at a relatively high accuracy the leading end of the voice component of the third sound signal by increasing the threshold level to be compared with the second sound signal produced by the microphone unit 53 when the judgment is made that the sound is being outputted by the speaker unit 52 on the basis of the first sound signal inputted by the sound signal inputting means 51.

The voice detecting means 56 is operative to detect the leading end of the voice component of the third sound signal through the steps of smoothing the third sound signal e(i) outputted by the echo canceller 54, measuring the signal level Pe(i) of the smoothed third sound signal e(i), storing the measured signal level Pe(i) of the smoothed third sound signal e(i) as a smoothed signal level Pn(i) of the background noise component indicative of background sounds produced in the vicinity of the microphone unit 53 when the judgment is made that the sound of the speaker unit 52 and the voice of the speaker is not being received by the microphone unit 53, calculating the difference “L(i)=Pe(i)−Pn(i)” between the measured signal level Pe(i) of the smoothed third sound signal e(i) and the smoothed signal level Pn(i) of the background noise component of the smoothed third sound signal e(i) in frame, judging whether or not the calculated difference L(i) exceeds a predetermined threshold level. The voice detecting means 56 is operative to judge that the voice of the speaker is being received by the microphone unit 53 by judging that the calculated difference “L(i)=Pe(i)−Pn(i)” exceeds the predetermined threshold level.

It's preferable that the voice detecting means 56 is operative to detect the leading end of the voice component of the third sound signal through the steps of measuring the duration of the sound to be outputted by the speaker unit 52, updating the threshold level on the basis of the measured duration of the sound to be outputted by the speaker unit 52, and comparing the signal level of each of the first and third sound signals with the updated predetermined threshold level.

It's preferable that the voice detecting means 56 is operative to detect the leading end of the voice component of the third sound signal through the steps of judging whether or not the sound is being outputted by the speaker unit 52, updating the threshold level on the basis of this judgment, and comparing the signal level of each of the first and third sound signals with the updated predetermined threshold level.

It's preferable that the voice detecting means 56 is operative to proportionally update the predetermined threshold level on the basis of the signal level Pe(i) of the smoothed third sound signal e(i).

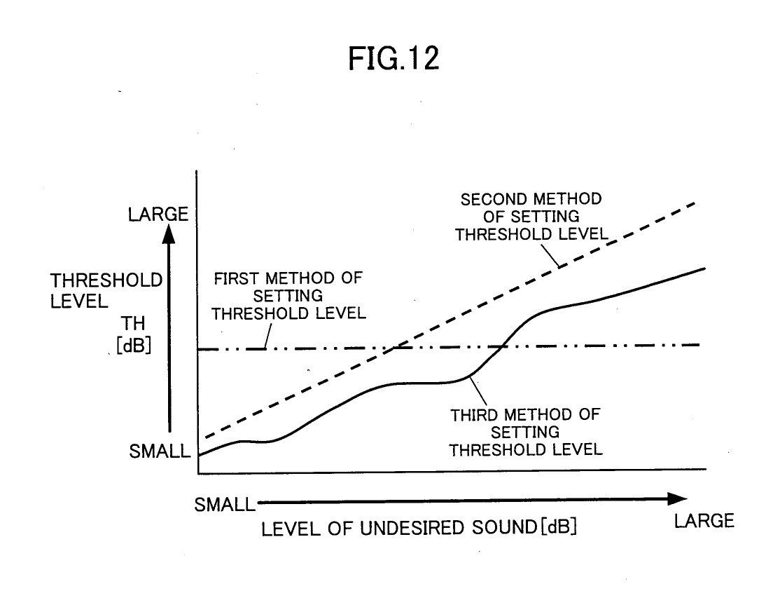

As a first method 1 of setting the threshold level “TH”, the voice detecting means 56 may be operative to maintain the threshold level “TH” without updating the threshold level “TH” in response to the signal level Pe(i) of the smoothed third sound signal e(i) as shown in FIG. 12.

As a second method 2 of setting the threshold level “TH”, the voice detecting means 56 may be operative to update the threshold level “TH” in proportional relationship with the signal level Pe(i) of the smoothed third sound signal e(i).

As a third method 3 of setting the threshold level “TH”, the voice detecting means 56 may be operative to maintain the threshold level “TH” without updating the threshold level “TH” in response to the signal level Pe(i) of the smoothed third sound signal e(i) within one or more specific ranges of the background noise signal, and to update the threshold level “TH” in proportional relationship with the signal level Pe(i) of the smoothed third sound signal e(i) within remaining range of the background noise signal.

The following description will be directed to the method of setting the threshold level “TH” to allow the echo component of the second sound signal to be effectively suppressed by the echo canceller. Its preferable that the threshold level is increased when the judgment is made that the level of the noise component is relatively large by reason that the level of the voice received by the microphone unit is generally large when the level of the noise component is relatively large.

The voice detecting means 56 may be operative to update the threshold level “TH” by judging whether or not the sound is being outputted by the speaker unit 52. The sound signal processing apparatus 50 according to the present invention can effectively suppress the echo component of the second sound signal by reason that the voice detecting means 56 is operative to reduce the threshold level “TH” When the judgment is made that the sound is not outputted by the speaker unit 52.

The voice detecting means 56 may be operative to update the threshold level “TH” on the basis of the sum of the time period when the sound is outputted by the speaker unit 52 by reason that the echo component is generally suppressed at a relatively low reliability under the condition that the sum of the time period is relatively small. Its preferable that the third sound signal is compared with the relatively large threshold level.

From the above detail description, it will be understood that the sound signal processing apparatus 50 according to the second embodiment of the present invention can effectively suppress the echo component of the second sound signal to output the suppressed second sound signal by reason that the voice detecting means 56 is operative to update the threshold level to detect the voice of the speaker on the basis of the updated threshold level.

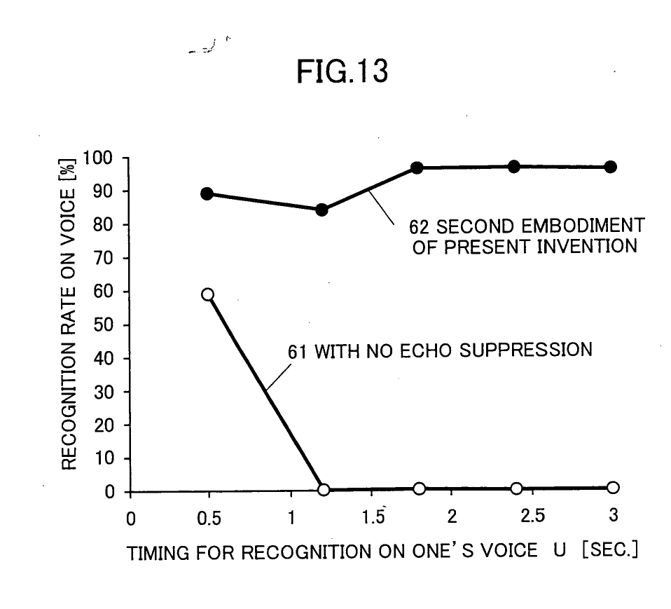

FIG. 13 is a schematic graph showing the recognition rate on the sound signal outputted by the sound signal processing apparatus according to the second embodiment of the present invention in comparison with the recognition rate on the sound signal outputted by the conventional sound signal processing apparatus under the condition that the second sound is received by the microphone unit 53 in the time period when the first sound is being outputted by the speaker unit 52, 2,500 words registered in the dictionary, the level of the background sound is 25 [dB].

The horizontal axis of the graph shown in FIG. 13 indicates a time. The recognition rate is shown in FIG. 13 with the assumption that the leading end of the first sound is outputted by the speaker unit 52 at the time 1.5, the speaker starts to talk to the microphone unit 13 at the time “U”. As will be seen from FIG. 13, the recognition rate 62 under the condition that the echo component is sufficiently suppressed by the echo canceller 54 is exceeds the recognition rate 61 under the condition that the echo component is not suppressed in the conventional sound signal processing apparatus.

The operation of the sound signal processing apparatus 50 according to the second embodiment is the same as that of the sound signal processing apparatus 10 according to the first embodiment with the exception of the operation of the voice detecting means 56. Therefore, the operation of the voice detecting means 56 will be described hereinafter.

The first sound signal inputted by the sound signal inputting means 51 and the third sound signal outputted by the echo canceller 54 are inputted in the voice detecting means 56. The voice detecting means 56 is operated to detect the leading end of the voice component of the third sound signal in response to the inputted first and third sound signals. The infromation on whether or not the leading end of the voice of the speaker is detected by the voice detecting means 56 is inputted in the controlling means 57.

The following description will be then directed to the detection of the voice of the speaker.

The detection of the voice of the speaker is performed by the voice detecting means 56 in response to the first sound signal x(i) inputted by the sound signal inputting means 51 and the third sound signal e(i) outputted by the echo canceller 54. In this embodiment, the voice of the speaker is detected from the smoothed signal level. Here, the term “the smoothed signal level” is intended to indicate an average of the absolute value of the signal level of the sound signal.

The third sound signal e(i) outputted by the echo canceller 54 is sequentially smoothed by the voice detecting means 56. The signal level Pe(i) of the smoothed third sound signal e(i) is measured by the voice detecting means 56. The measured signal level Pe(i) of the smoothed third sound signal e(i) is stored as a smoothed signal level Pn(i) of the background noise component indicative of background sounds produced in the vicinity of the microphone unit 53 when the judgment is made that the sound of the speaker unit 52 and the voice of the speaker is not being received by the microphone unit 53. The difference “L(i)=Pe(i)−Pn(i)” between the measured signal level Pe(i) of the smoothed third sound signal e(i) and the smoothed signal level Pn(i) of the background noise component of the smoothed third sound signal e(i) is calculated by the voice detecting means 56 in frame. The judgment is made whether or not the calculated difference “L(i)=Pe(i)−Pn(i)” exceeds a predetermined threshold level. The voice detecting means 56 is operative to judge that the voice of the speaker is being received by the microphone unit 53 by judging that the calculated difference “L(i)=Pe(i)−Pn(i)” exceeds the predetermined threshold level.

From the above detail description, it will be understood that the sound signal processing apparatus 50 according to the second embodiment of the present invention can specify two different clock times on the basis of a predetermined time difference even if the echo component of the second sound signal is being insufficiently suppressed by the echo canceller 54, the clock times including a first clock time at which the leading end of the voice is detected by the voice detecting means 56, and a second clock time prior to the first clock time, start to retroactively output the third sound signal stored after the second clock time.

The sound signal processing apparatus 50 according to the third embodiment of the present invention may be operative in combination with a voice recognition apparatus for performing the voice recognition to the fourth sound signal outputted by the sound signal outputting means 58. In this particular case, the sound signal processing apparatus 50 according to the second embodiment of the present invention can have the voice recognition apparatus effectively perform the voice recognition by reason that the controlling means 57 is operative to have the sound signal storing means 55 output the fourth sound signal to the sound signal outputting means 58 only for a time period that the speaker is talking to the microphone unit 53.

### Third Embodiment

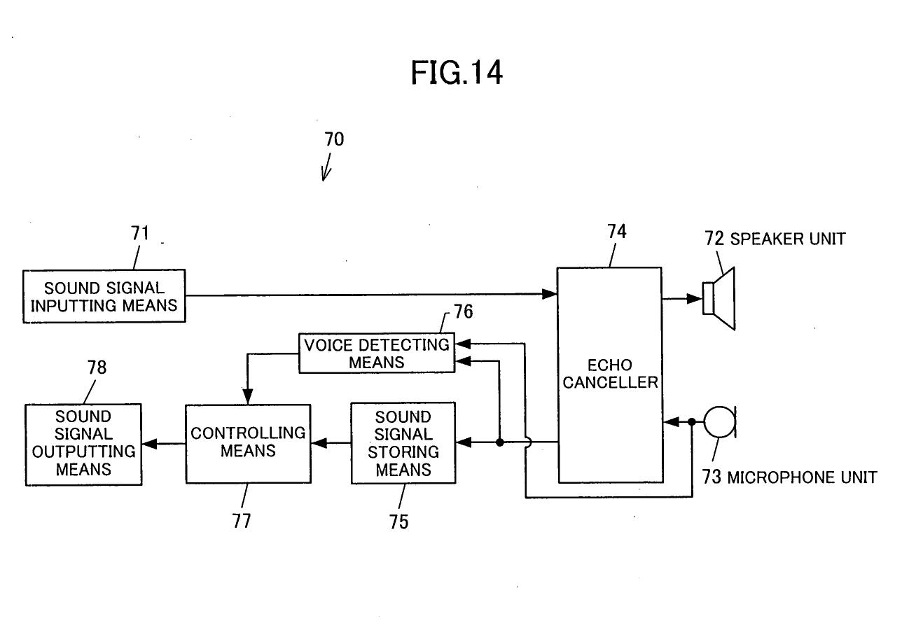

Although there has been described in the above about the first and second embodiments of the sound signal processing apparatus according to the present invention, the objects of the present invention may be attained by the third embodiment of the sound signal processing apparatus according to the present invention. The third embodiment of the sound signal processing apparatus will be described hereinafter with reference to FIG. 14.

The sound signal processing apparatus 70 according to the third embodiment of the present invention is shown in FIG. 14 as comprising sound signal inputting means 71, a speaker unit 72, a microphone unit 73, an echo canceller 74, sound signal storing means 75, sound signal outputting means 78, voice detecting means 76 for detecting the leading end of the voice on the basis of the second sound signal produced by the microphone unit 73 and the third sound signal produced by the echo canceller 74, and controlling means 77 for controlling the sound signal storing means 75 to have the sound signal storing means 75 output, as a fourth sound signal, the third sound signal stored in the time period when the voice is detected in the third sound signal outputted by the echo canceller 74.

The voice detecting means 76 is operative to produce a control signal to be outputted to the controlling means 77, the control signal having a low level before the leading end of the voice is detected by the voice detecting means 76, the control signal having a high level after the leading end of the voice is detected by the voice detecting means 76. The voice detecting means 76 is operative to allow the control signal to transit from the low level to the high level at the time “Ton” when the leading end of the voice component of third sound signal is detected by the voice detecting means 76. The controlling means 77 is operative to specify two different clock times on the basis of a predetermined time difference, the clock times including a first clock time at which the leading end of the voice is detected by the voice detecting means 76, and a second clock time prior to the first clock time. The controlling means 77 is operative to have the sound signal storing means 75 start to output the third sound signal stored after the second clock time.

The voice detecting means 76 can detect at a relatively high accuracy the leading end of the voice component of the third sound signal on the basis of the signal level of the first sound signal inputted by the sound signal inputting means 71, the frequency characteristic of the first sound signal, and the information on the voice of the speaker. The voice detecting means 76 is operative to update the predetermined threshold level on the basis of the signal level of the first sound signal inputted by the sound signal inputting means 71. When the judgment is made that the signal level of the first sound signal inputted by the sound signal inputting means 71 is relatively high in comparison with a predetermined threshold level, the voice detecting means 76 is operative to increase the threshold level to be compared with the second sound signal outputted by the microphone unit 73. The voice detecting means 76 is operative to judge whether or not the signal level of the third sound signal exceeds the updated threshold level.

The constitutional elements of the sound signal processing apparatus 70 according to the third embodiment of the present invention are respectively the same in operation as those of the sound signal processing apparatus 10 according to the first embodiment of the present invention with the exception of the voice detecting means 76. Therefore, the operation of the voice detecting means 76 will be described hereinafter.

The second sound signal produced by the microphone unit 73 and the third sound signal produced by the echo canceller 74 are inputted in the voice detecting means 76, while the leading end of the voice is detected by the voice detecting means 76 on the basis of the second and third sound signals. When the leading end of the voice is detected by the voice detecting means 76, the control signal indicative of the information that the leading end of the voice is detected by the voice detecting means 76 is outputted to the controlling means 77.

From the above detail description, it will be understood that the sound signal processing apparatus 70 according to the third embodiment of the present invention can judge whether or not the echo component of the second sound signal produced by the microphone unit 73 is sufficiently suppressed by the echo canceller 74 by reason that the voice detecting means 76 is operative to detect the leading end of the voice component of the second sound signal on the basis of the second sound signal produced by the microphone unit 73 and the third sound signal outputted by the echo canceller 74.

The sound signal processing apparatus 70 according to the third embodiment of the present invention can judge at a relatively high accuracy on whether or not the speaker is talking to the microphone unit 73 even if the echo component of the second sound signal is insufficiently suppressed by the echo canceller 74, and have the sound signal storing means 75 output, as the fourth sound signal, the stored third sound signal only for a time period that the speaker is talking to the microphone unit 73.

The controlling means 77 can have the sound signal storing means 75 output the fourth sound signal to the sound signal outputting means 78 only for a time period that the speaker is talking to the microphone unit 73 by reason that the voice detecting means 76 is operative to judge that the speaker is talking to the microphone unit 73 when the signal level of the second sound signal to be inputted in the echo canceller 74 is relatively high, and the signal level of the third sound signal outputted by the echo canceller 74 is relatively high.

The sound signal processing apparatus 70 according to the third embodiment of the present invention may be operative in combination with a voice recognition apparatus for performing the voice recognition to the fourth sound signal outputted by the sound signal outputting means 78. In this particular case, the sound signal processing apparatus 70 according to the third embodiment of the present invention can have the voice recognition apparatus effectively perform the voice recognition by reason that the controlling means 77 is operative to have the sound signal storing means 75 output the fourth sound signal to the sound signal outputting means 78 only for a time period that the speaker is talking to the microphone unit 73.

### Fourth Embodiment

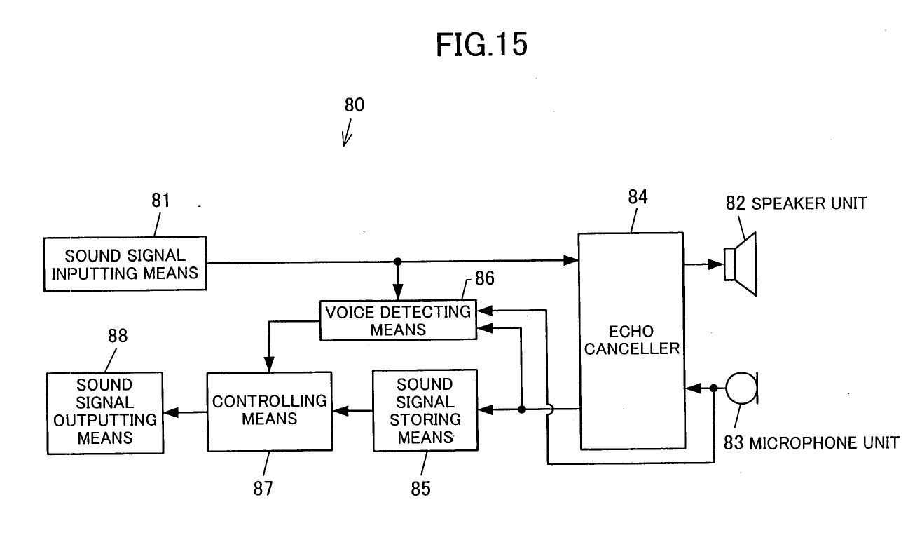

Although there has been described in the above about the first to third embodiments of the sound signal processing apparatus according to the present invention, the objects of the present invention may be attained by the fourth embodiment of the sound signal processing apparatus according to the present invention. The fourth embodiment of the sound signal processing apparatus will then be described hereinafter with reference to FIG. 15.

The sound signal processing apparatus 80 according to the fourth embodiment of the present invention is shown in FIG. 15 as comprising sound signal inputting means 81, a speaker unit 82, a microphone unit 83, an echo canceller 84, sound signal storing means 85, sound signal outputting means 88, voice detecting means 86 for detecting the leading end of the voice on the basis of the first sound signal inputted by the sound signal inputting means 81 and the second sound signal produced by the echo canceller 84, and controlling means 87 for controlling the sound signal storing means 85 to have the sound signal storing means 85 output, as a fourth sound signal, the third sound signal stored in the time period when the voice is detected in the third sound signal outputted by the echo canceller 84.

The controlling means 87 is operative to have the sound signal storing means 85 sequentially and temporary store the third sound signal outputted by the echo canceller 84. The voice detecting means 86 is operative to produce a control signal to be outputted to the controlling means 87, the control signal having a low level before the leading end of the voice is detected by the voice detecting means 86, the control signal having a high level after the leading end of the voice is detected by the voice detecting means 86. The voice detecting means 86 is operative to allow the control signal to transit from the low level to the high level at the time “Ton” when the leading end of the voice component of third sound signal is detected by the voice detecting means 86, while the controlling means 87 is operative to have the sound signal storing means 85 start to retroactively output, as the fourth sound signal, the stored third sound signal when the leading end of the voice is detected by the voice detecting means 86.

The voice detecting means 86 can detect at a relatively high accuracy the leading end of the voice component of the third sound signal on the basis of the signal level of the first sound signal inputted by the sound signal inputting means 81, the frequency characteristic of the first sound signal, and the information on the voice of the speaker. The voice detecting means 86 is operative to update the predetermined threshold level on the basis of the signal level of the first sound signal inputted by the sound signal inputting means 81. When the judgment is made that the signal level of the first sound signal inputted by the sound signal inputting means 81 is relatively high in comparison with a predetermined threshold level, the voice detecting means 86 is operative to increase the threshold level to be compared with the second sound signal outputted by the microphone unit 83. The voice detecting means 86 is operative to judge whether or not the signal level of the third sound signal exceeds the updated threshold level.

The constitutional elements of the sound signal processing apparatus 80 according to the fourth embodiment of the present invention are respectively the same in operation as those of the sound signal processing apparatus 10 according to the first embodiment of the present invention with the exception of the voice detecting means 86. Therefore, the operation of the voice detecting means 86 will be described hereinafter.

The first sound signal inputted by the sound signal inputting means 81, the second sound signal produced by the microphone unit 83 and the third sound signal produced by the echo canceller 84 are inputted in the voice detecting means 86, while the leading end of the voice is detected by the voice detecting means 86 on the basis of the second and third sound signals. When the leading end of the voice is detected by the voice detecting means 86, the controlling means 87 is operated to have the sound signal storing means 85 start to retroactively output, as the fourth sound signal, the stored sound signal in order of first-in first-out with a predetermined delay.

The sound signal processing apparatus 80 according to the fourth embodiment of the present invention can judge at a relatively high accuracy on whether or not the speaker is talking to the microphone unit 83 even if the echo component of the second sound signal is insufficiently suppressed by the echo canceller 84, and have the sound signal storing means 85 output, as the fourth sound signal, the stored third sound signal only for a time period that the speaker is talking to the microphone unit 83.

The sound signal processing apparatus 80 according to the fourth embodiment of the present invention may be operative in combination with a voice recognition apparatus for performing the voice recognition to the fourth sound signal outputted by the sound signal outputting means 88. In this particular case, the sound signal processing apparatus 80 according to the fourth embodiment of the present invention can have the voice recognition apparatus effectively perform the voice recognition by reason that the controlling means 87 is operative to have the sound signal storing means 85 output the fourth sound signal to the sound signal outputting means 88 only for a time period that the speaker is talking to the microphone unit 83.

### Fifth Embodiment

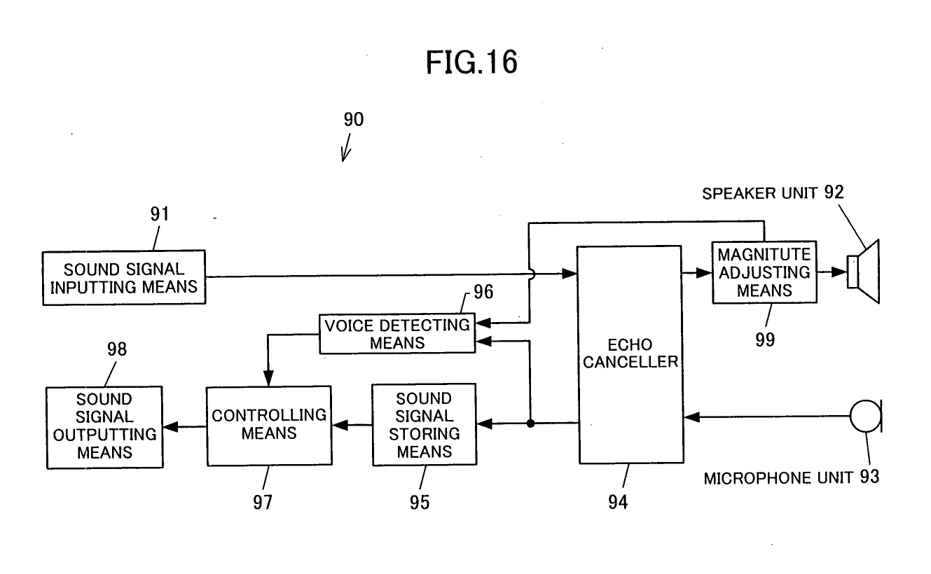

Although there has been described in the above about the first to fourth embodiments of the sound signal processing apparatus according to the present invention, the objects of the present invention may be attained by the fifth embodiment of the sound signal processing apparatus according to the present invention. The fifth embodiment of the sound signal processing apparatus according to the present invention will be described hereinafter with reference to FIG. 16.

The sound signal processing apparatus 90 according to the fifth embodiment of the present invention is shown in FIG. 16 as comprising sound signal inputting means 91, a speaker unit 92, a microphone unit 93, an echo canceller 94, sound signal storing means 95, sound signal outputting means 98, magnitude adjusting means 99 for adjusting the magnitude of the sound to be outputted by the speaker unit 92 by adjusting the signal level of the first sound signal to be inputted to the speaker unit 92, voice detecting means 96 for detecting the leading end of the voice on the basis of the first sound signal inputted by the sound signal inputting means 91 and the third sound signal produced by the echo canceller 94, and controlling means 97 for controlling the sound signal storing means 95 to have the sound signal storing means 95 output, as a fourth sound signal, the third sound signal stored in the time period when the voice is detected in the third sound signal outputted by the echo canceller 94.

The controlling means 97 is operative to have the sound signal storing means 95 sequentially and temporary store the third sound signal outputted by the echo canceller 94. The voice detecting means 96 is operative to produce a control signal to be outputted to the controlling means 97, the control signal having a low level before the leading end of the voice is detected by the voice detecting means 96, the control signal having a high level after the leading end of the voice is detected by the voice detecting means 96. The voice detecting means 96 is operative to allow the control signal to transit from the low level to the high level at the time “Ton” when the leading end of the voice component of third sound signal is detected by the voice detecting means 96, while the controlling means 97 is operative to have the sound signal storing means 95 start to retroactively output, as the fourth sound signal, the stored third sound signal in response to the control signal produced by the voice detecting means 96 when the leading end of the voice is detected by the voice detecting means 96.

The voice detecting means 96 can detect at a relatively high accuracy the leading end of the voice component of the third sound signal on the basis of the signal level of the first sound signal inputted by the sound signal inputting means 91, the frequency characteristic of the first sound signal, and the information on the voice of the speaker. The voice detecting means 96 is operative to update the predetermined threshold level on the basis of the signal level of the first sound signal inputted by the sound signal inputting means 91. When the judgment is made that the signal level of the first sound signal inputted by the sound signal inputting means 91 is relatively high in comparison with a predetermined threshold level, the voice detecting means 96 is operative to increase the threshold level to be compared with the second sound signal outputted by the microphone unit 93. The voice detecting means 96 is operative to judge whether or not the signal level of the third sound signal exceeds the updated threshold level.

The constitutional elements of the sound signal processing apparatus 90 according to the fifth embodiment of the present invention are respectively the same in operation as those of the sound signal processing apparatus 10 according to the first embodiment of the present invention with the exception of the voice detecting means 96 and the magnitude adjusting means 99. Therefore, the operation of each of the voice detecting means 96 and the magnitude adjusting means 99 will be described hereinafter.

The signal level of the first sound signal inputted by the sound signal inputting means 91 is adjusted by the magnitude adjusting means 99 in order to adjust the magnitude of the sound to be outputted by the speaker unit 92. As a result of the fact that the magnitude of the sound to be outputted by the speaker unit 92 is increased or decreased by the magnitude adjusting means 99, the level of the echo component of the second sound signal produced by the microphone unit 93.

On the other hand, the detection of the voice is performed by the voice detecting means 96 on the basis of the third sound signal outputted by the echo canceller 94 and the information on the adjustment received from the magnitude adjusting means 99.

From the above detail description, it will be understood that the sound signal processing apparatus 90 according to the fifth embodiment of the present invention can judge at a relatively high accuracy on whether or not the speaker is talking to the microphone unit 93 even if the echo component of the second sound signal is insufficiently suppressed by the echo canceller 94, and have the sound signal storing means 95 output, as the fourth sound signal, the stored third sound signal only for a time period that the speaker is talking to the microphone unit 93.

The sound signal processing apparatus 90 according to the fifth embodiment of the present invention may be operative in combination with a voice recognition apparatus for performing the voice recognition to the fourth sound signal outputted by the sound signal outputting means 98. In this particular case, the sound signal processing apparatus 90 according to the fifth embodiment of the present invention can have the voice recognition apparatus effectively perform the voice recognition by reason that the controlling means 97 is operative to have the sound signal storing means 95 output the fourth sound signal to the sound signal outputting means 98 only for a time period that the speaker is talking to the microphone unit 93.

### Sixth Embodiment

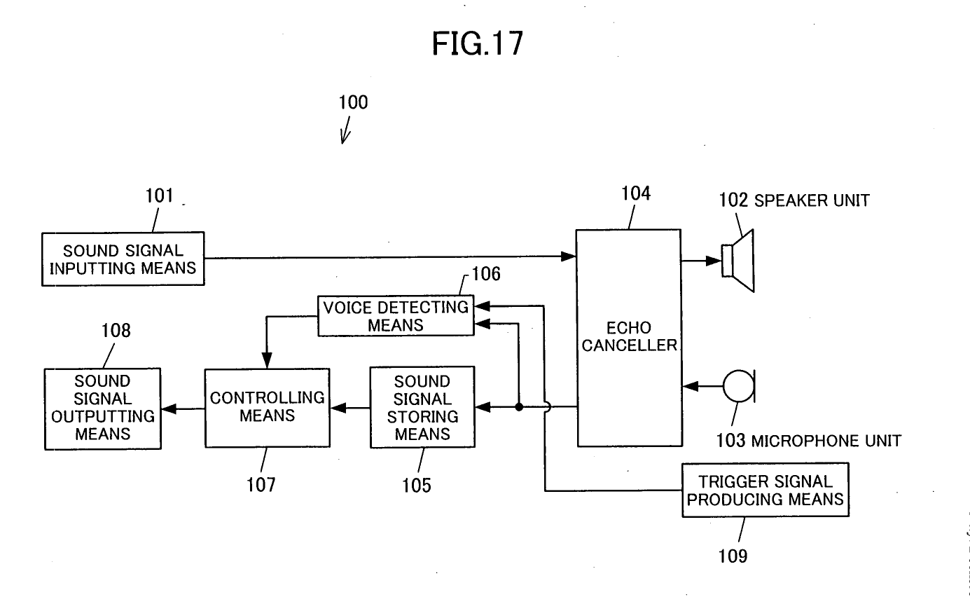

Although there has been described in the above about the first to fifth embodiments of the sound signal processing apparatus according to the present invention, the objects of the present invention may be attained by the sixth embodiment of the sound signal processing apparatus according to the present invention. The sixth embodiment of the sound signal processing apparatus according to the present invention will be described hereinafter with reference to FIG. 17.

The sound signal processing apparatus 100 according to the sixth embodiment of the present invention is shown in FIG. 17 as comprising sound signal inputting means 101, a speaker unit 102, a microphone unit 103, an echo canceller 104, sound signal storing means 105, sound signal outputting means 108, a supplementary switching unit 109 for producing a trigger signal in synchronization with the voice of the speaker, voice detecting means 106 for judging whether or not the signal level of the voice component of the third sound signal exceeds the predetermined threshold level on the basis of the trigger signal produced by the supplementary switching unit 109 and the third sound signal produced by the echo canceller 104, and controlling means 107 for controlling the sound signal storing means 105 to have the sound signal storing means 105 output, as a fourth sound signal, the third sound signal stored in the time period when the voice is detected in the third sound signal outputted by the echo canceller 104.

The voice detecting means 106 can detect at a relatively high accuracy the leading end of the voice component of the third sound signal by judging whether or not the increment in the signal level of the third sound signal results from the fact that the speaker starts to talk to the microphone unit 103 on the basis of the trigger signal produced by the supplementary switching unit 109.

The supplementary switching unit 109 constitutes trigger signal producing means. Additionally, the supplementary switching unit 109 may be constituted by a button switch, a touch sensor, or a system for detecting the motion of the lips of the speaker.

The operation of the sound signal processing apparatus 100 according to the sixth embodiment is the same as that of the sound signal processing apparatus 10 according to the first embodiment with the exception of the operation of the supplementary switching unit 109. Therefore, the operation of the supplementary switching unit 109 will be described hereinafter.

When the speaker starts to talk to the microphone unit 103, the supplementary switching unit 109 assumes “ON” state to produce the trigger signal indicative of the leading end of the voice, and to output the trigger signal to the voice detecting means 106. On the other hand, the voice detecting means 76 is operated to judge whether or not the speaker starts to talk to the microphone unit 103 on the basis of the trigger signal received from the supplementary switching unit 109.

From the above detail description, it will be understood that the sound signal processing apparatus 100 according to the sixth embodiment of the present invention can judge at a relatively high accuracy on whether or not the speaker starts to talk to the microphone unit 103 on the basis of the trigger signal received from the supplementary switching unit 109 and the third sound signal outputted by the echo canceller 104 even if the echo component of the second sound signal is insufficiently suppressed by the echo canceller 104.

The sound signal processing apparatus 100 according to the sixth embodiment of the present invention can cancel the remaining echo component by reason that by reason that the controlling means 107 is operative to have the sound signal storing means 105 output the fourth sound signal to the sound signal outputting means 108 only for a time period that the speaker is talking to the microphone unit 103.

The sound signal processing apparatus 100 according to the sixth embodiment of the present invention may be operative in combination with a voice recognition apparatus for performing the voice recognition to the fourth sound signal outputted by the sound signal outputting means 108. In this particular case, the sound signal processing apparatus 100 according to the sixth embodiment of the present invention can have the voice recognition apparatus effectively perform the voice recognition by reason that the controlling means 107 is operative to have the sound signal storing means 105 output the fourth sound signal to the sound signal outputting means 108 only for a time period that the speaker is talking to the microphone unit 103.

### Seventh Embodiment

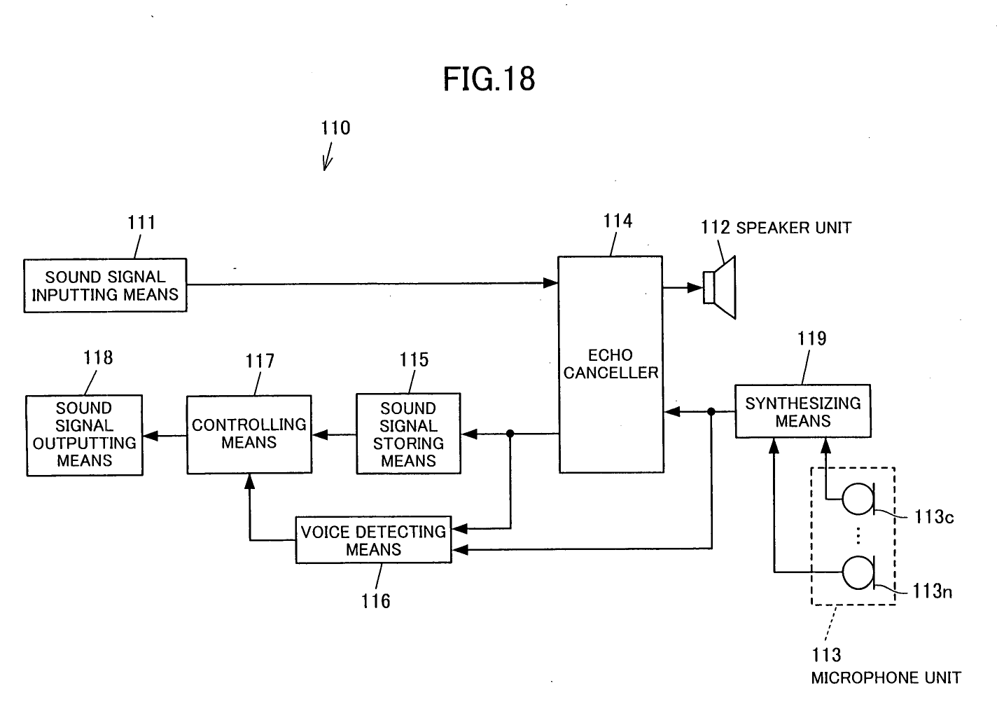

Although there has been described in the above about the first to sixth embodiments of the sound signal processing apparatus according to the present invention, the objects of the present invention may be attained by the seventh embodiment of the sound signal processing apparatus according to the present invention. The seventh embodiment of the sound signal processing apparatus according to the present invention will then be described hereinafter with reference to FIG. 18.

The sound signal processing apparatus 110 according to the seventh embodiment of the present invention is shown in FIG. 18 as comprising sound signal inputting means 111, a speaker unit 112, a plurality of microphone units 113c to 113n for producing respective signals each indicative of the voice of the speaker, and synthesizing means 119 for allowing the second sound signal to be constituted by the signals respectively produced by the respective microphone units 113c to 113n, the synthesizing means 119 being operative to emphasize the voice component of the second sound signal by synthesizing the sounds produced by the respective microphone units 113c to 113n, an echo canceller 114 for suppressing the echo component of the second sound signal produced by the synthesizing means 119, sound signal storing means 115, sound signal outputting means 118, voice detecting means 116 for detecting the leading end of the voice by judging whether or not the voice component of the third sound signal exceeds a predetermined threshold level on the basis of the second sound signal produced by the synthesizing means 119 and the third sound signal produced by the echo canceller 114, and controlling means 117 for having the sound signal storing means 115 start to retroactively output the stored third sound signal in order of first-in first-out with a predetermined delay on the basis of the judgment of the voice detecting means 116. Here, the microphone units 113c to 113n collectively constitute a microphone array 113. The microphone array 113 and the synthesizing means 119 are collectively constitute sound signal producing means.

In this embodiment of the sound signal processing apparatus 110 according to the present invention, the voice detecting means 116 can judge at a relatively high accuracy on whether the third sound signal is being varied in response to the voice of the speaker or in response to the first sound converted by the speaker unit 112 on the basis of the second sound signal produced by the synthesizing means 119 and the third sound signal produced by the echo canceller 114.

The synthesizing means 119 can emphasize the voice component of the second sound signal, and reduce the echo component of the third sound signal by synthesizing the sounds produced by the respective microphone units 113c to 113n which are disposed at predetermined regular intervals.

The operation of the sound signal processing apparatus 110 according to the seventh embodiment is the same as that of the sound signal processing apparatus 10 according to the first embodiment with the exception of the operations of the microphone array 113 and the synthesizing means 119. Therefore, the operations of the microphone array 113 and the synthesizing means 119 will be described hereinafter.

The voice of the speaker is received by the microphone array 113. On the other hand, the synthesizing means 119 is operated to emphasize the voice component of the second sound signal by synthesizing the sounds produced by the microphone units 113c to 113n. The detection of the leading end of the voice is performed by the voice detecting means 116 on the basis of the second sound signal emphasized by the synthesizing means 119.

From the above detail description, it will be understood that the sound signal processing apparatus 110 according to the seventh embodiment of the present invention can judge at a relatively high accuracy on whether or not the speaker starts to talk to the microphone array 113 on the basis of the second sound signal produced by the synthesizing means 119 and the third sound signal outputted by the echo canceller 114 even if the echo component of the second sound signal is insufficiently suppressed by the echo canceller 114.

The sound signal processing apparatus 110 according to the seventh embodiment of the present invention. can cancel the remaining echo component by reason that by reason that the controlling means 117 is operative to have the sound signal storing means 115 output the fourth sound signal to the sound signal outputting means 118 only for a time period that the speaker is talking to the microphone array 113.

The sound signal processing apparatus 110 according to the seventh embodiment of the present invention may be operative in combination with a voice recognition apparatus for performing the voice recognition to the fourth sound signal outputted by the sound signal outputting means 118. In this particular case, the sound signal processing apparatus 110 according to seventh embodiment of the present invention can have the voice recognition apparatus effectively perform the voice recognition by reason that the controlling means 117 is operative to have the sound signal storing means 115 output the fourth sound signal to the sound signal outputting means 118 only for a time period that the speaker is talking to the microphone array 113.

### Eighth Embodiment

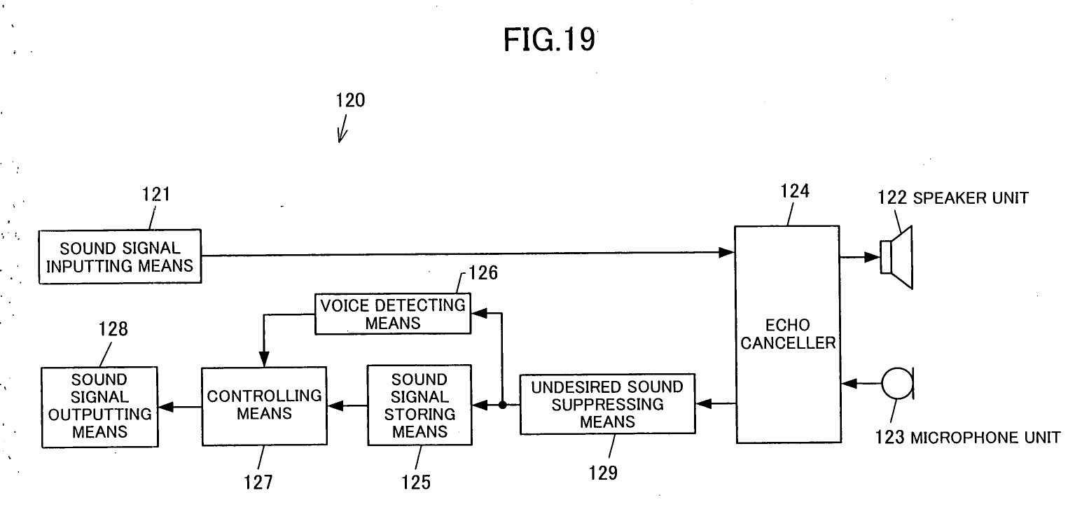

Although there has been described in the above about the first to seventh embodiments of the sound signal processing apparatus according to the present invention, the objects of the present invention may be attained by the eighth embodiment of the sound signal processing apparatus according to the present invention. The eighth embodiment of the sound signal processing apparatus according to the present invention will be described hereinafter with reference to FIG. 19 The sound signal processing apparatus 120 according to the eighth embodiment of the present invention is shown in FIG. 19 as comprising sound signal inputting means 121, a speaker unit 122, a microphone unit 123, an echo canceller 124, noise suppressing means 129 for suppressing the noise component of the third sound signal outputted by the echo canceller 124, sound signal storing means 125 for storing the third sound signal suppressed by the noise suppressing means 129, sound signal outputting means 128, voice detecting means 126 for detecting the leading end of the voice on the basis of the third sound signal suppressed by the noise suppressing means 129, and controlling means 127 for controlling the sound signal storing means 125 to have the sound signal storing means 125 output, as a fourth sound signal, the third sound signal stored in the time period when the voice is detected in the third sound signal outputted by the echo canceller 124.

In this embodiment of the sound signal processing apparatus 120 according to the present invention, the voice detecting means 126 can judge at a relatively high accuracy on whether the third sound signal is being varied in response to the voice of the speaker or in response to the first sound converted by the speaker unit 122 on the basis of the third sound signal suppressed by the noise suppressing means 129.

The operation of the noise suppressing means 129 of the sound signal processing apparatus 120 according to the eighth embodiment of the present invention will be described hereinafter.

The operation of the sound signal processing apparatus 120 according to the eighth embodiment is the same as that of the sound signal processing apparatus 10 according to the first embodiment with the exception of the operation of the noise suppressing means 129. Therefore, the operation of the noise suppressing means 129 will be described hereinafter.

The noise component of the third sound signal outputted by the echo canceller 124 is firstly suppressed by the noise suppressing means 129. The third sound signal suppressed by the noise suppressing means 129 is then stored in the sound signal storing means 125. When the leading end of the voice is detected by the voice detecting means 126 on the basis of the third sound signal suppressed by the noise suppressing means 129, the controlling means 127 is operated to have the sound signal storing means 125 start to retroactively output the stored third sound signal in order of first-in first-out with a predetermined delay.

From the above detail description, it will be understood that the sound signal processing apparatus 120 according to the eighth embodiment of the present invention can detect at a relatively high accuracy the leading end of the voice component of the third sound signal on the basis of the third sound signal suppressed by the noise suppressing means 129 even if the echo component of the second sound signal produced by the microphone unit 123 is insufficiently suppressed by the echo canceller 124.

The sound signal processing apparatus 120 according to the eighth embodiment of the present invention can cancel the remaining echo component by reason that by reason that the voice detecting means 126 is operative to detect the leading end of the voice in the third sound signal suppressed by the noise suppressing means 129, and the controlling means 127 is operative to have the sound signal storing means 125 output the fourth sound signal to the sound signal outputting means 128 only for a time period that the speaker is talking to the microphone unit 123.

The sound signal processing apparatus 120 according to the eighth embodiment of the present invention may be operative in combination with a voice recognition apparatus for performing the voice recognition to the fourth sound signal outputted by the sound signal outputting means 128. In this particular case, the sound signal processing apparatus 120 according to eighth embodiment of the present invention can have the voice recognition apparatus effectively perform the voice recognition by reason that the controlling means 127 is operative to have the sound signal storing means 125 output the fourth sound signal to the sound signal outputting means 128 only for a time period that the speaker is talking to the microphone unit 123.

### Ninth Embodiment

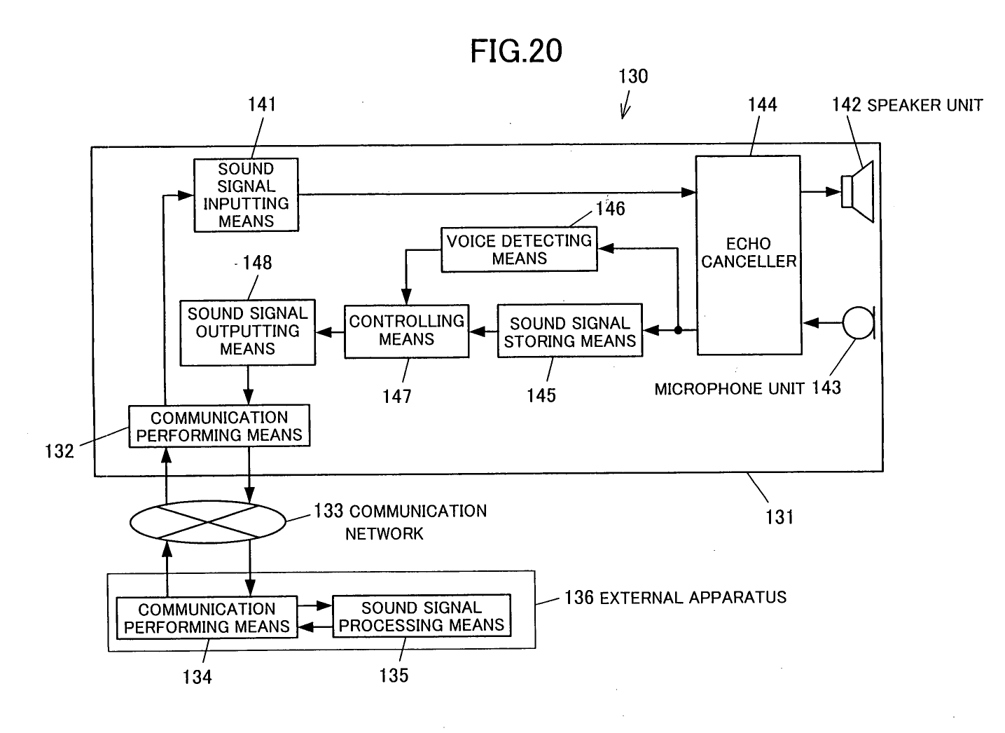

Although there has been described in the above about the first to eighth embodiments of the sound signal processing apparatus according to the present invention, the objects of the present invention may be attained by the ninth embodiment of the sound signal processing apparatus according to the present invention. The ninth embodiment of the sound signal processing apparatus according to the present invention will be described hereinafter with reference to FIG. 20.

The sound signal processing apparatus 130 according to the ninth embodiment of the present invention is shown in FIG. 20 as comprising communication performing means 132 for performing the communication with an external apparatus 136 to receive a first sound signal indicative of a voice of a far-end speaker from the external apparatus 136 through a communication network 133, sound signal inputting means 141 for inputting the first sound signal received by the communication performing means 132, a speaker unit 142 for converting the first sound signal inputted by the sound signal inputting means 141 to a first sound, a microphone unit 143 for receiving a voice of a near-end speaker, an echo canceller 144, sound signal storing means 145, voice detecting means 146 for detecting the leading end of the voice on the basis of the first sound signal inputted by the sound signal inputting means 141 and the third sound signal produced by the echo canceller 144, controlling means 147 for controlling the sound signal storing means 145 to have the sound signal storing means 145 output, as a fourth sound signal, the third sound signal stored in the time period when the voice is detected in the third sound signal outputted by the echo canceller 144, and sound signal outputting means 148 for outputting the fourth sound signal to the external apparatus 136 through the communication network 133.

The communication performing means 132 is operative to transmit the fourth sound signal outputted by the sound signal outputting means 148 to the external apparatus 136 through the communication network 133.

The external apparatus 136 includes communication performing means 134 for performing the communication with the sound signal processing apparatus 130 to transmit the first sound signal to the sound signal processing apparatus 130 through the communication network 133, and to receive the fourth sound signal from the sound signal processing apparatus 130 through the communication network 133, and voice signal processing means 135 for processing the fourth sound signal received by the communication performing means 134.

Here, the above mentioned communication network 133 may include a cable communication network such as for example the public telecommunication network and the Ethernet (registered trademark), or a wireless communication network such as for example an infrared communication network.

The operation of the sound signal processing apparatus 130 according to the ninth embodiment of the present invention will be described hereinafter.

The first sound signal produced by the voice signal processing means 135 of the external apparatus 136 is received by the communication performing means 132 from the communication performing means 134 of the external apparatus 136 through the communication network 133. On the other hand, the fourth sound signal outputted by the sound signal outputting means 148 is transmitted to the external apparatus 136 by the communication performing means 132 through the communication network 133.

From the above detail description, it will be understood that the sound signal suppressing apparatus 130 according to the ninth embodiment of the present invention can detect at a relatively high accuracy the leading end of the voice component of the third sound signal on the basis of the third sound signal suppressed by the echo canceller 144 even if the echo component of the second sound signal is insufficiently suppressed by the echo canceller 144.

The sound signal processing apparatus 130 according to the ninth embodiment of the present invention can sufficiently suppress the echo component of the third sound signal by reason that the controlling means 147 is operative to have the sound signal storing means 145 start to retroactively output the stored third sound signal in order of first-in first-out with a predetermined delay when the leading end of the voice is detected by the voice detecting means 146.

The sound signal processing apparatus 130 according to the ninth embodiment of the present invention can transmit the fourth sound signal to the external apparatus 136 by reason that the communication performing means 132 is operative to perform the communication with the external apparatus 136 through the communication network 133.

The sound signal processing apparatus 130 according to the ninth embodiment of the present invention may be operative in combination with a voice recognition apparatus for performing the voice recognition to the fourth sound signal outputted by the sound signal outputting means 148. In this particular case, the sound signal processing apparatus 130 according to ninth embodiment of the present invention can have the voice recognition apparatus effectively perform the voice recognition by reason that the controlling means 147 is operative to have the sound signal storing means 145 output the fourth sound signal to the sound signal outputting means 148 only for a time period that the speaker is talking to the microphone unit 143.

### Tenth Embodiment

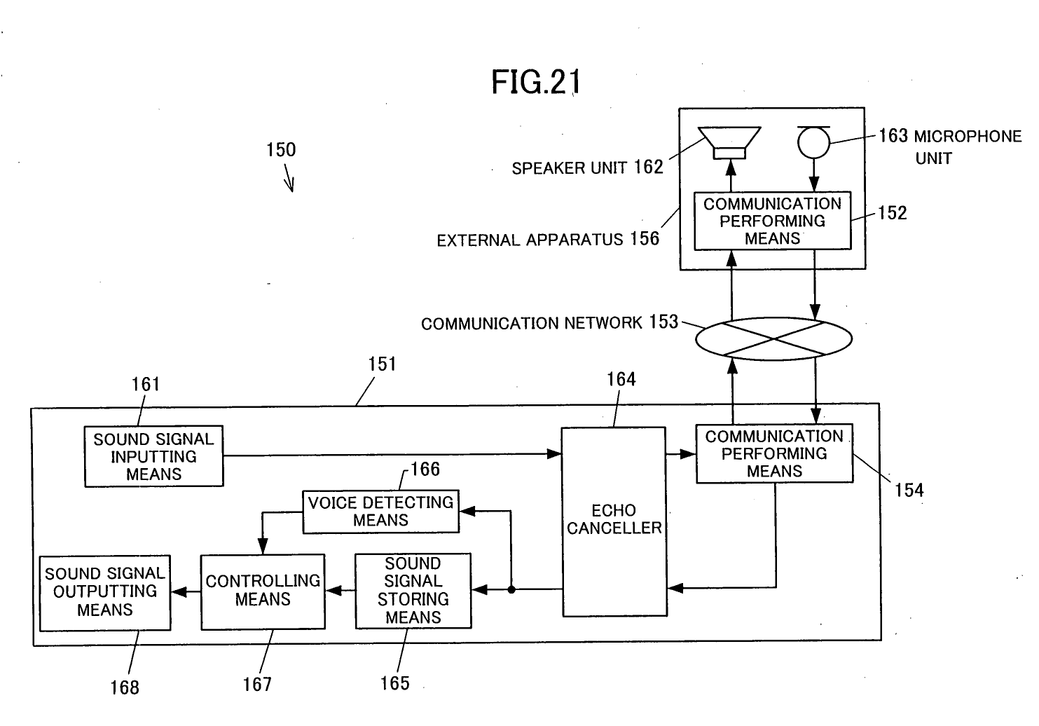

Although there has been described in the above about the first to ninth embodiments of the sound signal processing apparatus according to the present invention, the objects of the present invention may be attained by the tenth embodiment of the sound signal processing apparatus according to the present invention. The tenth embodiment of the sound signal processing apparatus according to the present invention will be described hereinafter with reference to FIG. 21.

The sound signal processing apparatus 151 according to the tenth embodiment of the present invention is shown in FIG. 21 as comprising sound signal inputting means 161 for inputting a first sound signal, and communication performing means 154 for performing the communication with an external apparatus 156 to transmit the first sound signal inputted by the sound signal inputting means 161 to the external apparatus 156 through a communication network 153.

The external apparatus 156 includes communication performing means 152 for performing the communication with the communication performing means 154 of the sound signal processing apparatus 151 to receive the first sound signal from the sound signal processing apparatus 151 through the communication network 153, a speaker unit 162 for converting the first sound signal received by the communication performing means 152 to a first sound, and a microphone unit 163 for receiving one's voice to produce a second sound signal to be outputted to the communication performing means 152. The second sound signal is constituted by at least two different components including an echo component indicative of the sound outputted by the speaker unit 162, and a voice component indicative of the voice of the speaker.

The communication performing means 152 of the external apparatus 156 is operative to transmit the second sound signal produced by the microphone unit 163 to the sound signal processing apparatus 151 through the communication network 153, while the communication performing means 154 of the sound signal processing apparatus 151 is operative to receive the second sound signal from the external apparatus 156.

The sound signal processing apparatus 151 according to the tenth embodiment of the present invention further comprises an echo canceller 164 for suppressing the echo component of the second sound signal received by the communication performing means 154, sound signal storing means 165, voice detecting means 166, controlling means 167, and sound signal outputting means 168.

Here, the above mentioned communication network 153 may include a cable communication network such as for example the public telecommunication network and the Ethernet (registered trademark), or a wireless communication network such as for example an infrared communication network.

The operation of the sound signal processing apparatus 151 according to the tenth embodiment of the present invention will be described hereinafter.

The speaker unit 162 of the external apparatus 156 is operated to receive the second sound signal from the sound signal inputting means 161 of the sound signal processing apparatus 151 through the communication network 153, and to convert the received second sound signal to a first sound. On the other hand, the second sound signal produced by the microphone unit 163 of the external apparatus 156 is transmitted to the echo canceller 164 of the sound signal processing apparatus 151 by the communication performing means 152 through the communication network 153.

From the above detail description, it will be understood that the sound signal processing apparatus 151 according to the tenth embodiment of the present invention can detect at a relatively high accuracy the leading end of the voice component of the third sound signal on the basis of the third sound signal outputted by the echo canceller 164 even if the echo component of the second sound signal is insufficiently suppressed by echo canceller 164.

The sound signal processing apparatus 151 according to the tenth embodiment of the present invention can reduce the echo component of the second sound signal produced by the microphone unit 163 of the external apparatus 156 by reason that the communication performing means 154 of the sound signal processing apparatus 151 is operative to transmit the first sound signal to be converted to the sound by the speaker unit 162, and to receive the second sound signal produced by the microphone unit 163 of the external apparatus 156, the echo canceller 164 is operative to suppress the echo component of the second sound signal received from the external apparatus 156.

The sound signal processing apparatus 151 according to the tenth embodiment of the present invention may be operative in combination with a voice recognition apparatus for performing the voice recognition to the fourth sound signal outputted by the sound signal outputting means 168. In this particular case, the sound signal processing apparatus 151 according to the tenth embodiment of the present invention can have the voice recognition apparatus effectively perform the voice recognition by reason that the controlling means 167 is operative to have the sound signal storing means 165 output the fourth sound signal to the sound signal outputting means 168 only for a time period that the speaker is talking to the microphone unit 163 of the external apparatus 156.

The speaker unit 162, the microphone unit 163, and the communication performing unit 152 collectively constitute a downsized audio device expected to be used in an expanded range, and adapted to allow the echo component of the second sound signal produced by the microphone unit 163 to be suppressed by the sound signal processing apparatus 151 according to the tenth embodiment of the present invention.

### Eleventh Embodiment

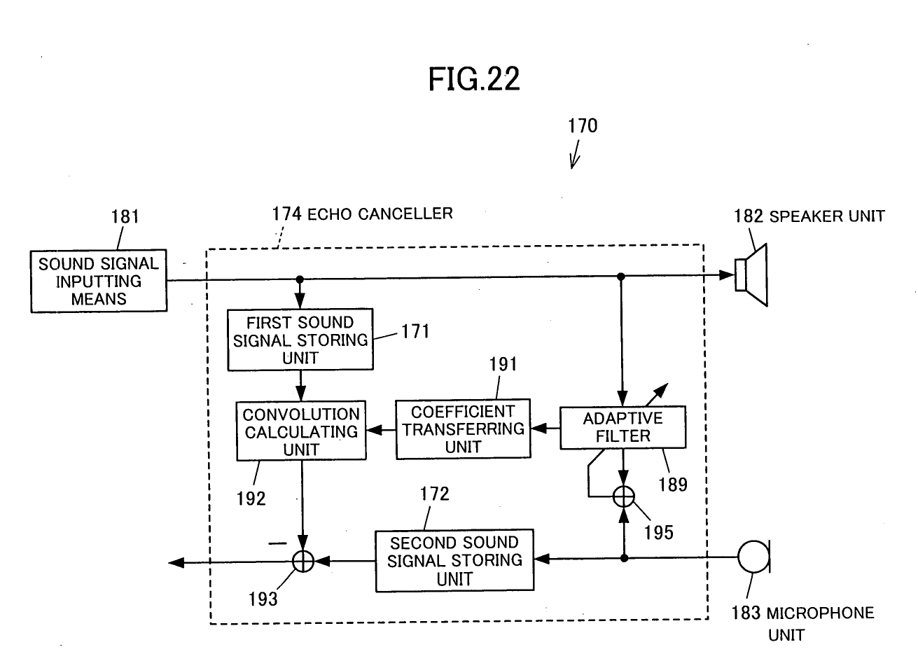

Although there has been described in the above about the first to tenth embodiments of the sound signal processing apparatus according to the present invention, the objects of the present invention may be attained by the eleventh embodiment of the sound signal processing apparatus according to the present invention. The eleventh embodiment of the sound signal processing apparatus according to the present invention will be described hereinafter with reference to FIG. 22.

The sound signal processing apparatus 170 according to the eleventh embodiment of the present invention is shown in FIG. 22 as comprising sound signal inputting means 181, a speaker unit 182, a microphone unit 183, an adaptive filter 189 for producing a first replica echo signal, and a second subtracting unit 195 for subtracting the first replica echo signal produced by the adaptive filter 189 from the second sound signal produced by the microphone unit 183 to produce a signal indicative of the difference between the first replica echo signal produced by the adaptive filter 189 and the second sound signal produced by the microphone unit 183.

The adaptive filter 189 is operative to update the filter coefficient on the basis of the signal produced by the second subtracting unit 195 and the first sound signal inputted by the sound signal inputting means 181, and to produce the first replica echo signal on the basis of the updated filter coefficient.

The sound signal processing apparatus 170 according to the eleventh embodiment of the present invention further comprises a first sound signal storing unit 171 having the first sound signal stored therein, the first sound signal storing unit 171 being operative to output the stored first sound signal in order of first-in first-out with a predetermined delay, a second sound signal storing unit 172 having stored therein the second sound signal produced by the microphone unit 183, the second sound signal storing unit 172 being operative to output the stored second sound signal in order of first-in first-out with a predetermined delay, a convolution calculating unit 192 for estimating a second replica echo signal indicative of the echo component of the second sound signal by calculating the convolution of the first sound signal outputted by the first sound signal storing unit 171 with respect to the filter coefficient updated by the adaptive filter 189, a filter coefficient transferring unit 191 for transferring the filter coefficient estimated by the adaptive filter 189 to the convolution calculating unit 192, and a first subtracting unit 193 for subtracting the second replica echo signal produced by the convolution calculating unit 192 from the second sound signal outputted by the second sound signal storing unit 172 to output a signal indicative of the difference between the second sound signal and the second replica echo signal.

The operation of the sound signal processing apparatus 170 according to the eleventh embodiment of the present invention will be described hereinafter.

The first and second sound signals are sequentially and temporally stored in the first and second sound signal storing units 171 and 172, respectively. When judgment is made that the filter coefficient produced by the adaptive filter 189 is relatively stable, the first sound signal storing unit 171 starts to output the stored first sound signal to the convolution calculating unit 192 with a predetermined delay in order of first-in first-out. On the other hand, the second sound signal storing unit 172 starts to output the stored second sound signal to the first subtracting unit 193 with a predetermined delay in order of first-in first-out in synchronization with the operation of the first sound signal storing unit 171. In general, the level of the remaining echo component of the third sound signal outputted by the echo canceller 174 is relatively large under the condition that the filter coefficient produced by the adaptive filter 189 is varied with time. Accordingly, the echo canceller 174 is operative to start to suppress the echo component of the second sound signal stored in the second sound signal storing unit 172 after the judgment is made that the filter coefficient produced by the adaptive filter 189 is relatively stable.

From the above detail description, it will be understood that the sound signal processing apparatus 170 according to the eleventh embodiment of the present invention can detect at a relatively high accuracy the leading end of the voice component of the third sound signal on the basis of the third sound signal outputted by the echo canceller 174 even if the echo component of the second sound signal is insufficiently suppressed by echo canceller 174.

The sound signal processing apparatus 170 according to the eleventh embodiment of the present invention can sufficiently reduce the remaining echo component of the third sound signal outputted by the echo canceller 174 by reason that the echo canceller 174 is operative to start to suppress the echo component of the second sound signal stored in the second sound signal storing unit 172 after the judgment is made that the filter coefficient produced by the adaptive filter 189 is relatively stable, the echo canceller 174 includes a first sound signal storing unit 171 having the first sound signal stored therein, the first sound signal storing unit 171 being operative to output the stored first sound signal with a predetermined delay in order of first-in first-out, and a second sound signal storing unit 172 having stored therein the second sound signal produced by the microphone unit 183, the second sound signal storing unit 172 being operative to output the stored second sound signal with a predetermined delay in order of first-in first-out in synchronization with the operation of the first sound signal storing unit 171.

The sound signal processing apparatus 170 according to the eleventh embodiment of the present invention may be operative in combination with a voice recognition apparatus for performing the voice recognition to the third sound signal outputted by the echo canceller 174. In this particular case, the sound signal processing apparatus 170 according to the eleventh embodiment of the present invention can have the voice recognition apparatus effectively perform the voice recognition on the basis of the third sound signal outputted by the echo canceller 174.

The echo canceller of the sound signal processing apparatus according to the first to tenth embodiments may be replaced by the echo canceller 174, shown in FIG. 22, of the sound signal processing apparatus according to the eleventh embodiment.

### Twelfth Embodiment

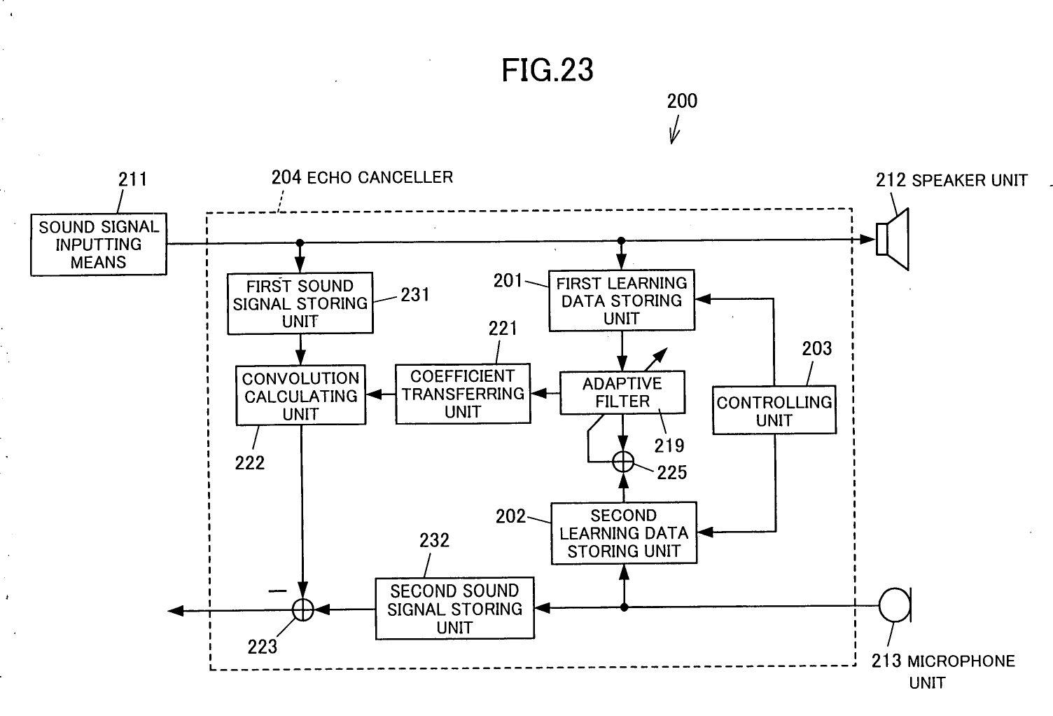

Although there has been described in the above about the first to eleventh embodiments of the sound signal processing apparatus according to the present invention, the objects of the present invention may be attained by the twelfth embodiment of the sound signal processing apparatus according to the present invention. The twelfth embodiment of the sound signal processing apparatus according to the present invention will be described hereinafter with reference to FIG. 23.

The sound signal processing apparatus 200 according to the twelfth embodiment of the present invention is shown in FIG. 23 as comprising sound signal inputting means 211, a speaker unit 212, a microphone unit 213, an adaptive filter 219 for producing a first replica echo signal by estimating the echo component of the second sound signal, a first learning data storing unit 201 having the first sound signal as first learning data stored therein, a second learning data storing unit 202 having the second sound signal as second learning data stored therein in synchronization with the operation of the first learning data storing unit 201, a controlling unit 203 for updating the first and second learning data stored in the first and second learning data storing units 201 and 202 when the judgment is made that each of the inputted first and second sound signals are useful as the learning data, and a second subtracting unit 225 for subtracting the replica echo signal produced by the adaptive filter 219 from the second sound signal produced by the microphone unit 213 to output a signal indicative of the difference between the second sound signal and the replica echo signal.

The sound signal processing apparatus 200 according to the twelfth embodiment of the present invention further comprises a first sound signal storing unit 231 having the first sound signal stored therein, the first sound signal storing unit 231 being operative to output the stored first sound signal with a predetermined delay in order of first-in first-out, a second sound signal storing unit 232 having stored therein the second sound signal produced by the microphone unit 213, the second sound signal storing unit 232 being operative to output the stored second sound signal with a predetermined delay in order of first-in first-out, a convolution calculating unit 222 for producing a second replica echo signal by estimating the echo component of the second sound signal, a filter coefficient transferring unit 221 for judging whether the filter coefficient updated by the adaptive filter 219 is being varied or relatively stable, the filter coefficient transferring unit 221 being operative to transfer the filter coefficient updated by the adaptive filter 219 to the convolution calculating unit 222 when the judgment is made that the filter coefficient updated by the adaptive filter 219 is relatively stable, and a first subtracting unit 223 for subtracting the second replica echo signal produced by the convolution calculating unit 222 from the second sound signal outputted by the second sound signal storing unit 232 to output a signal indicative of the difference between the second sound signal and the second replica echo signal.

The convolution calculating unit 222 is operative to output the second replica echo signal indicative of the estimated echo component of the second sound signal by calculating the convolution of the first sound signal outputted by the first sound signal storing unit 231 with respect to the filter coefficient transferred by the filter coefficient transferring unit 221.

The operation of the sound signal processing apparatus 200 according to the twelfth embodiment of the present invention will be described hereinafter.

When the judgment is made that each of the first and second sound signals are useful as the learning data, the controlling unit 203 allows the first and second learning data storing units 201 and 202 to respectively store the first and second sound signals in synchronization with each other. The filter coefficient is repeatedly estimated by the adaptive filter 219 on the basis of the first and second leaning data stored in the first and second learning data storing units 201 and 202. Accordingly, the stable filter coefficient can be immediately estimated by the adaptive filter 219 on the basis of the first and second leaning data stored in the first and second learning data storing units 201 and 202 under the condition that the fluctuation of the transfer characteristic is relatively small. It's preferable that the first and second leaning data stored in the first and second learning data storing units 201 and 202 are updated as frequently as possible when the judgment is made that the fluctuation of the transfer characteristic is relatively large.

From the above detail description, it will be understood that the sound signal processing apparatus 200 according to the twelfth embodiment of the present invention can detect at a relatively high accuracy the leading end of the voice component of the third sound signal on the basis of the third sound signal outputted by the echo canceller 204 even if the echo component of the second sound signal produced by the microphone unit 213 is insufficiently suppressed by the echo canceller 204.

The sound signal processing apparatus 200 according to the twelfth embodiment of the present invention can suppress the remaining echo component by reason that the echo canceller 204 includes a first sound signal storing unit 231 having the first sound signal stored therein, the first sound signal storing unit 231 being operative to output the stored first sound signal with a predetermined delay in order of first-in first-out, and a second sound signal storing unit 232 having stored therein the second sound signal produced by the microphone unit 213, the second sound signal storing unit 232 being operative to output the stored second sound signal with a predetermined delay in order of first-in first-out.

The sound signal processing apparatus 200 according to the twelfth embodiment of the present invention may be operative in combination with a voice recognition apparatus for performing the voice recognition to the fourth sound signal received from the echo canceller 204. In this particular case, the sound signal processing apparatus 200 according to the twelfth embodiment of the present invention can have the voice recognition apparatus effectively perform the voice recognition by having the voice recognition apparatus receive the fourth sound signal only for a time period that the speaker is talking to the microphone unit 213.

The echo canceller of the sound signal processing apparatus according to the first to tenth embodiments of the present invention may be replaced by the echo canceller 204 of the sound signal processing apparatus 200 according to the twelfth embodiment of the present invention. This leads to the fact that the echo component of the third sound signal is more sufficiently suppressed by the echo canceller 204.

### Thirteenth Embodiment

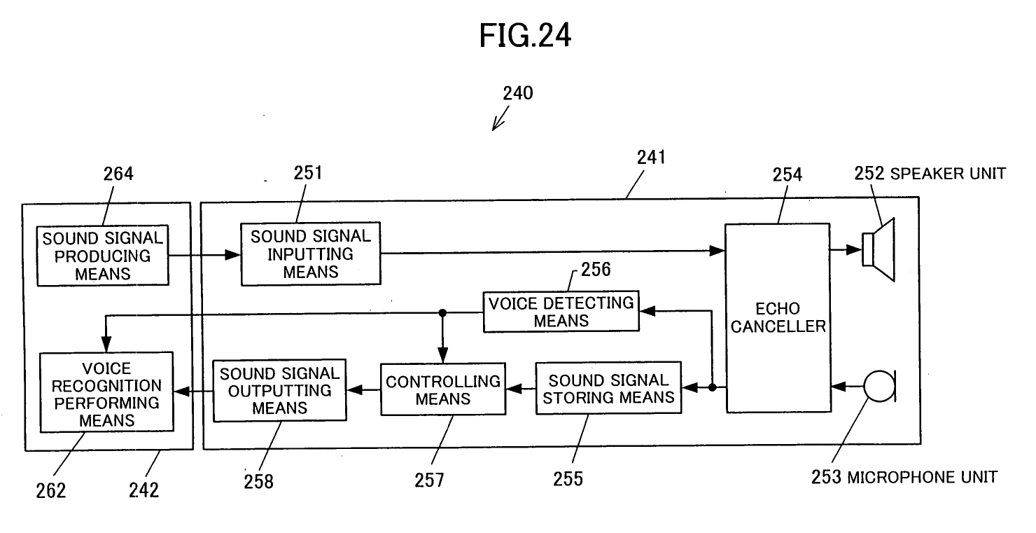

Although there has been described in the above about the first to twelfth embodiments of the sound signal processing apparatus according to the present invention, the objects of the present invention may be attained by the thirteenth embodiment of the sound signal processing apparatus according to the present invention. The thirteenth embodiment of the sound signal processing apparatus according to the present invention will be described hereinafter with reference to FIG. 24.

The sound signal processing system 240 according to the thirteenth embodiment of the present invention is shown in FIG. 24 as comprising a navigation apparatus 242 and a sound signal processing apparatus 241. The navigation apparatus 242 includes sound signal producing means 264 for producing a first sound signal as navigation information.

The sound signal processing apparatus 241 includes sound signal inputting means 251 for inputting a first sound signal, a speaker unit 252 for converting the first sound signal inputted by the sound signal inputting means 251 to the first sound, a microphone unit 253 for producing a second sound signal constituted by three different components including an echo component indicative of the first sound outputted by the speaker unit 252, a voice component indicative of one's voice having a least one leading end, and an background noise component indicative of background sounds produced in the vicinity of the microphone unit 253, an echo canceller 254 for suppressing the echo component of the second sound signal on the basis of the first sound signal inputted by the sound signal inputting means 251 and the second sound signal produced by the microphone unit 253 to output the suppressed second sound signal as a third sound signal, sound signal storing means 255 for storing the third sound signal outputted by the echo canceller 254, voice detecting means 256 for detecting the leading end of the voice on the basis of the third sound signal outputted by the echo canceller 254, and controlling means 257 for controlling the sound signal storing means 255 to have the sound signal storing means 255 output, as a fourth sound signal, the third sound signal stored in the time period when the voice is detected in the third sound signal outputted by the echo canceller 254.

The controlling means 257 is operative to have the sound signal storing means 255 start to retroactively output, as a fourth sound signal, the stored third sound signal by imposing a predetermined delay on the fourth sound signal when the leading end of the voice is detected by the voice detecting means 256. On the other hand, the navigation apparatus 242 further includes voice recognition performing means 262 for performing the voice recognition of the sound represented by the fourth sound signal before judging whether or not the speaker is talking to the microphone unit 253 in reply to the sound outputted by the speaker unit 252 on the basis of the result of the voice recognition. When the judgment is made that the sound represented by the fourth sound signal is recognized as the specific voice of the speaker on the basis of the voice recognition, a navigation information producing means (not shown) of the navigation apparatus for produce navigation information in reply to the specific voice of the speaker.

The voice detecting means 256 is operative to produce a control signal having trigger information on whether or not the leading end of the voice is detected from the third sound signal outputted by the echo canceller 254, and output the control signal to each of the controlling means 257 and the voice recognition means 262 of the navigation apparatus 242.

In the operation of the sound signal processing system 240 according to the thirteenth embodiment of the present invention, the operation of the sound signal processing apparatus 241 is the same as that of the sound signal processing apparatus 10 according to the first embodiment of the present invention with the exception of the fact that the control signal is produced and outputted to the navigation apparatus 242 by the voice detecting means 256. Therefore, the operation of the sound signal processing system 240 according to the thirteenth embodiment of the present invention will not be described hereinafter.

From the above detail description, it will be understood that the sound signal processing system 240 according to the thirteenth embodiment of the present invention can detect at a relatively high accuracy the leading end of the voice component of the third sound signal on the basis of the third sound signal outputted by the echo canceller 254 even if the echo component of the second sound signal produced by the microphone unit 253 is insufficiently suppressed by the echo canceller 254.

As will be seen from the foregoing description, the navigation apparatus of the sound signal processing system 240 according to the thirteenth embodiment of the present invention can effectively perform the voice recognition to the fourth sound signal received from the sound signal processing apparatus, and enhance the recognition rate of the voice of the speaker.

### Fourteenth Embodiment

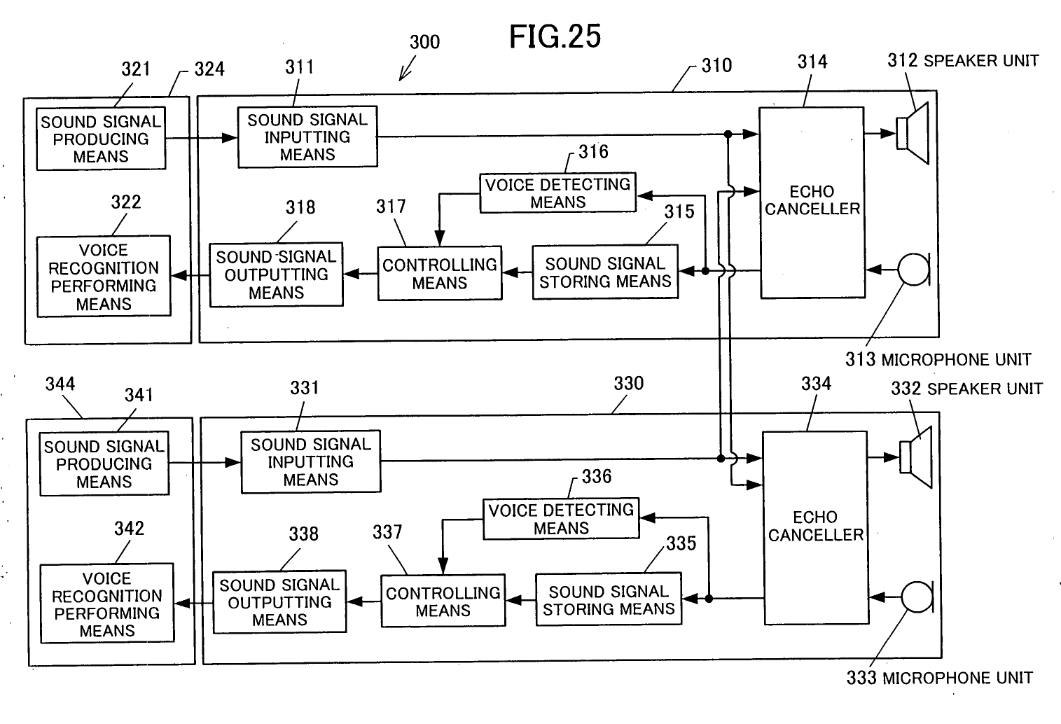

Although there has been described in the above about the first to thirteenth embodiments of the sound signal processing apparatus according to the present invention, the objects of the present invention may be attained by the fourteenth embodiment of the sound signal processing apparatus according to the present invention. The fourteenth embodiment of the sound signal processing apparatus according to the present invention will be described hereinafter with reference to FIG. 25.

The sound signal processing system 300 according to the fourteenth embodiment of the present invention is shown in FIG. 25 as comprising first and second sound signal processing apparatuses 310 and 330. Each of the first and second sound signal processing apparatuses 310 and 330 is the same in construction as the sound signal processing apparatuses 10 according to the first embodiment of the present invention with the exception of the echo cancellers 314 and 334.

The first sound signal processing apparatus 310 comprises sound signal inputting means 311, a speaker unit 312, a microphone unit 313, an echo canceller 314, sound signal storing means 315, voice detecting means 316, controlling means 317, and sound signal outputting means 318. The second sound signal processing apparatus 330 comprises sound signal inputting means 331, a speaker unit 332, a microphone unit 333, an echo canceller 334, sound signal storing means 335, voice detecting means 336, controlling means 337, and sound signal outputting means 338.

The microphone unit 313 of the first sound signal processing apparatus 310 is operative to produce a second sound signal constituted by three different components including an echo component indicative of the first sound outputted by the speaker unit 312 of the first sound signal processing apparatus 310, a voice component indicative of one's voice having a least one leading end, and an background noise component indicative of undesired sound produced in the vicinity of the microphone unit 313. The echo canceller 314 of the first sound signal processing apparatus 310 is operative to suppress the echo component of the second sound signal on the basis of the first sound signal inputted by the sound signal inputting means 311 of the first sound signal processing apparatus 310 and the first sound signal produced by the sound signal inputting means 331 of the second sound signal processing apparatus 330 to output the suppressed second sound signal as a third sound signal.

On the other hand, the microphone unit 333 of the first sound signal processing apparatus 330 is operative to produce a second sound signal constituted by at least three different components including an echo component indicative of the sound outputted by the speaker unit 332 of the first sound signal processing apparatus 330, a voice component indicative of one's voice having a least one leading end, and an background noise component indicative of the sound outputted by the speaker unit 312 of the first sound signal processing apparatus 310. The echo canceller 334 of the first sound signal processing apparatus 330 is operative to suppress the echo component of the second sound signal on the basis of the first sound signal inputted by the sound signal inputting means 331 of the first sound signal processing apparatus 330 and the first sound signal produced by the microphone unit 313 of the second sound signal processing apparatus 310 to output the suppressed second sound signal as a third sound signal.

The sound signal processing system 300 further comprises first and second external apparatuses 324 and 344.

The first external apparatus 324 includes sound signal producing means 321 for producing, as an audio guidance, a first sound signal to be outputted to the sound signal * processing apparatus 310, and voice recognition means 322 for performing the voice recognition to the fourth sound signal outputted by the sound signal outputting means 318 of the first sound signal processing apparatus 310. The sound signal inputting means 311 of the first sound signal processing apparatus 310 is operative to receive the first sound signal from the first external apparatus 324. The second external apparatus 344 includes sound signal producing means 341 for producing, as an audio guidance, a first sound signal to be outputted to the sound signal processing apparatus 330, and voice recognition means 342 for performing the voice recognition to the fourth sound signal outputted by the sound signal outputting means 318 of the second sound signal processing apparatus 330. The sound signal inputting means 331 of the second sound signal processing apparatus 330 is operative to receive the first sound signal from the second external apparatus 344.

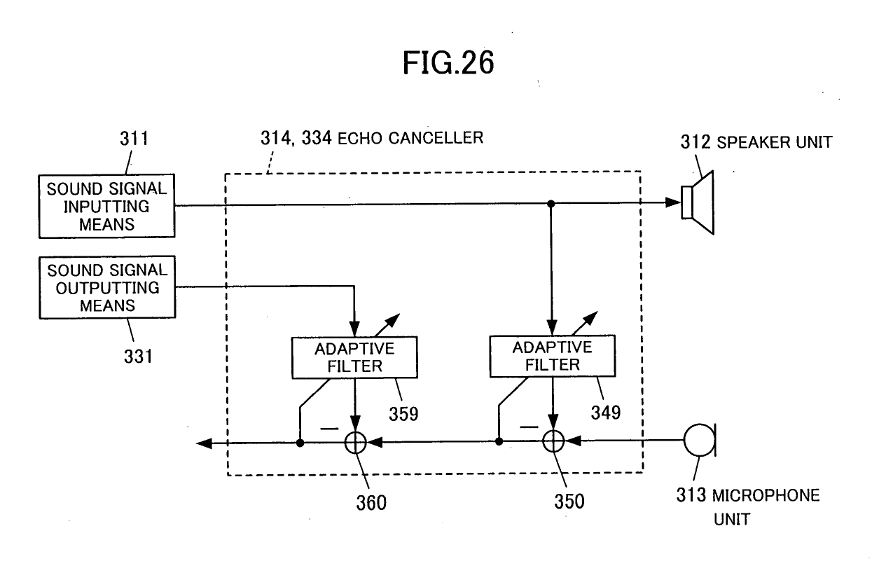

The echo canceller 314 of the first sound signal processing apparatus 310 is shown in FIG. 26 as including an adaptive filter 349 for estimating the echo component of the second sound signal produced by the microphone unit 313 to produce a replica echo signal indicative of the estimated echo component of the second sound signal on the basis of the first sound signal inputted by the sound signal inputting means 311 and the second sound signal produced by the microphone unit 313, a first subtracting unit 350 for producing the difference between the replica echo signal produced by the adaptive filter 349 and the second sound signal produced by the microphone unit 313, an adaptive filter 359 for estimating the echo component of the second sound signal produced by the microphone unit 313 to produce a replica echo signal indicative of the estimated echo component of the second sound signal on the basis of the first sound signal inputted by the sound signal inputting means 331 and the second sound signal produced by the microphone unit 313, and a second subtracting unit 360 for producing the difference between the replica echo signal produced by the adaptive filter 359 and the signal produced by the first subtracting unit 350. The echo canceller 314 of the first sound signal processing apparatus 310 is operative to output the signal produced by the second subtracting unit 360 to the sound signal storing means 315 as a third sound signal.

As shown in FIG. 26, the echo canceller 334 of the second sound signal processing apparatus 330 is the same in construction as the echo canceller 314 of the first sound signal processing apparatus 310. The echo canceller 334 of the second sound signal processing apparatus 330 includes an adaptive filter, a first subtracting unit 350, an adaptive filter 359, and a second subtracting unit 360. The echo canceller 334 of the first sound signal processing apparatus 330 is operative to output the signal produced by the second subtracting unit 360 to the sound signal storing means 335 as a third sound signal.

The operation of the sound signal processing system 300 according to the fourteenth embodiment of the present invention will be described hereinafter.

In the first sound signal processing apparatus 310, the first sound signal is produced by the sound signal producing means 321 of the first external apparatus 324 as the audio guidance, and outputted to the sound signal inputting means 311 of the first sound signal processing apparatus 310. The first sound signal inputted by the sound signal inputting means 311 of the first sound signal processing apparatus 310 is converted to the sound by the speaker unit 312. The first sound signal is produced by the sound signal producing means 341 of the second external apparatus 344 as the audio guidance, and outputted to the sound signal inputting means 331 of the second sound signal processing apparatus 330. The first sound signal inputted by the sound signal inputting means 331 of the second sound signal processing apparatus 330 is converted to the sound by the speaker unit 332. On the other hand, the second sound signal is produced by the microphone unit 313. The echo component of the second sound signal is then suppressed by the echo canceller 314. The suppressed second sound signal is sequentially stored in the sound signal storing means 315 as the third sound signal. When the leading end of the voice is detected in the third sound signal outputted by the echo canceller 314, the controlling means 317 has the sound signal storing means 315 retroactively output, as the fourth sound signal, the stored third sound signal to the sound signal outputting means 318 by imposing a predetermined delay on the fourth sound signal. The voice recognition to the fourth sound signal is performed by the voice recognition performing means 322 of the first external apparatus 324.

In the second sound signal processing apparatus 330, the first sound signal is produced by the sound signal producing means 341 of the second external apparatus 344 as the audio guidance, and outputted to the sound signal inputting means 331 of the second sound signal processing apparatus 330. The first sound signal inputted by the sound signal inputting means 331 of the second sound signal processing apparatus 330 is converted to the sound by the speaker unit 332. The first sound signal is produced by the sound signal producing means 321 of the first external apparatus 324 as the audio guidance, and outputted to the sound signal inputting means 311 of the first sound signal processing apparatus 310. The first sound signal inputted by the sound signal inputting means 311 of the first sound signal processing apparatus 310 is converted to the sound by the speaker unit 312. On the other hand, the second sound signal is produced by the microphone unit 333. The echo component of the second sound signal is then suppressed by the echo canceller 334. The suppressed second sound signal is sequentially stored in the sound signal storing means 335 as the third sound signal. When the leading end of the voice is detected in the third sound signal outputted by the echo canceller 334, the controlling means 337 has the sound signal storing means 335 retroactively output, as the fourth sound signal, the stored third sound signal to the sound signal outputting means 338 by imposing a predetermined delay on the fourth sound signal. The voice recognition to the fourth sound signal is performed by the voice recognition performing means 342 of the second external apparatus 344.

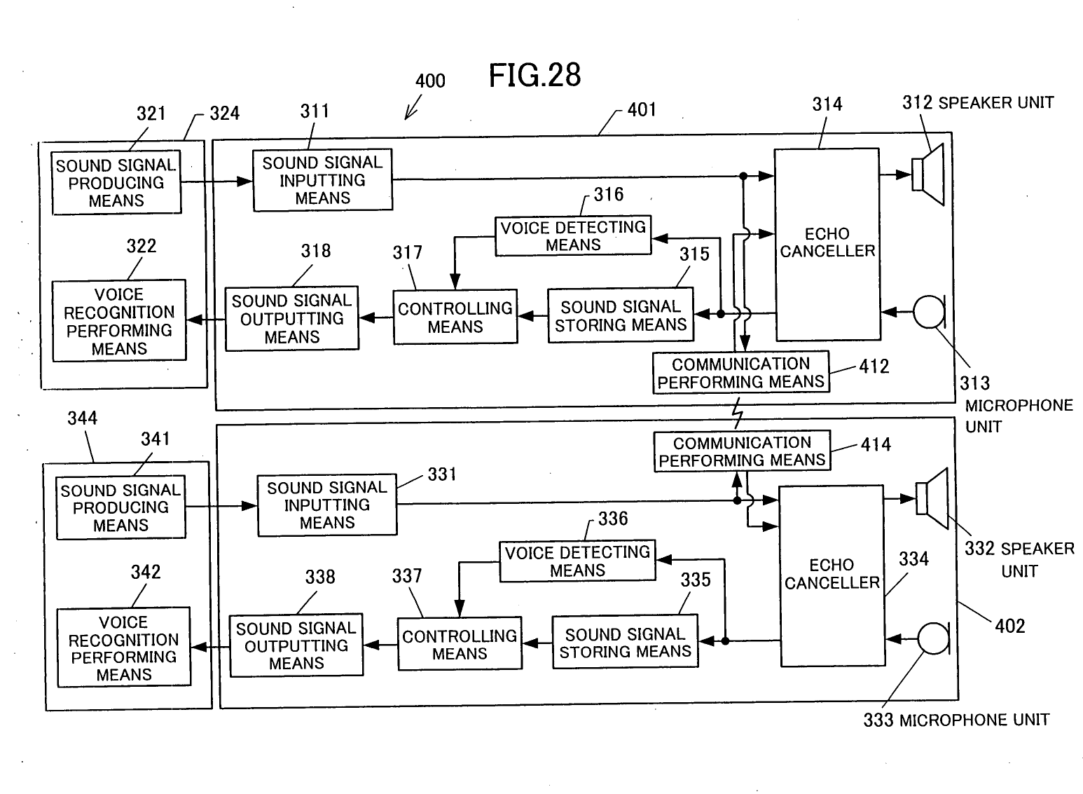

The following description will be directed to the one modified embodiment similar to the above mentioned fourteenth embodiment of the sound signal processing system 400 according to the present invention. The modified embodiment shown in FIG. 28 is the same in constitution as the fourteenth embodiment of the sound signal processing system 300 shown in FIG. 25 with the exception of the communication performing means 412 and 414. The communication performing means 412 of the first sound signal processing apparatuses 401 is operative to transmit the first sound signal inputted by the sound signal inputting means 311 to the second sound signal processing apparatuses 402, and to receive the first sound signal inputted by the sound signal inputting means 331 from the second sound signal processing apparatuses 402. Similarly, the communication performing means 414 of the second sound signal processing apparatuses 402 is operative to transmit the first sound signal inputted by the sound signal inputting means 331 to the first sound signal processing apparatuses 401, and to receive the first sound signal inputted by the sound signal inputting means 311 from the first sound signal processing apparatuses 401.

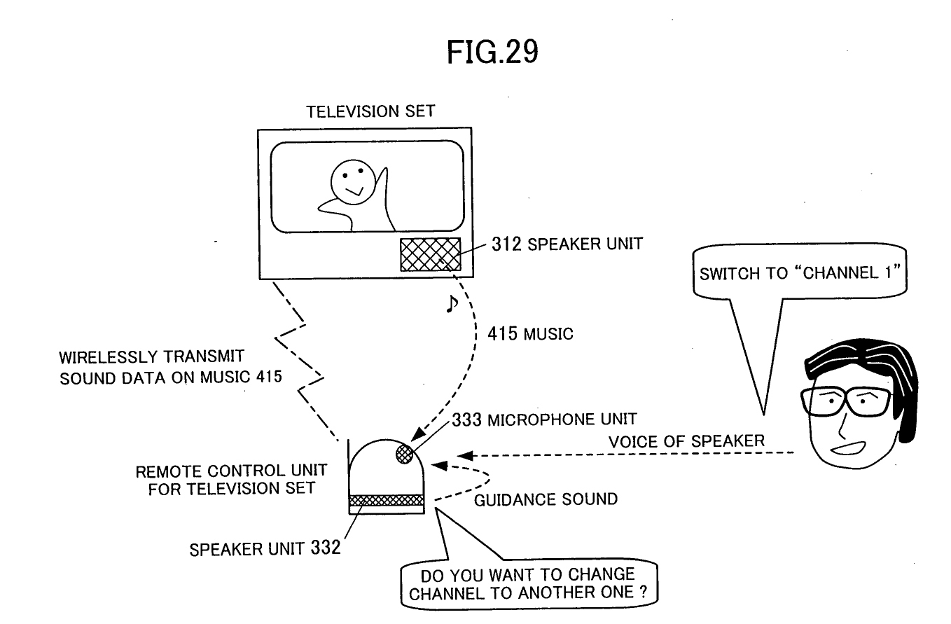

As will be seen from FIG. 29, the first and second sound signal processing apparatuses 401 and 402 may be respectively built in a television set and a remote controller for controlling the television set. In this particular case, the remote controller is operative to judge whether or not to switch the TV cannels by performing the communication with its user. When the user asks the remote controller to switch the TV cannels, the remote controller is operative to wirelessly switch the TV cannels.

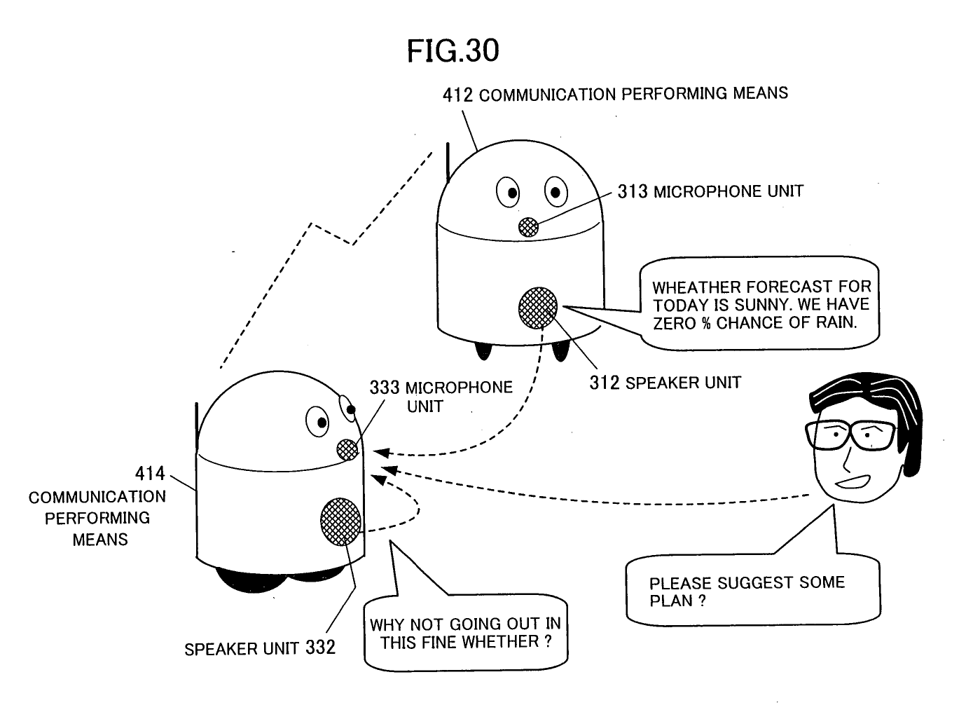

When the voice interaction is performed between the remote controller and the user under the condition that the sound 415 is being outputted by the speaker unit 312 of the television set, the voice of the user is received with the sound outputted by the television set by the microphone unit 333 of the sound signal processing apparatus 402. Accordingly, the sound signal produced by the microphone unit 333 is constituted by three different components including an echo component indicative of the sound outputted by the remote controller, a voice component indicative of user's voice having a least one leading, and a background noise component indicative of the sound outputted by the television set. The sound signal processing apparatus built in the remote controller suppresses each of the voice component and the background noise component to recognize the echo suppressed sound signal over the time period when the voice is detected. As another case, there may be provided a system comprises a plurality of robots shown in FIG. 30, each of the robots comprises sound signal processing apparatus.

From the above detail description, it will be understood that the sound signal processing system 400 according to the fourteenth embodiment of the present invention can detect the leading end of the voice component of the third sound signal to specify at a relatively high accuracy the time period when the speaker talks to the microphone unit 333 on the basis of the detected leading end of the voice component of the third sound signal, and selectively output, as a fourth sound signal, the third sound signal stored in the sound signal storing means on the basis of the specified time period by reason that the echo cancellers 314 and 334 are operative to suppress the respective echo components of the second sound signals produced by the speaker units 312 and 332, and the voice detecting means 316 and 336 are operative to detect the respective leading ends of the voice component of the third sound signal.

The sound signal processing apparatus can have the voice recognition means effectively perform the voice recognition by reason that the controlling means is operative to have the sound signal storing means output the fourth sound signal to the sound signal outputting means only for a time period that the speaker is talking to the microphone unit.

In this embodiment, the sound signal processing system comprises first and second sound signal processing apparatuses. However, the sound signal processing system may comprise three or more sound signal processing apparatuses. The effect of the sound signal processing system comprising three or more sound signal processing apparatuses is the same as that of the sound signal processing system comprising the two sound signal processing apparatuses.

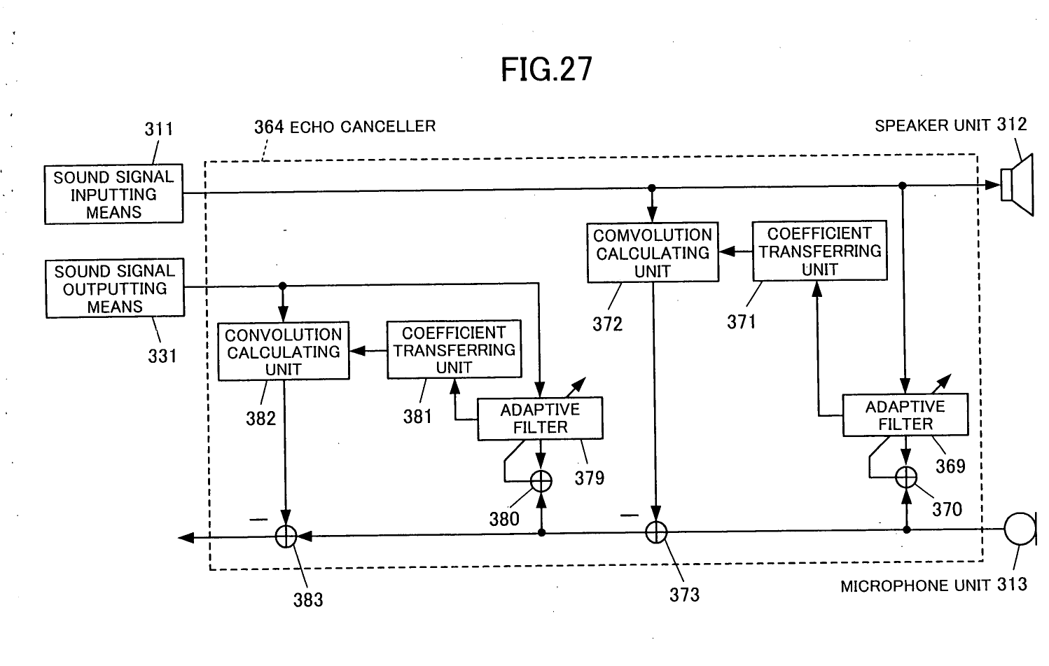

In this embodiment, each of the echo cancellers 314 and 334 of the first and second sound signal processing apparatuses 310 and 330 shown in FIG. 26 may be replaced by the echo canceller 364 shown in FIG. 27.

As shown in FIG. 27, the echo canceller 364 may include an adaptive filter 369 for estimating a filter coefficient, a convolution calculating unit 372 for producing a replica echo signal indicative of the echo component of the second sound signal by calculating the convolution of the first sound signal inputted by the sound signal inputting means 311 with respect to the filter coefficient estimated by the adaptive filter 369, a filter coefficient transferring unit 371 for transferring the filter coefficient estimated by the adaptive filter 369 to the convolution calculating unit 372, and a first subtracting unit 373 for subtracting the replica echo signal produced by the convolution calculating unit 372 from the second sound signal produced by the microphone unit 313 to produce a signal indicative of the difference between the second sound signal and the replica echo signal, a second subtracting unit 370 for subtracting the replica echo signal produced by the adaptive filter 369 from the second sound signal produced by the microphone unit 313 to output a signal indicative of the difference between the second sound signal and the replica echo signal. Here, the estimation of the filter coefficient is performed on the basis of the first sound signal outputted by the sound signal inputting means 311 and the signal outputted by the first subtracting unit 373. The adaptive filter 369 may be operative to estimate the echo component of the second sound signal on the basis of the first sound signal outputted by the sound signal inputting means 311 and the signal outputted by the first subtracting unit 373 to produce a replica echo signal indicative of the echo component of the second sound signal. The adaptive filter 369 may be operative to update the filter coefficient in response to the signal outputted by the second subtracting unit 370. The filter coefficient transferring unit 371 may be operative to judge whether the filter coefficient estimated by the adaptive filter 369 is being varied or relatively stable. When the judgment is made that the estimated filter coefficient is in stable, the transfer of the filter coefficient estimated by the adaptive filter 369 to the convolution calculating unit 372 may be performed by the filter coefficient transferring unit 371.

The echo canceller 364 may further include an adaptive filter 379 for estimating a filter coefficient, a convolution calculating unit 382 for producing a replica echo signal indicative of the echo component of the second sound signal by calculating the convolution of the first sound signal inputted by the sound signal inputting means 331 with respect to the filter coefficient estimated by the adaptive filter 379, a filter coefficient transferring unit 381 for transferring the filter coefficient estimated by the adaptive filter 389 to the convolution calculating unit 382, and a first subtracting unit 383 for subtracting the replica echo signal produced by the convolution calculating unit 382 from the second sound signal produced by the microphone unit 313 to produce a signal indicative of the difference between the second sound signal and the replica echo signal, a second subtracting unit 380 for subtracting the replica echo signal produced by the adaptive filter 379 from the second sound signal produced by the microphone unit 313 to output a signal indicative of the difference between the second sound signal and the replica echo signal. The adaptive filter 379 may be operative to estimate the echo component of the second sound signal on the basis of the first sound signal outputted by the sound signal inputting means 331 and the signal outputted by the first subtracting unit 383 to produce a replica echo signal indicative of the echo component of the second sound signal. The adaptive filter 379 may be operative to update the filter coefficient in response to the signal outputted by the second subtracting unit 380. The filter coefficient transferring unit 381 may be operative to judge whether the filter coefficient estimated by the adaptive filter 379 is being varied or relatively stable. When the judgment is made that the estimated filter coefficient is in stable, the transfer of the filter coefficient estimated by the adaptive filter 379 to the convolution calculating unit 382 may be performed by the filter coefficient transferring unit 381. The echo canceller 364 may be operative to output, as a third sound signal, the signal produced by the first subtracting unit 383.

### Fifteenth Embodiment

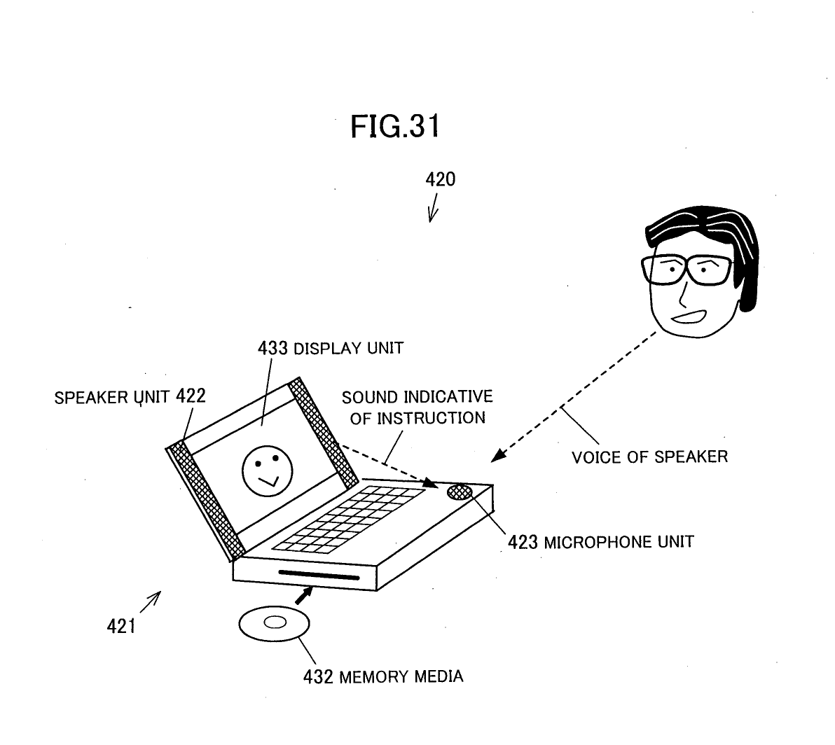

Although there has been described in the above about the first to fourteenth embodiments of the sound signal processing apparatus according to the present invention, the objects of the present invention may be attained by the fifteenth embodiment of the sound signal processing system according to the present invention. The fifteenth embodiment of the sound signal processing system according to the present invention will be described hereinafter with reference to FIG. 31.

As shown in FIG. 31, the sound signal processing system 420 according to the fifteenth embodiment of the present invention is constituted by part of a laptop computer 421 which comprises a speaker unit 422, a microphone unit 423, a display unit 433, a microprocessor (not shown), a semiconductor memory (not shown), and a hard disk (not shown). The microprocessor is operative to execute a previously installed sound signal processing program stored in a memory media 432 such as for example a magnetic disc, an optical disc, and a semiconductor memory.

The sound signal processing program comprises a first sound signal producing step of producing a first sound signal, a second sound signal obtaining step of obtaining a second sound signal from the microphone unit 423, the second sound signal being constituted by at least two different components including an echo component indicative of the sound outputted by the speaker unit 422, and a voice component indicative of one's voice having a least one leading, an echo component suppressing step of suppressing the echo component of the second sound signal on the basis of the first and second sound signals, the echo component suppressing step being of outputting the suppressed second sound signal as a third sound signal, a sound signal storing step of storing the third sound signal in the hard disc, a voice component detecting step of detecting the leading end of the voice on the basis of the third sound signal outputted in the echo component suppressing step, a controlling step of having the hard disc start to retroactively output, as a fourth sound signal, the third sound signal stored in the time period when the voice is detected in the third sound signal outputted by the echo canceller 14 in order of first-in first-out with a predetermined delay when the leading end of the voice is detected in the voice detecting step, and a voice recognition step of performing the voice recognition to the fourth sound signal outputted by the hard disc.

The echo component suppressing step includes a replica echo signal estimating step of estimating the replica echo signal on the basis of the first and second sound signals, and a subtracting step of subtracting the replica echo signal estimated in the replica echo signal estimating step from the second sound signal obtained in the second sound signal obtaining step, and outputting a signal indicative of the difference between the replica echo signal and the second sound signal.

The controlling step is of having the hard disc sequentially output, as a fourth sound signal, the stored third sound signal with a predetermined delay “Tm” in order of first-in first-out when the leading end of the voice is detected in the voice detecting step.

The sound signal processing system can detect at a relatively high accuracy the leading end of the voice component of the third sound signal in the detecting step on the basis of the fluctuation of the first sound signal, frequency characteristic of the first sound signal, and the information about the first sound signal to be converted by the speaker unit 422.

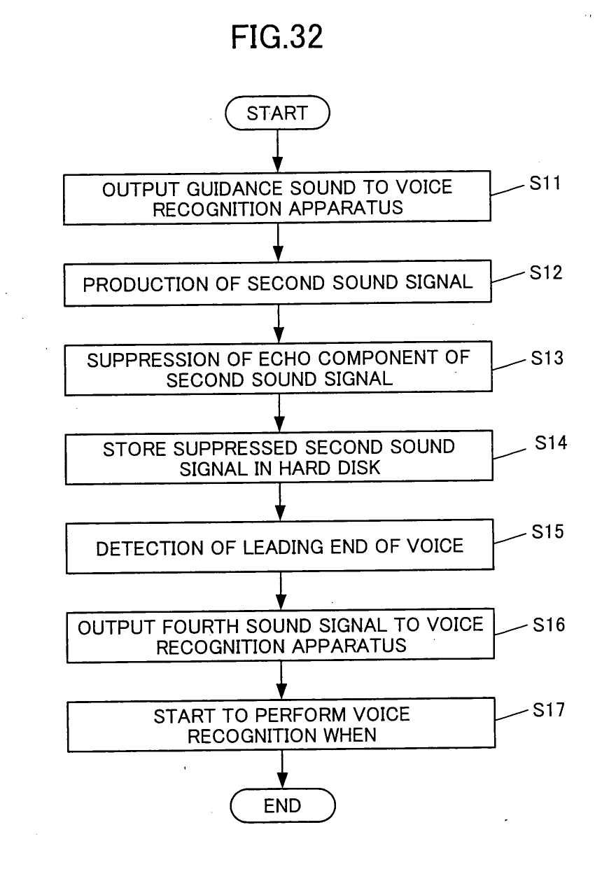

As shown in FIG. 32, the first sound signal is firstly produced as a guidance voice, and outputted to the speaker unit 422. The first sound signal is then converted to the sound by the speaker unit 422 (in the step S11), while the second sound signal is produced by the microphone unit 423 (in the step S12). The second sound signal is constituted by at least two different components including an echo component indicative of the sound outputted by the speaker unit 422, and a voice component indicative of one's voice. The echo component of the second sound signal obtained from the microphone unit 423 is suppressed on the basis of the first and second sound signals by the echo canceller. The suppressed second sound signal is outputted as the third sound signal (in the step S13). The third sound signal is sequentially stored in the hard disc (in the step S14). The judgment is made (in the step S15) on whether or not the leading end of the voice is detected from the third sound signal. When the leading end of the voice is detected from the third sound signal, the microprocessor specifies two different clock times on the basis of a predetermined time difference, the clock times including a first clock time at which the leading end of the voice is detected in the step 15, and a second clock time prior to the first clock time. The microprocessor then control the hard disc to have the hard disc start to output the third sound signal stored after the second clock time (in the step S17).

From the above detail description, it will be understood that the sound signal processing system 420 according to the fifteenth embodiment of the present invention can be low in production cost in comparison with the conventional sound signal processing system by reason that the sound signal processing system 420 is effectively constituted by a laptop computer 421 for executing the sound signal processing program.

In this embodiment, the sound signal processing system 420 is constituted by a laptop computer 421. However, the sound signal processing system 420 may be constituted by a mobile phone. The sound signal processing system may be constituted by a plurality of personal computers performing the communication with one another through the communication network.

From the above detail description, it will be understood that the sound signal processing system 420 according to the fifteenth embodiment of the present invention can effectively perform the voice recognition to the second sound signal outputted by the microphone even if the echo component of the second sound signal is insufficiently suppressed.

### INDUSTRIAL APPLICABILITY OF THE PRESENT INVENTION

As will be seen from the foregoing detail description, the sound signal processing apparatus according to the present invention can sufficiently suppress the echo component of the sound signal, and reduce the time period up to start to output the echo suppressed sound signal. Each of the sound signal processing system, the sound signal processing apparatus, the sound signal processing method, the sound signal processing program, and the recordable media provided with the echo canceller is useful as a voice recognition system and a voice interactive system.

1. A sound signal processing apparatus, comprising:
a speaker unit for converting a first sound signal to a first sound;
sound signal producing means for producing a second sound signal constituted by at least two different components including an echo component indicative of said first sound outputted by said speaker unit, and a voice component indicative of one's voice having a least one leading end;
echo component suppressing means for suppressing said echo component of said second sound signal on the basis of said first and second sound signals to output, as a third sound signal, said suppressed second sound signal;
sound signal storing means for storing said third sound signal outputted by said echo component suppressing means;
voice detecting means for detecting said leading end of said voice on the basis of said third sound signal outputted by said echo component suppressing means; and
controlling means for controlling said sound signal storing means to have said sound signal storing means output, as a fourth sound signal, said third sound signal stored in the time period when said voice is detected in said third sound signal outputted by said echo component suppressing means, said controlling means being operative to specify two different clock times on the basis of a predetermined time difference, said clock times including a first clock time at which said leading end of said voice is detected by said voice detecting means, and a second clock time prior to said first clock time, said controlling means being operative to have said sound signal storing means start to output said third sound signal stored after said second clock time.

2. A sound signal processing apparatus as set forth in claim 1, in which
said echo component suppressing means includes:
an adaptive filter for estimating said echo component of said second sound signal to output a replica echo signal indicative of said estimated echo component of said second sound signal; and
a subtracting unit for subtracting said replica echo signal produced by said adaptive filter from said second sound signal produced by said sound signal producing means to output a signal indicative of the difference between said second sound signal and said replica echo signal, and in which
said adaptive filter is operative to produce said replica echo signal on the basis of said first sound signal produced by said sound signal producing means and said signal outputted by said subtracting unit, and
said echo component suppressing means is operative to output, as a third signal, said signal produced by said subtracting unit.

3. A sound signal processing apparatus as set forth in claim 1, in which
said echo component suppressing means includes:
an adaptive filter for estimating a filter coefficient;
a convolution calculating unit for estimating a replica echo signal indicative of said echo component of said second sound signal by calculating the convolution of said first sound signal with respect to said filter coefficient estimated by said adaptive filter;
a filter coefficient transferring unit for judging whether said filter coefficient estimated by said adaptive filter is being varied or relatively stable, said filter coefficient transferring unit being operative to transfer said filter coefficient estimated by said adaptive filter to said convolution calculating unit when the judgment is made that said filter coefficient estimated by said adaptive filter is relatively stable; and
a subtracting unit for subtracting said replica echo signal produced by said convolution calculating unit from said second sound signal produced by said sound signal producing means to output a signal indicative of the difference between said second sound signal and said replica echo signal, and in which
said adaptive filter is operative to estimate said filter coefficient on the basis of said first sound signal produced by said sound signal producing means and said signal outputted by said subtracting unit, and
said echo component suppressing means is operative to output, as a third signal, said signal outputted by said subtracting unit.

4. A sound signal processing apparatus as set forth in claim 1, in which
said echo component suppressing means includes:
an adaptive filter for estimating a filter coefficient;
a first sound signal storing unit having said first sound signal stored therein, said first sound signal storing unit being operative to output said stored first sound signal in order of first-in first-out with a predetermined delay;
a second sound signal storing unit having said second sound signal stored therein, said first sound signal storing unit being operative to output said stored second sound signal in order of first-in first-out with a predetermined delay;
a convolution calculating unit for estimating a replica echo signal indicative of said echo component of said second sound signal by calculating the convolution of said first sound signal outputted by said first sound signal storing unit with respect to said filter coefficient estimated by said adaptive filter;
a filter coefficient transferring unit for judging whether said filter coefficient estimated by said adaptive filter is being varied or relatively stable, said filter coefficient transferring unit being operative to transfer said filter coefficient estimated by said adaptive filter to said convolution calculating unit when the judgment is made that said filter coefficient estimated by said adaptive filter is relatively stable; and
a subtracting unit for subtracting said replica echo signal produced by said convolution calculating unit from said second sound signal outputted by said second sound signal storing unit to output a signal indicative of the difference between said second sound signal and said replica echo signal, and in which
said adaptive filter is operative to estimate said filter coefficient on the basis of said first sound signal and said signal outputted by said subtracting unit, and
said echo component suppressing means is operative to output, as a third signal, said signal outputted by said subtracting unit.

5. A sound signal processing apparatus as set forth in claim 1, in which
said echo component suppressing means includes:
a first learning data storing unit to be operable to have stored therein said first sound signal as first learning data;
a second learning data storing unit to be operable to have stored therein said second sound signal produced by said sound signal producing means as second learning data;
a controlling unit for allowing said first and second learning data storing units to respectively have stored therein said first and second learning data related to each other;
an adaptive filter for estimating a filter coefficient on the basis of said first learning data stored in said first learning data storing unit and said second learning data stored in said second learning data storing unit;
a convolution calculating unit for estimating a replica echo signal indicative of said echo component of said second sound signal by calculating the convolution of said first sound signal with respect to said filter coefficient estimated by said adaptive filter;
a filter coefficient transferring unit for judging whether or not said filter coefficient estimated by said adaptive filter is relatively stable, said filter coefficient transferring unit being operative to transfer said filter coefficient estimated by said adaptive filter to said convolution calculating unit; and
a subtracting unit for subtracting said replica echo signal produced by said convolution calculating unit from said second sound signal outputted by said second sound signal storing unit to output a signal indicative of the difference between said second sound signal and said replica echo signal, and in which
said adaptive filter is operative to estimate said filter coefficient on the basis of said first sound signal and said signal outputted by said subtracting unit, and
said echo component suppressing means is operative to output, as a third signal, said signal outputted by said subtracting unit.

6-7. (canceled)

8. A sound signal processing apparatus as set forth in claim 1, in which
said voice detecting means is operative to detect said leading end of said voice component of said third sound signal by measuring the signal level of each of said first and third sound signals, and by comparing the signal level of each of said measured first and third sound signals with a predetermined threshold level.

9. A sound signal processing apparatus as set forth in claim 1, in which
said voice detecting means is operative to detect said leading end of said voice component of said third sound signal by measuring the noise level of said third sound signal to update said determined threshold level on the basis of said measured noise level of said third sound signal, and by comparing each of said measured first and third sound signals with said updated predetermined threshold level.

10. A sound signal processing apparatus as set forth in claim 1, in which
said voice detecting means is operative to detect said leading end of said voice component of said third sound signal by judging whether or not the magnitude of said first sound to be outputted by said speaker unit is larger than a predetermined threshold level to update said determined threshold level on the basis of said judgment, and by comparing each of said measured first and third sound signals with said updated predetermined threshold level.

11. A sound signal processing apparatus as set forth in claim 1, in which
said voice detecting means is operative to detect said leading end of said voice component of said third sound signal by measuring the duration of said first sound to be outputted by said speaker unit to update said determined threshold level on the basis of said measured duration of said sound, and by comparing each of said measured first and third sound signals with said updated predetermined threshold level.

12. A sound signal processing apparatus as set forth in claim 1, in which
said voice detecting means is operative to operative to detect said leading end of said voice component of said third sound signal by calculating first and third power values of said first and third sound signals, and by comparing each of said calculated first and third power values of said first and third sound signals with a predetermined threshold level.

13. (canceled)

14. A sound signal processing apparatus as set forth in claim 1, in which
said voice detecting means is operative to detect said leading end of said voice component of said third sound signal by measuring the signal level of each of said second and third sound signals, and by comparing each of said calculated signal levels of said second and third sound signals with a predetermined threshold level.

15-16. (canceled)

17. A sound signal processing apparatus as set forth in claim 1, in which
said voice detecting means is operative to detect said leading end of said voice component of said third sound signal by measuring the signal level of each of said first to third sound signals, and by comparing each of said calculated signal levels of said first to third sound signals with a predetermined threshold level.

18-19. (canceled)

20. A sound signal processing apparatus as set forth in claim 1, which further comprises signal level adjusting means for adjusting the signal level of said first sound signal to be converted to said sound by said speaker unit, and in which
said voice detecting means is operative to detect said leading end of said voice component of said third sound signal by measuring each of the signal level of said first sound signal adjusted by said signal level adjusting means and the signal level of said third sound signal outputted by said echo component suppressing means, and by comparing each of said calculated signal levels of said first and third sound signals with a predetermined threshold level.

21-22. (canceled)

23. A sound signal processing apparatus as set forth in claim 1, which further comprises trigger signal producing means for producing a trigger signal having a trigger pulse to be defined in association with the time at which said voice is detected by said voice detecting means, and in which
said voice detecting means is operative to detect said leading end of said voice component of said third sound signal component of said third sound signal outputted by said echo component suppressing means on the basis of said trigger signal produced by said trigger signal producing means.

24-33. (canceled)

34. A sound signal processing system, comprising:
at least two sound signal processing apparatuses including first and second sound signal processing apparatuses, said first sound signal processing apparatus including: a speaker unit for converting a first sound signal to a first sound; sound signal producing means for producing a second sound signal constituted by at least two different components including an echo component indicative of said first sound outputted by said speaker unit, and a voice component indicative of one's voice having a least one leading end; echo component suppressing means for suppressing said echo component of said second sound signal on the basis of said first and second sound signals to output, as a third sound signal, said suppressed second sound signal; sound signal storing means for storing said third sound signal outputted by said echo component suppressing means; voice detecting means for detecting said leading end of said voice on the basis of said third sound signal outputted by said echo component suppressing means; controlling means for controlling said sound signal storing means to have said sound signal storing means output, as a fourth sound signal, said third sound signal stored in the time period when said voice is detected in said third sound signal outputted by said echo component suppressing means, said controlling means being operative to specify two different clock times on the basis of a predetermined time difference, said clock times including a first clock time at which said leading end of said voice is detected by said voice detecting means, and a second clock time prior to said first clock time, said controlling means being operative to have said sound signal storing means start to output said third sound signal stored after said second clock time; and communication performing means for transmitting said first sound signal to said second sound signal processing apparatus, and
said second sound signal processing apparatus including: a speaker unit for converting a first sound signal to a first sound; sound signal producing means for producing a second sound signal constituted by at least two different components including an echo component indicative of said first sound outputted by said speaker unit, and a voice component indicative of one's voice having a least one leading end; echo component suppressing means for suppressing said echo component of said second sound signal on the basis of said first and second sound signals to output, as a third sound signal, said suppressed second sound signal; sound signal storing means for storing said third sound signal outputted by said echo component suppressing means; voice detecting means for detecting said leading end of said voice on the basis of said third sound signal outputted by said echo component suppressing means; controlling means for controlling said sound signal storing means to have said sound signal storing means output, as a fourth sound signal, said third sound signal stored in the time period when said voice is detected in said third sound signal outputted by said echo component suppressing means, said controlling means being operative to specify two different clock times on the basis of a predetermined time difference, said clock times including a first clock time at which said leading end of said voice is detected by said voice detecting means, and a second clock time prior to said first clock time, said controlling means being operative to have said sound signal storing means start to output said third sound signal stored after said second clock time; and communication performing means for transmitting said first sound signal to said first sound signal processing apparatus.

35-39. (canceled)

40. A sound signal processing program, comprising:
an echo component suppressing step of suppressing an echo component of a second sound signal on the basis of first and second sound signals to output, as a third sound signal, said suppressed second sound signal;
a sound signal storing step of storing said third sound signal with time information in sound signal storing means;
a voice detecting step of detecting a leading end of one's voice on the basis of said third sound signal; and
a controlling step of controlling said sound signal storing means to have said sound signal storing means output, as a fourth sound signal, said third sound signal stored in the time period when said voice is detected on the basis of said third sound signal outputted by said echo component suppressing means, said controlling step being of specifying two different clock times on the basis of a predetermined time difference, said clock times including a first clock time at which said leading end of said voice is detected in said voice detecting step, and a second clock time prior to said first clock time, said controlling step being of having said sound signal storing means start to output said third sound signal stored after said second clock time.

41. (canceled)
